(19) United States
(12) Patent Application Publication
(10) Pub. No.: US 2016/0328743 A1
(43) Pub. Date: Nov. 10, 2016

(54) SYSTEM AND METHOD FOR ASKING AND ANSWERING QUESTIONS WITH AN ELECTRONIC DEVICE

(71) Applicant: Ric Militi, San Diego, CA (US)

(72) Inventor: Ric Militi, San Diego, CA (US)

(21) Appl. No.: 15/146,700

(22) Filed: May 4, 2016

Related U.S. Application Data
(60) Provisional application No. 62/158,083, filed on May 7, 2015.

(51) Int. Cl. G06Q 30/02

(52) U.S. Cl. CPC G06Q 30/0255; G06Q 30/0203; G06Q 30/0267

(57) ABSTRACT

The systems and methods for asking and answering questions with an electronic device described herein provide for a platform, in various embodiments, that allows for users to be targeted for additional information based on responses and other inputs provided in an application running on an electronic device, at a particular moment of engagement. In some embodiments, advertisements or other information may be provided to users based on whether they respond to questions in a pre-specified manner. In other embodiments, advertisements or other information may be provided to users based on selection of certain unique identifiers, such as QuickCodes, that correspond to such information. An object of the inventions is to target and engage users at a particular moment of engagement, as such opportunities may be fleeting based on dynamic changes to a mobile electronic device user's environment.

### CROSS REFERENCE TO OTHER APPLICATIONS

This application is a non-provisional of, and claims priority under 35 U.S.C. §119 to, U.S. Provisional Patent Application No. 62/168,083, filed May 7, 2015, the contents of which are hereby expressly incorporated by reference.

### GENERAL FIELD OF ART

The inventions herein relate generally to the field of polling using mobile electronic means, and more particularly to systems and methods for asking and answering questions with an electronic device, and related fields.

### BACKGROUND

The desirability knowing the feelings of certain demographics regarding a multitude of issues is known in the art. One means for determining such feelings is via the use of polling. A poll generally asks its participants certain questions and keeps track of the results. The results of such polls can be used to determine the sentiments of certain targeted groups regarding the subjects of such polls.

Further, it is also known that poll results may be used to target advertising or certain other information to specific groups. For example, based on the results of a poll, poll respondents can be presented with further information.

The prior art methods, however, have certain disadvantages, and an object of the present invention is to remedy disadvantages of the prior art. For example targeting a user's interest at a particular moment of engagement has been difficult. In certain prior art systems, targeting of users may occur based on past response trends, or demographics. However, these features may not be reflective of more fleeting and dynamic interests of a user based on presently occurring events. As such, an object of the present inventions is to ensure that information is targeted to users as close to a particular moment of engagement with the subject matter as permitted by the user's environment. Another object of the present invention is to enable content providers to provide a user with a set of questions or other information that may be directly tied to that user's particular moment of engagement. Another object of the present invention is to enable content providers to provide both questions and advertisements that engage with a user at a particular moment of engagement and which are related to events of interest in the user's surrounding environment.

As explained in further detail below, the present invention remedies the prior art's disadvantages, and provides further benefits over the prior art as discussed in further detail herein.

### DESCRIPTION OF THE FIGURES

FIG. 1 shows an Example System Architecture.

FIG. 2A shows an example Flow Chart for Authentication Process of a Zip User.

FIG. 2B shows an example Flow Chart for Authentication Process of a Zip User entering a QuickCode.

FIG. 3A shows an example Flow Chart for Authorization Process for a Zip User.

FIG. 3B shows an example Flow Chart for an Account Freeze Process.

FIG. 4 shows an example Flow Chart for a User Profile Setup Process.

FIG. 5 shows an example Flow Chart for an “Ask Basic Question” Process.

FIG. 6 shows an example Flow Chart for an “Ask Channel Question” Process.

FIG. 7 shows an example Flow Chart for a “Target Questions” Process.

FIG. 8 shows an example Flow Chart for an “Answer questions” Process.

FIG. 9 shows an example Flow Chart for a Viewing Poll Results Process.

FIG. 10 to shows an example Flow Chart for a User Storing Content in a Zip Wallet.

FIG. 11 shows an example Flow Chart For an Invoicing Process.

FIG. 12 shows an example mobile application practicing certain features of the inventions, referred to herein as “Zip.”

FIG. 13 shows an example Zip sign in screen.

FIG. 14 shows an example Zip screen allowing for entry of a QuickCode.

FIG. 15 shows an example Zip screen displaying categories of questions.

FIG. 16 shows an example Zip screen displaying categories of interest.

FIG. 17 shows an example Zip screen for email verification.

FIG. 18 shows an example Zip home screen.

FIG. 19 shows an example Zip tutorial screen.

FIG. 20 shows an example Zip tutorial screen regarding swiping to answer.

FIG. 21 shows an example Zip tutorial screen regarding entering a QuickCode.

FIG. 22 shows an example Zip tutorial screen regarding swiping to skip.

FIG. 23 shows another example Zip tutorial screen regarding swiping to skip.

FIG. 24 shows an example Zip tutorial screen regarding the bell icon.

FIG. 25 shows an example Zip tutorial screen regarding the menu icon.

FIG. 26 shows an example Zip tutorial screen regarding the wallet icon.

FIG. 27 shows an example Zip tutorial screen regarding the flag icon.

FIG. 28 shows an example Zip tutorial screen regarding the help icon.

FIG. 29 shows an example Zip screen with a question.

FIG. 30 shows an example Zip screen with the results of a poll.

FIG. 31 shows an example Zip screen with the help screen associated with a question.

FIG. 32 shows an example Zip screen with a question card.

FIG. 33 shows an example Zip screen with a question card being swiped.

FIG. 34 shows an example Zip screen with mature content question card.

FIG. 35 shows an example Zip screen with the bell icon clicked for a particular question card.

FIG. 36 shows an example Zip screen with a deck of question cards to be answered.

FIG. 37 shows an example Zip screen with the flag icon clicked for a particular question card.

FIG. 38 shows an example Zip screen with the results of flagging a question card.

FIG. 39 shows an example Zip screen with the results of answering all of the questions in a deck of questions.

FIG. 40 shows an example Zip screen allowing for sharing a question on social media.

FIG. 41 shows an example Zip screen showing a question shared on social media.

FIG. 42 shows an example Zip screen for authorization to ask a question.

FIG. 43 shows an example Zip screen for entering a question.

FIG. 44 shows an example Zip screen for identifying whether a question relates to mature content.

FIG. 45 shows an example Zip screen for identifying the category of a question.

FIG. 46 shows an example Zip screen for entering a question time limit.

FIG. 47 shows an example Zip screen for reviewing a question before submission.

FIG. 48 shows an example Zip screen displaying the entered question live.

FIG. 49 shows an example Zip screen for sharing a posed question on social media.

FIG. 50 shows an example Zip screen with a shared question on social media.

FIG. 51 shows an example Zip screen displaying the results of clicking the menu icon.

FIG. 52 shows another example Zip screen displaying the results of clicking the menu icon.

FIG. 53 shows an example Zip screen displaying the logout option.

FIG. 54 shows an example Zip screen for setting up push notifications.

FIG. 55 shows an example Zip screen for setting up content restriction settings.

FIG. 56 shows an example Zip screen for setting up categories of interest.

FIG. 57 shows an example notification message for a new pushed question.

FIG. 58 shows an example Zip menu screen.

FIG. 59 shows an example Zip screen for answering a pushed question.

FIG. 60 shows an example Zip screen displaying a set pushed questions, including a delete option.

FIG. 61 shows an example Zip screen showing a history of answers.

FIG. 62 shows an example Zip screen showing the cumulative results of a previously answered question.

FIG. 63 shows an example Zip screen showing previously answered questions for which results can be retrieved.

FIG. 64 shows an example Zip screen showing previously answered questions for which polling has closed.

FIG. 65 shows an example Zip screen showing previously answered questions for which polling is ongoing.

FIG. 66 shows an example Zip screen allowing filtering answers based on polling status.

FIG. 67 shows an example Zip screen allowing filtering answers based on question category.

FIG. 68 shows an example Zip screen allowing filtering of answered questions.

FIG. 69 shows an example Zip screen filtering of answered questions based on the word “music.”

FIG. 70 shows another example Zip screen for filtering results by polling status.

FIG. 71 shows another example Zip screen for filtering results by polling status.

FIG. 72 shows another example Zip screen for filtering results by category.

FIG. 73 shows another example Zip screen for filtering results by category.

FIG. 74 shows an example Zip screen for sharing polling results on social media.

FIG. 75 shows an example Zip screen displaying results on social media.

FIG. 76 shows an example Zip screen for entering a QuickCode.

FIG. 77 shows an example Zip screen for receiving questions associated with a particular QuickCode.

FIG. 78 shows another example Zip screen for receiving questions associated with a particular QuickCode.

FIG. 79 shows an example Zip screen listing channels to which a user has subscribed, for example by submitting multiple QuickCodes.

FIG. 80 shows an example Zip screen for unfollowing a channel.

FIG. 81 shows another example Zip screen for receiving questions associated with a particular QuickCode.

FIG. 82 shows an example Zip screen for flagging a channel and QuickCode.

FIG. 83 shows an example Zip screen displaying the results of unfollowing a channel.

FIG. 84 shows another example Zip Home screen.

FIG. 85 shows an example Zip screen for entering a QuickCode from the home screen.

FIG. 86 shows another example Zip screen for entering a QuickCode from the home screen.

FIG. 87 shows an example Zip screen with the result of entering a QuickCode from the home screen.

FIG. 88 shows an example Zip screen with a question, for which one of the results is tied to a particular advertisement.

FIG. 89 shows an example Zip screen displaying answering a question, for which one of the results is tied to a particular advertisement.

FIG. 90 shows an example Zip screen providing an advertisement that was associated with a particular response to a question, and poll results.

FIG. 91 shows an example Zip screen for saving an advertisement that was associated with a particular response to a question into a Zip Wallet.

FIG. 92 shows an example Zip screen indication that an advertisement that was associated with a particular response to a question has been saved into a Zip Wallet.

FIG. 93 shows another example Zip screen with a question, for which one of the results is tied to a particular advertisement.

FIG. 94 shows an example screen to filter saved advertisements in a Zip wallet.

FIG. 95 shows another example Zip screen providing an advertisement that was associated with a particular response to a question, and poll results.

FIG. 96 shows an example Zip screen to delete an advertisement from a Zip wallet.

FIG. 97 shows an example Zip Pass.

FIG. 98 shows an example Zip screen with a multimedia question.

FIG. 99 shows another example Zip screen with a multimedia question.

FIG. 100 shows an example Zip screen with the results of a multimedia question.

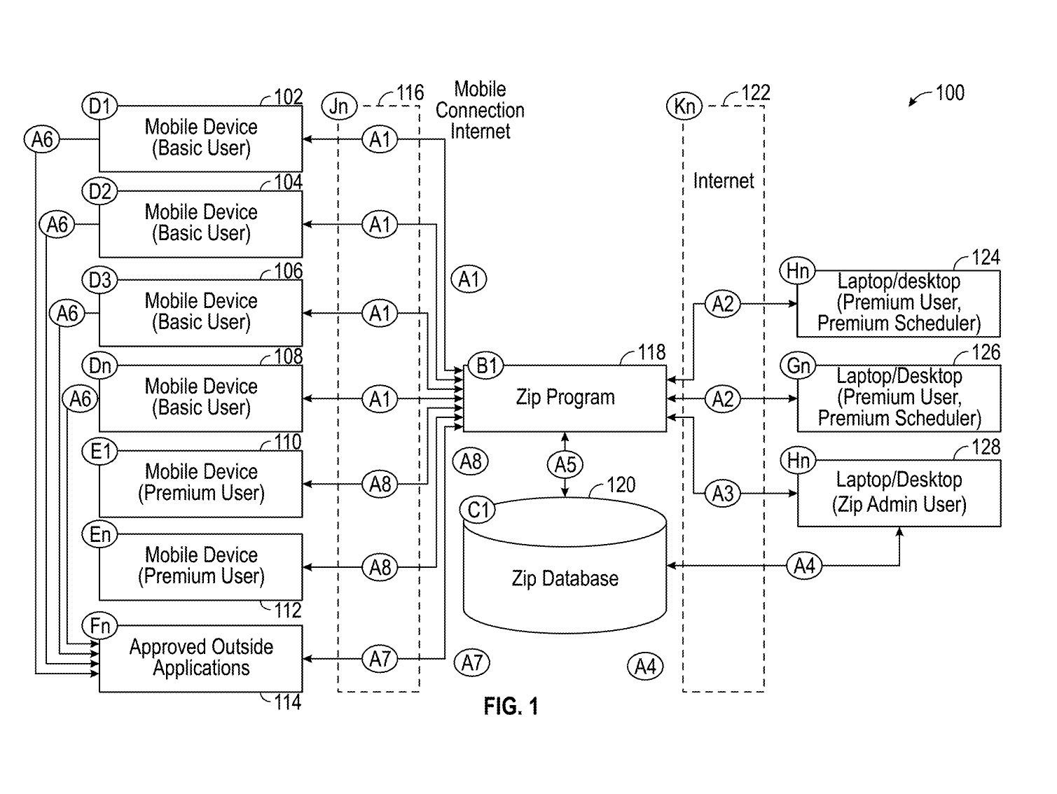

### DETAILED DESCRIPTION

Disclosed is a system and method for asking and answering questions with an electronic device, among other things.

Unanswerable and arguably subjective questions spark conversation, debates, and friendly disagreements. The systems and methods described herein provide a novel and unique approach to resolving such issues. The approaches described provide entertainment to users of the described systems as well and provide opportunity for other benefits to both end users of the systems and methods, and other parties that may be interested in posing questions, receiving answers to posed questions, or receiving data about users who themselves pose and answer questions. Such parties may include, for example, advertisers, market researchers, content providers, pollsters, demographers, brands, corporations, politicians, or others who have an interest in a broad, yet focusable, consumer base.

There are some types of questions that cannot be definitively answered with facts, research or other logic-based analysis. Such questions may include, for example, subjective questions, predictions of future events, specific user or group preferences, or other questions with no objective “right” or “wrong” answer. Regardless of the fact that there may not be a right or wrong answer, experience has shown that individuals, advertisers, and marketers, among others, would like to know trends in some particular userbases for such questions. Additionally, consumers may be more likely to accept majority public opinion as the correct answer.

For example, two friends may argue about who will win a football game being played on the following Sunday. There is no way to know in advance who will win the game, yet each individual may have a steadfast belief as to the correctness of their own particular position. The individuals may want to know what others in their group of friends believe in this regard. Or maybe they want to know what other football fans and the general public believes. It would be both beneficial and entertaining for these individuals to employ the systems and methods described herein to reach a resolution to the question, for example by using an internet connected mobile device such as a cell phone. The use of such a mobile device may allow for instant access to a group of users willing to respond to the question in real-time.

As another example, an advertiser may seek to advertise either a pizza restaurant or a Chinese restaurant, but may not know which advertisement would be better received by potential customers. The advertiser may seek to ask 18-25 year-olds what sort of food they would like to eat at this particular moment in time. And based on the responses, providing timely, up to instant, feedback, the advertiser may provide certain coupons or offers to particular receptive users.

At a high level, people often construct and pose questions with no proven or objectively verifiable answer. Such questions often provoke arguing, squabbling, and fighting without any definitive mechanism to answer the question. Oftentimes, individuals will simply “agree to disagree.” Questions may be left open with no resolution and an inability to reestablish emotional equilibrium and resolve the friendly dispute. In one embodiment, users can, for example, settle friendly disputes, question philosophical arguments, refute common myths, test advice, measure popular opinion, make informed decisions, and be the life of the party, among other things.

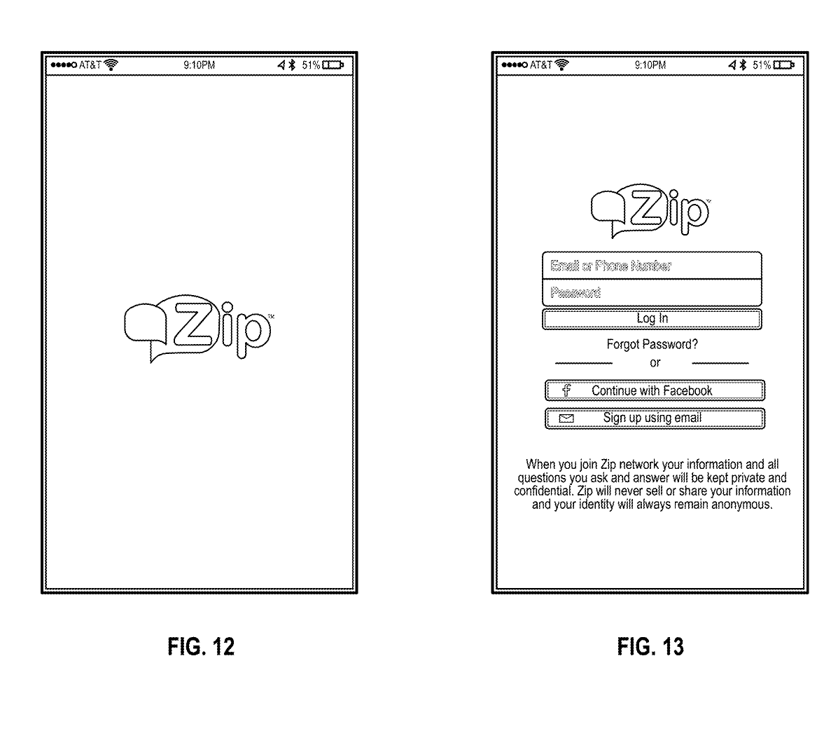

One embodiment, depicted for example in FIG. 12, includes a simple to use, intuitive, fun and social application that allows users to ask, for example, subjective questions that are subsequently “settled” by an immediate, short, longer, or otherwise time-limited term, and largely anonymous vote by a community of users of a particular application that may run, for example, on an internet connected mobile device. In another embodiment, voting may be of indefinite duration. Alternatively, voting could be controlled by some other means, such as a particular number of votes cast, or particular percentage of a specific target audience, or any other suitable limitation means. Still further, another embodiment may operate on other types of electronic devices.

For example, users of an embodiment of a social application can set an expiration and category for a question being asked, along with two opposing views/answers, and at the end of the specified period the application will provide the percentage distribution of answers. In another embodiment, the application may provide the results in other forms, including statistical results, graphical displays, or any other means suitable for presenting results in a fashion that could be readily consumed by users of varying skill levels. One embodiment may provide live results and updates to be displayed in various ways and on various electronic devices, e.g., web, mobile, public screens, etc.

In some embodiments, users can also answer questions posed by other users of the application. For example questions may be posed to users in a stream of questions, as a question targeted for that specific user, on demand or by request by a user, or by other suitable means. Once a user receives a question, that user may answer the question by, for example, swiping the screen of its electronic device in a certain direction corresponding to a particular answer. The user may also skip the question by selecting a certain icon or other indicator shown on the screen of his electronic device, or by swiping the screen in yet a different direction. The user may also take other actions, such as, for example, saving the question to answer later, blocking the question, blocking the type of question, reporting the question to an administrator, marking the question as a favorite to be subsequently notified of results, requesting further questions of this category type or from the user that generated the particular question, or other suitable actions that may not answer the question but that still express the user's feelings in one way or another regarding the question. In one embodiment, the user may be shown only two potential answers to the question. In another embodiment, the user may be shown three or more potential answers. In yet another embodiment, the user may be presented the option to provide its own answer, for example with a “write-in” option. In yet another embodiment, a user may be able to provide comments on the questions that others in the user community may see.

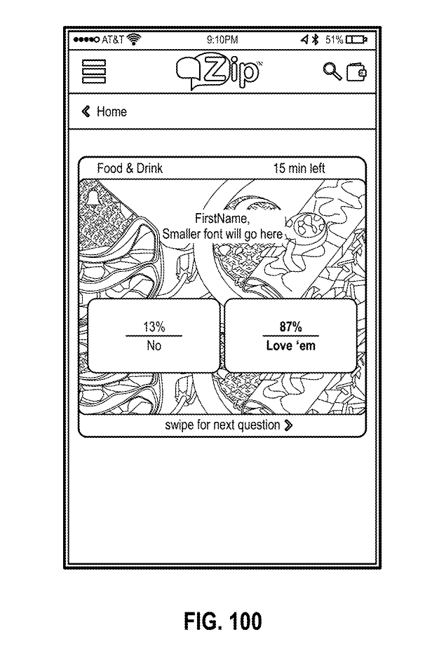

One embodiment may include an application running, for example on an internet connected media device. Some exemplary embodiments of such an application are disclosed in FIGS. 12-100. These figures and some related features of embodiments will be discussed below.

The application, depicted for example in FIG. 12, can run on, for example, an internet connected mobile device such as a cell phone. It can also run on other types of electronic platforms. The application can run on typical operating systems, such as iOS and Android, among others. The application can also be made available to users through, for example, the Apple App Store or the Google Play Market, among other distribution means.

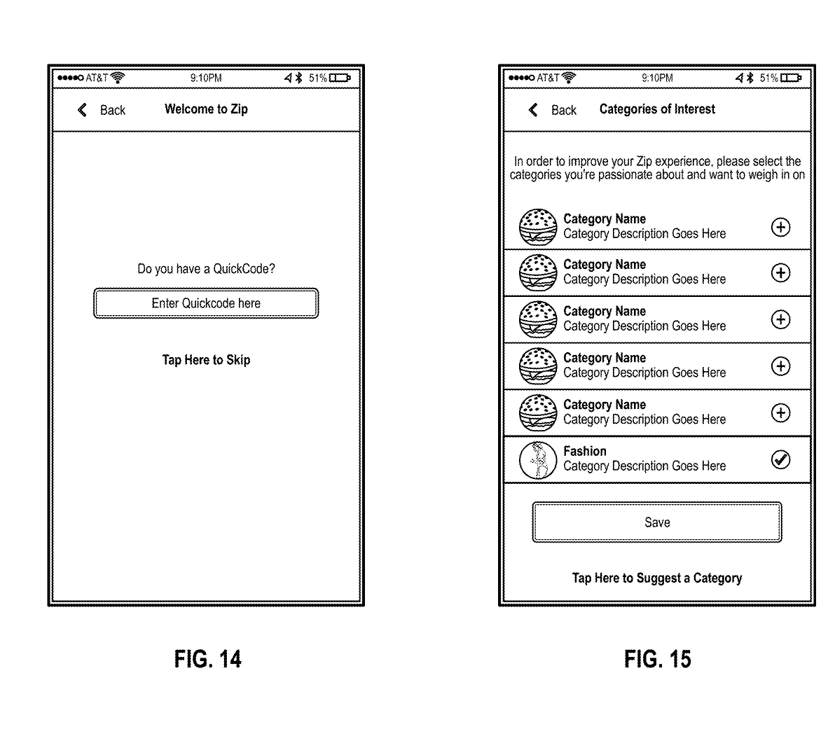

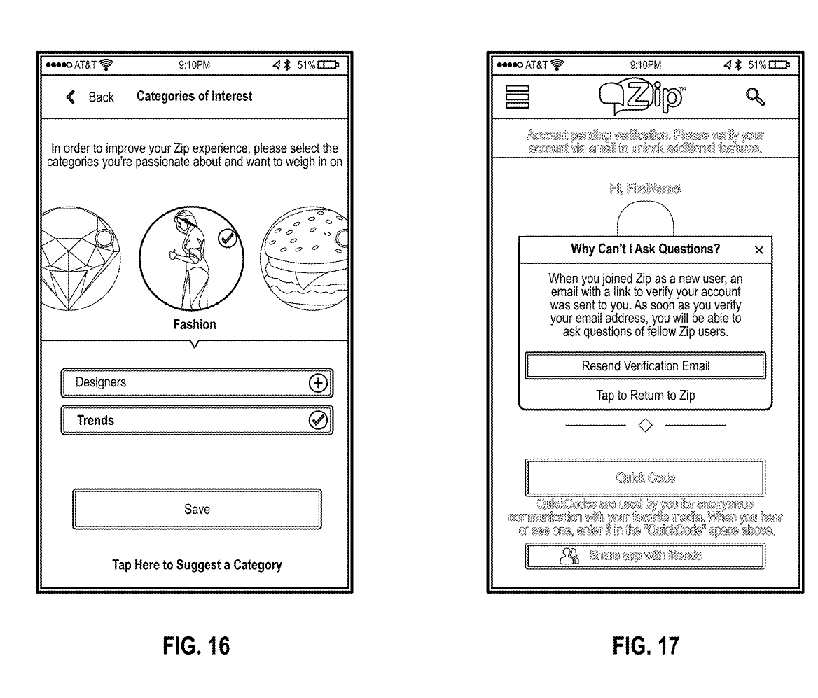

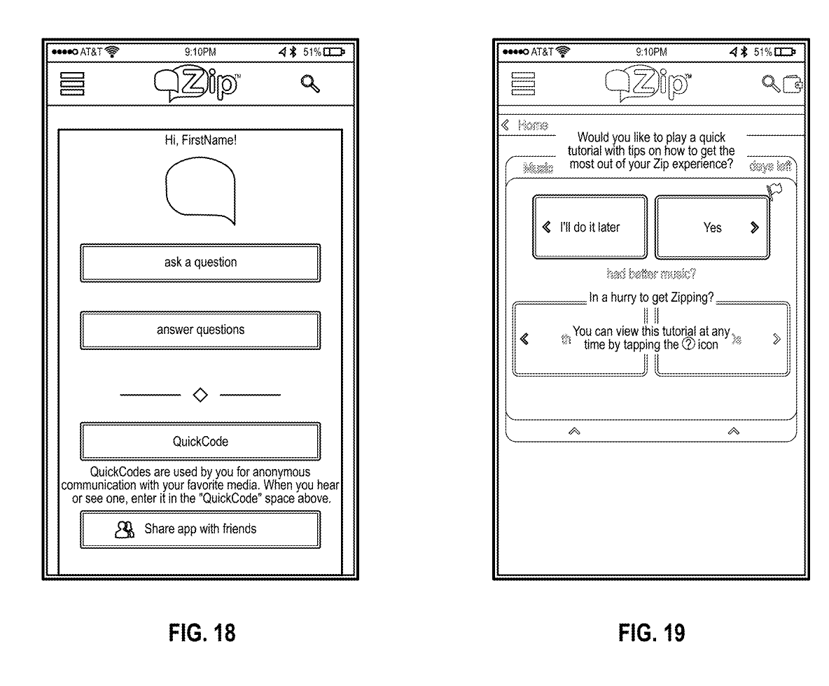

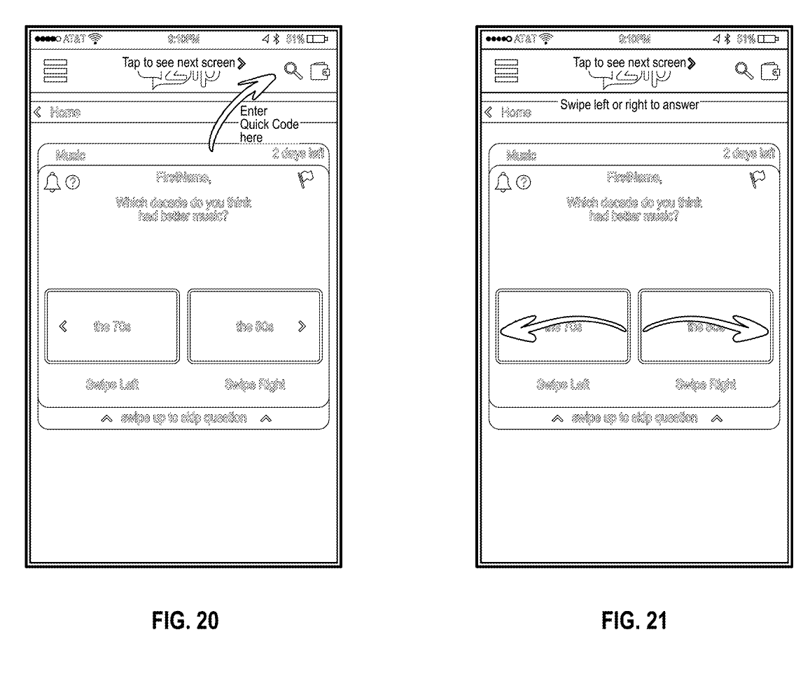

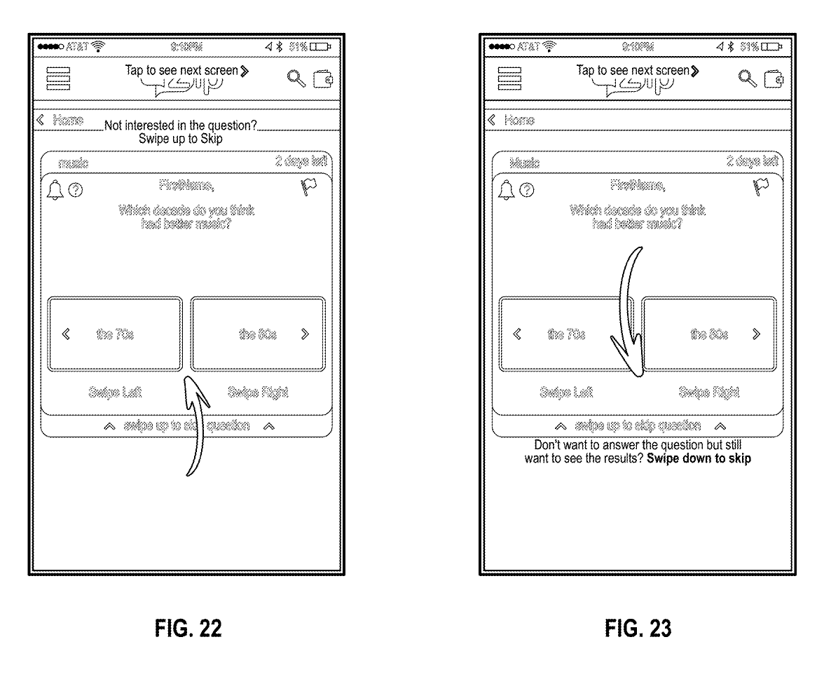

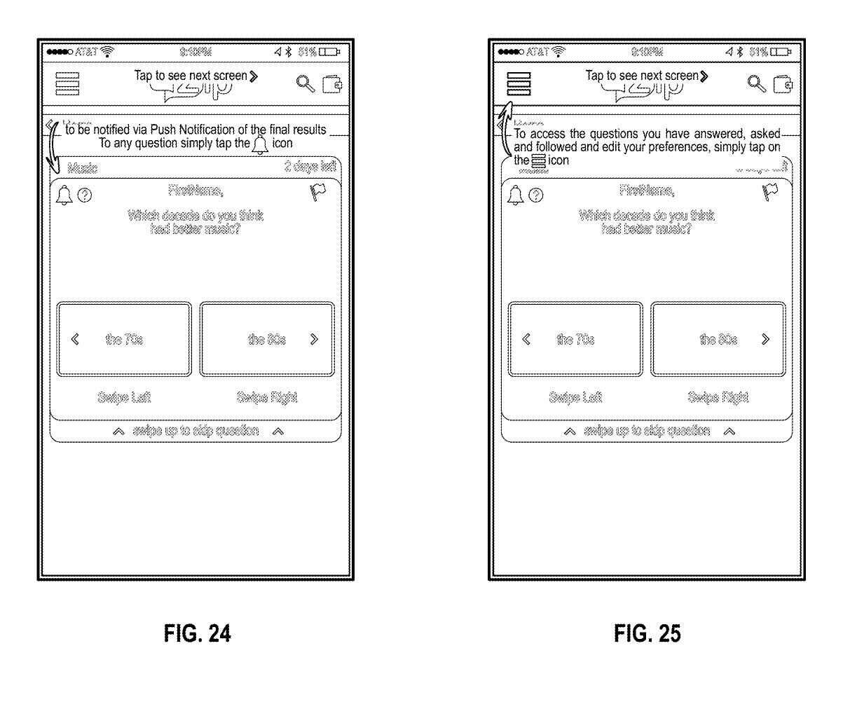

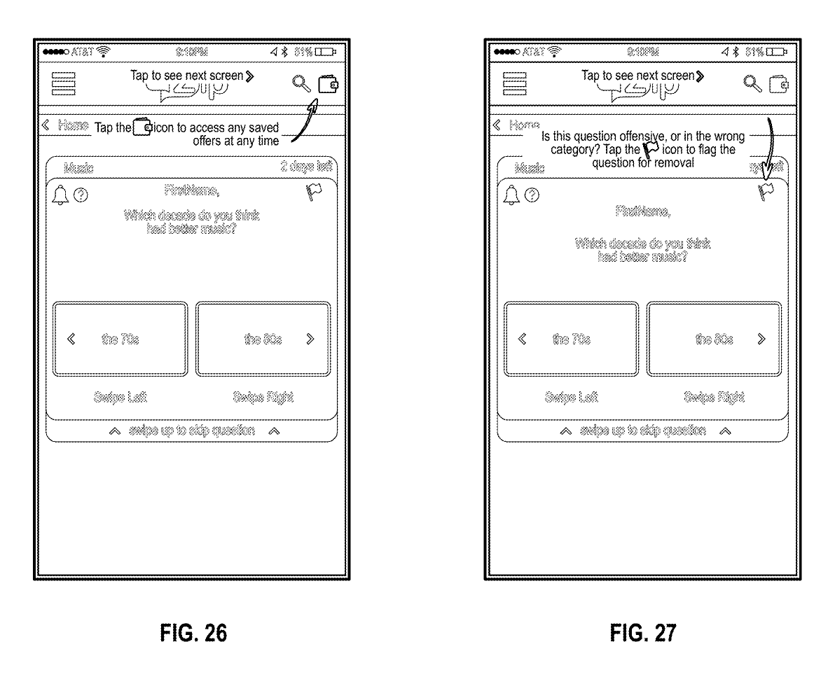

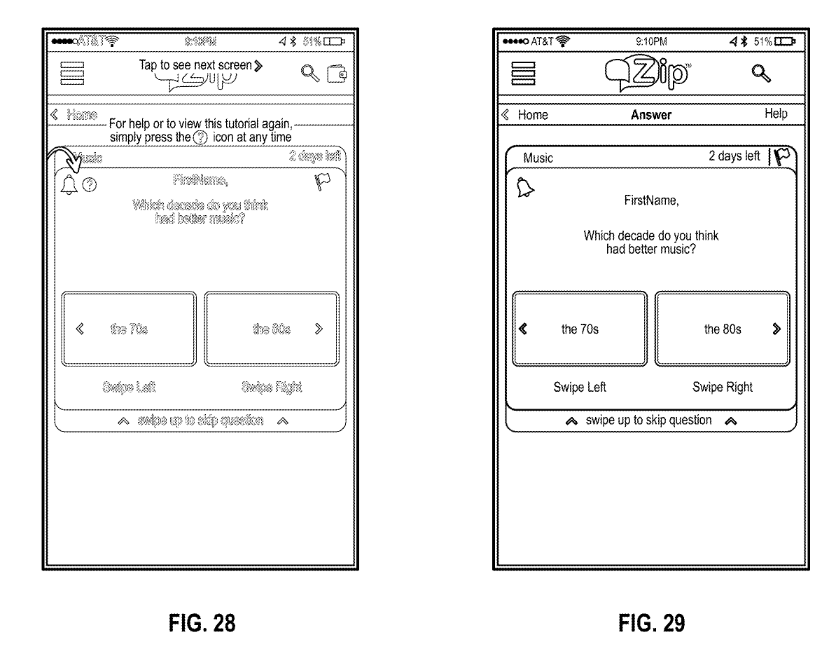

When a user loads the application, for example on an internet connected mobile device, the user may be presented the option to log in, depicted for example in FIG. 13. A user may create a new account, may log in using some other form of social network, or via other suitable means. When a user first logs in, information about that user may be collected. Such information may include, for example, demographic information, psychographic information, information about existing social network accounts, individual content preferences or other information that may later be used to describe the user, depicted for example in FIGS. 14-17. A user may then be provided with some basic training on the usage and functionality of the application, and be provided the opportunity to link various other social media or electronic accounts to the application, depicted for example in FIGS. 18-28.

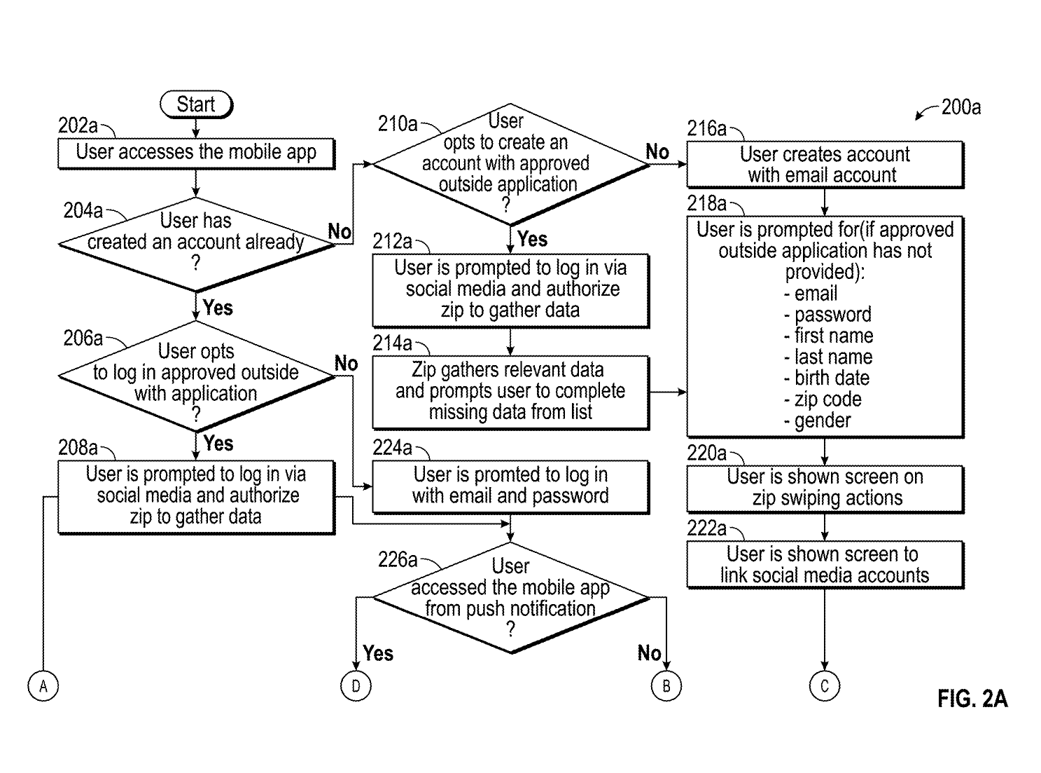

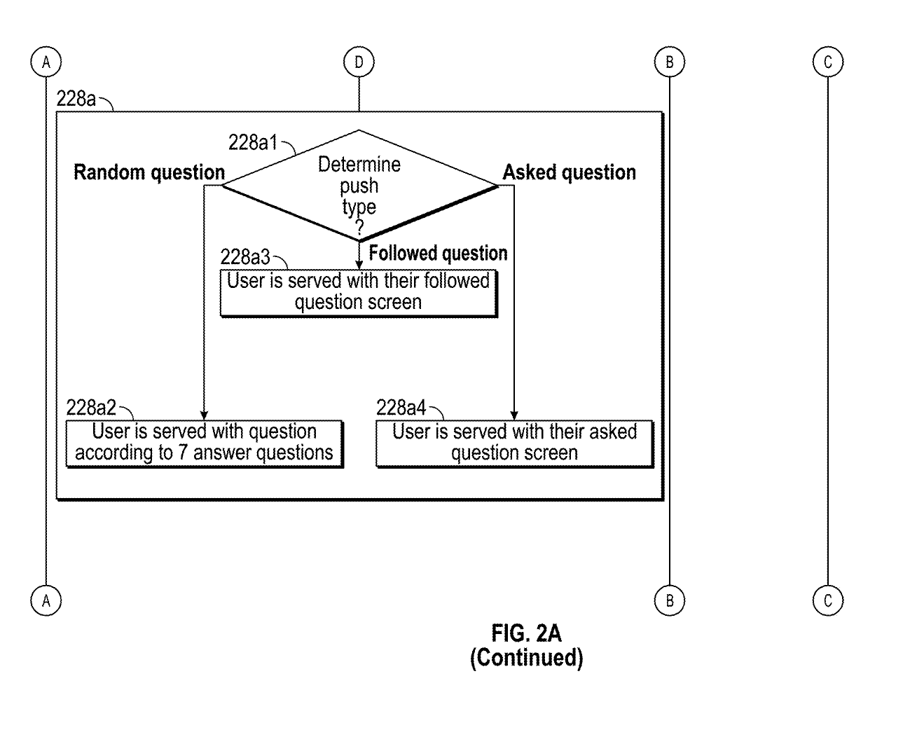

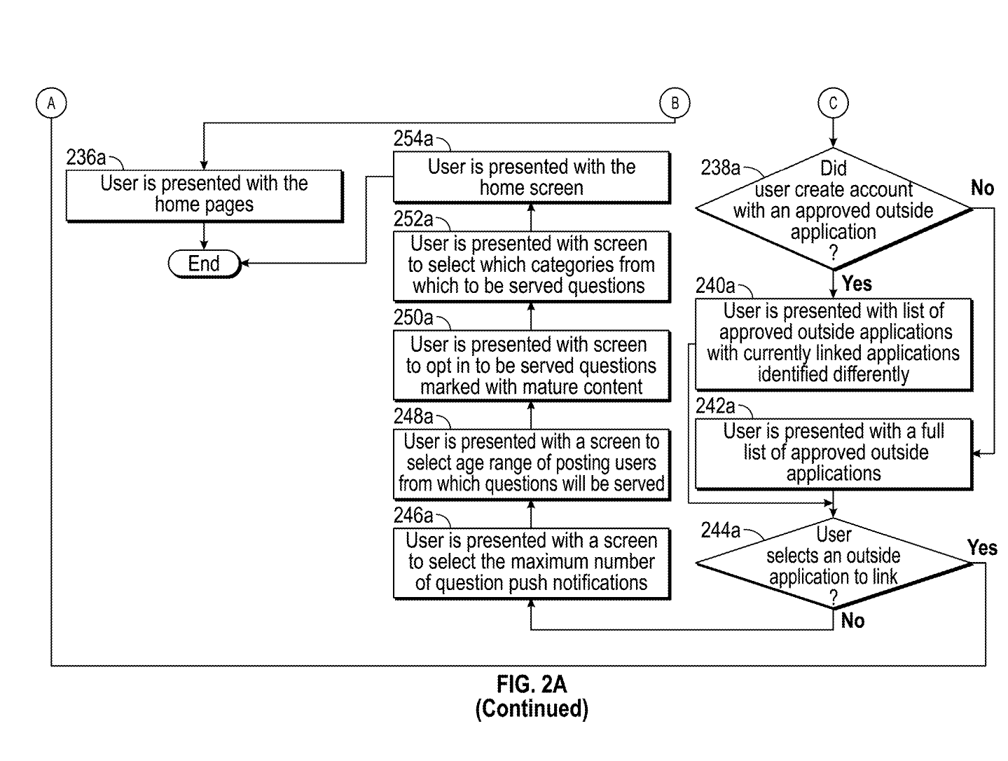

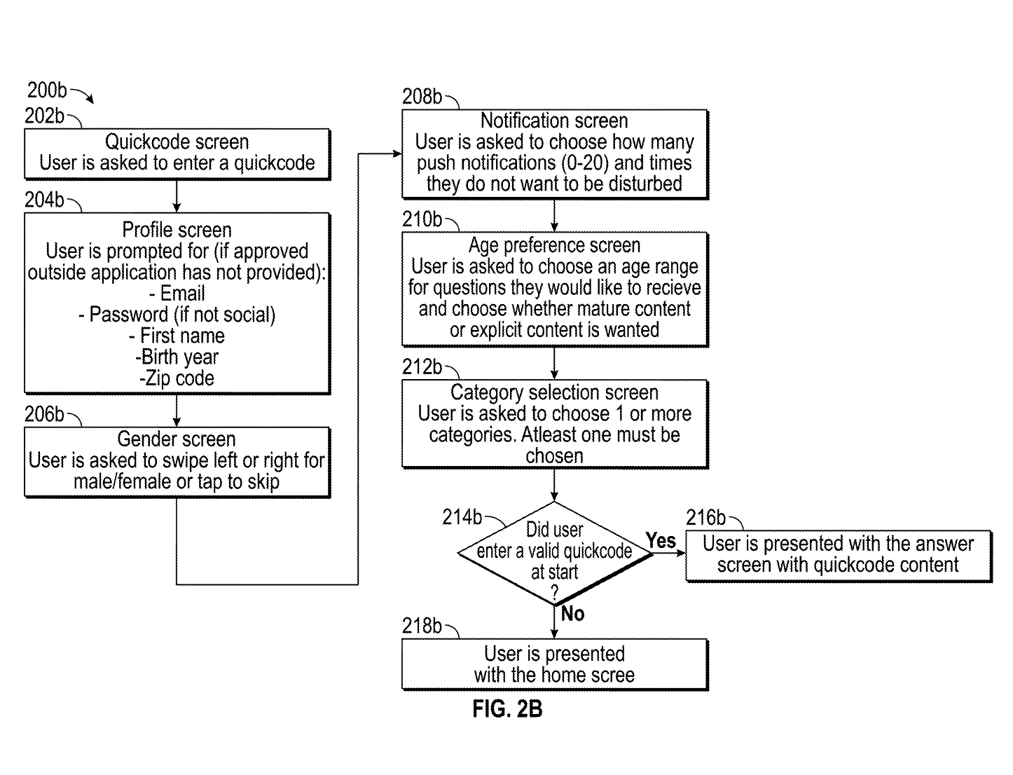

Referring to FIG. 2A is an illustration of a flowchart 200a, comprising of steps involved for the authentication process of the Zip user. The first step 202 has the user accessing the mobile app. At step 204a verification is performed to check whether the user has already created an account. If the enquiry at step 204a is Yes, then at step 206a ZIP enquires whether the user has opted to log in with an approved outside application. If the enquiry at step 206a is Yes, then at next step 208a the user is prompted to log in via social media and authorize ZIP to gather data which continues to the step 226a. In case the answer to the enquiry 204a is No, then at step 200a ZIP enquires whether the user opts to create an account with approved outside application. If the enquiry at step 210a is Yes, then the user is prompted to log in via social media and authorize ZIP to gather data at step 212a. Further, ZIP gathers relevant data and prompts the user to complete missing data from list as a next step 214a. The process from step 214a continues to step 218a. If the answer to the enquiry at step 210a is No, then the user creates an account with an email account as indicated in step 216a. This is further carried on to step 218a where the user is prompted for (if approved outside application has not been provided): e.g.—email—password—first name—last name—birth date—zip code—gender. The process continues to step 220a where the user is shown a screen on ZIP swiping actions which continues to step 222a where the user is shown screen to link social media accounts.

Referring back to the step to enquire at 206a, if the answer is No, then the user is prompted to login with email and password as cited in step 224a which further connects to step 226a where it is enquired whether the user has accessed the mobile app from push Notification. If the enquiry at step 226a is Yes, then the user is further directed to step 228a, or else the process ends at step 230a where the user is presented with the home page.

The step 222a continues to step 232a to enquire whether the user created an account with an approved outside application. If the enquiry at step 232a is Yes, then the user is presented with list of approved outside applications with currently linked applications identified differently as cited in step 234a. If the enquiry at step 232a is No, then at step 236a the user is presented with a full list of approved outside applications. The step 234a is further linked to a step 238a enquiring whether the user selects an outside application to link. If the enquiry at step 238a is Yes, the process links to step 208a and the process continues till the end. If the enquiry at step 238a is No, then the process continues to step 240a where user is presented with a screen to select the maximum number of question push notifications.

Further at step 242a ZIP ensures that the user is presented with a screen to select age range of posting users from which questions will be served. Next, at step 244 the user is presented with screen to opt in to be served questions marked with mature content and user is presented with screen to select which categories to be served questions at step 246a. Finally at step 248a the user is presented with the home screen ending the authentication process. Referring back to step 228a, it is further enquired about the push type to be determined at step 228a1. If the push type is random question based, then the user is served with questions at step 228a2. If the push type is a followed question, the user is served with their followed question screen at step 228a3. If the push type is Asked Question, the user is served with their asked question screen at step 228a4.

Referring to FIG. 2B is an illustration of a flowchart 200b, comprising of steps involved in for the QuickCode entry process for the authentication of the user. The process commences at step 202b by display of QuickCode screen where the user is asked to enter a QuickCode. At step 204b a profile screen is displayed where the user is prompted for (if approved outside application has been not provided): e.g., Email—Password (if not social)—First Name—Birth Year—Zip code. Further at step 206b the gender screen is displayed where the user is asked to swipe left or right for male/female or tap to skip. Further at step 208b a notification screen is displayed where the user is asked to choose how many push notifications (e.g., 0-20) they want to receive and times they do not want to be disturbed. In the age preference screen displayed at step 210b the user is asked to choose an age range for questions they would like to receive and choose whether mature content or explicit content is wanted. In the category selection screen at step 212b the user is asked to choose 1 or more categories. Here, the user has to choose at least one. Further at step 214b it is enquired whether the user has entered a valid QuickCode at start. If the enquiry at step 216b is Yes then, the user is presented with the answer screen with QuickCode content at step 216b. If the enquiry to step 214b is No, then the user is presented with the home screen at step 218b.

On setup, a user may be presented the opportunity to select certain “push” settings. These settings could control, for example, the frequency, content, timing, or other features of the questions that are provided via push notification to the user. Such settings could include, for example, the number of such notifications, timing or other “do not disturb” related features, the general subject matter of the questions pushed, or any other feature of questions on which a user may desire to filter such questions. A user may also select age related filters, such as allowing for “mature content,” blocking material not suitable for children, opting into content dedicated to a certain age group, or any other age related classification.

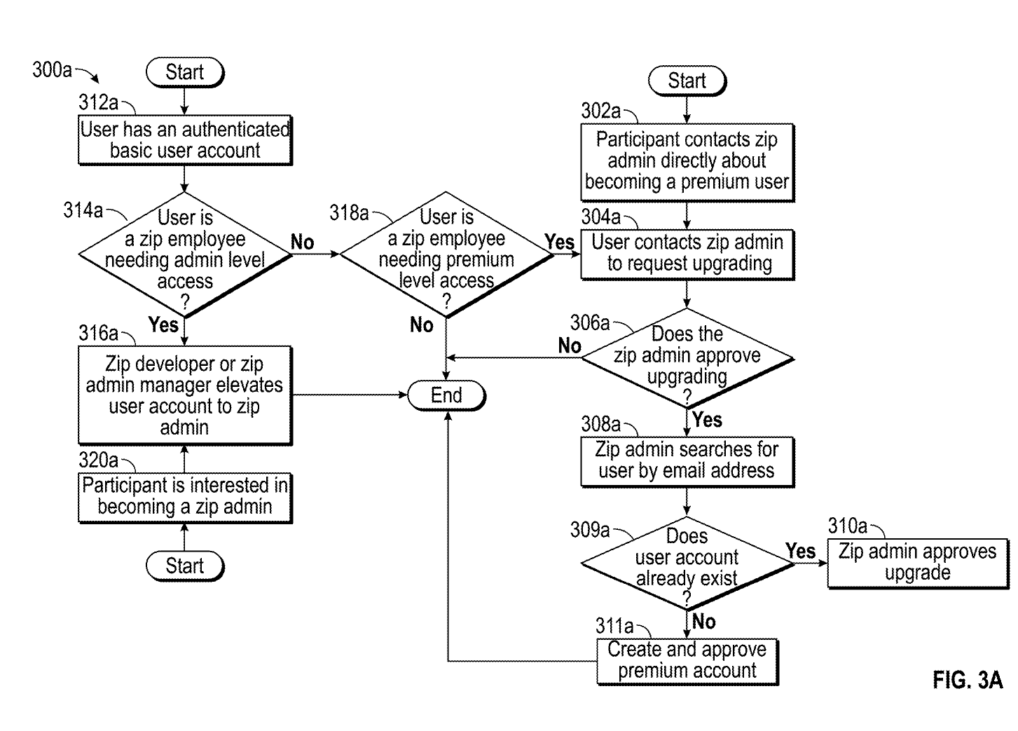

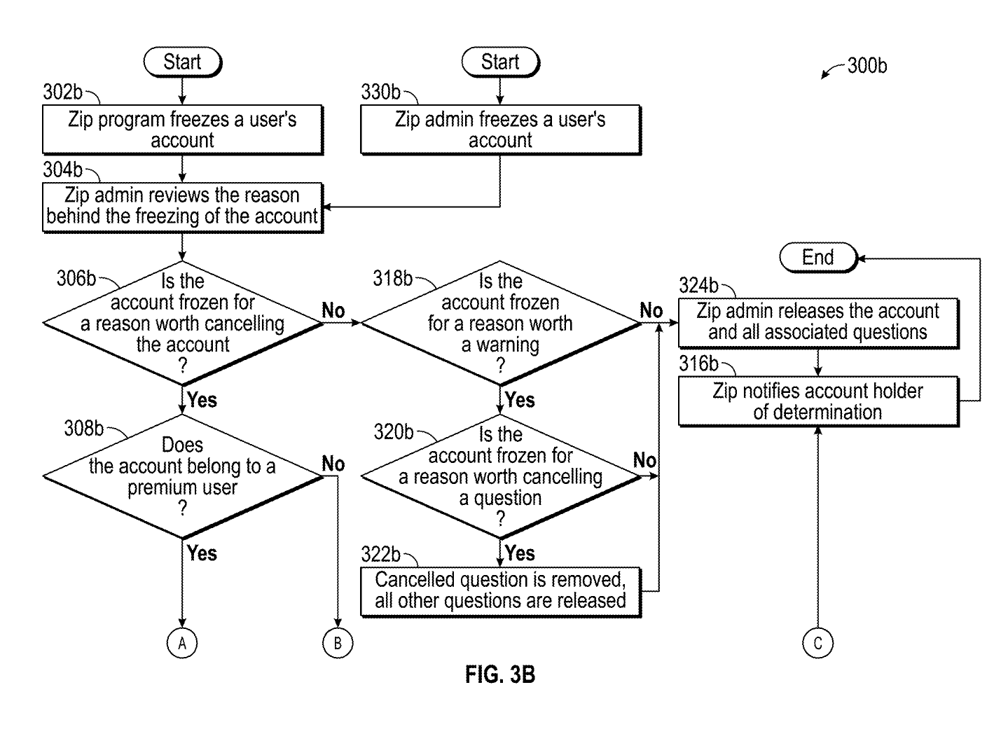

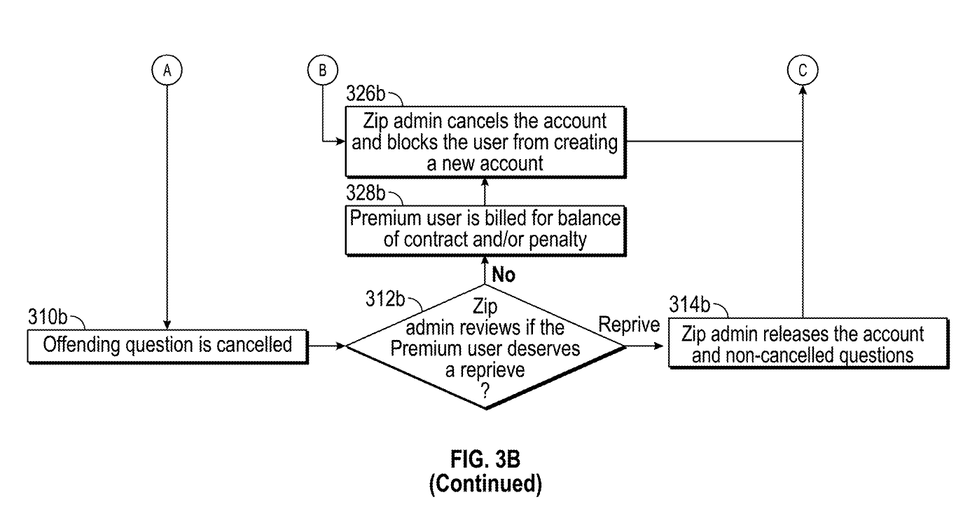

Referring to FIG. 3A is an illustration of a flow chart 300a, comprising of steps involved in the authorization process of the user. The commencement of the process can be described in three cases, for example. In this example, the process of Case I starts at step 302a where the participant contacts a ZIP admin directly about becoming a premium user. Step 304a involves the user contacting the ZIP admin to request an upgrade. At step 306a it is enquired if the ZIP admin approves upgrading. If the enquiry at step 306a is Yes, then at step 308a ZIP admin searches for the user through email address. The process continues to step 309a where it is enquired whether the user account already exists. If the enquiry to step 309a is Yes, then the process continues to step 310a where the ZIP admin approves an upgrade by authorizing the user. If the enquiry to step 309a is No, then at step 311a a premiere account is approved and created.

The process of case II commences at step 312a where the user has an authenticated basic account. At step 314a ZIP enquires whether the user is a ZIP employee in need of an admin level access. If the enquiry at step 314a is Yes, then the ZIP developer or admin manager elevates user account to ZIP admin as notified in step 316a. If the answer to the enquiry at step 314a is No, then it is further enquired at step 318a whether it is a ZIP employee needing a minimum level access. If the enquiry at step 318a is Yes, then connectivity is established to step 304a the enquiry at step 318a is No, then the process ends.

Referring to FIG. 3B is an illustration of a flowchart 300b, comprising of steps involved in the account freeze process of the user. The process commences at step 302b where the ZIP program freezes a user's account. The process also commences at step 330b where the ZIP admin freezes a user's account. Both the steps 302b and 316b are connected to step 304b where the ZIP admin reviews the reason behind the freezing of the account. It is enquired at step 306b whether the account is frozen for a reason worth cancelling. If the enquiry at step 306b is Yes, then it is enquired further at step 308b whether the account belongs to a premium user. If the enquiry at step 308b is Yes, then the offending question is cancelled at step 310b. Further the process continues by enquiring at step 312b where the ZIP admin reviews if the premium user deserves a reprieve. If the enquiry at step 312b is Yes, then the ZIP admin releases the account and non-cancelled questions at step 314b. The process continues to step 316b where ZIP notifies the account holder of determination by ending the process. In case the enquiry at step 306b is No, then it is further enquired whether the frozen account is worth a warning at step 318b. If the enquiry at step 320b is Yes, then it is further enquired at step 320b whether the frozen account is worth cancelling a question. If the enquiry at step 320b is Yes, then cancelled question is removed and all other questions are released at step 322b. In case the enquiry of step 318b is No, then it is connected to step 324b along with step 322b. Further at step 324b ZIP ensures that ZIP admin releases the account and all associated questions. This further connects to step 316b which ends the process. In case the enquiry at step 308b is No, then it connects to step 326b where ZIP admin cancels the account and blocks the user from creating a new account. This continues to step 316b which further ends the process. Finally if the enquiry at step 312b is No, then premium user is billed for balance of contract and/or penalty. This process continues by connecting to step 326b.

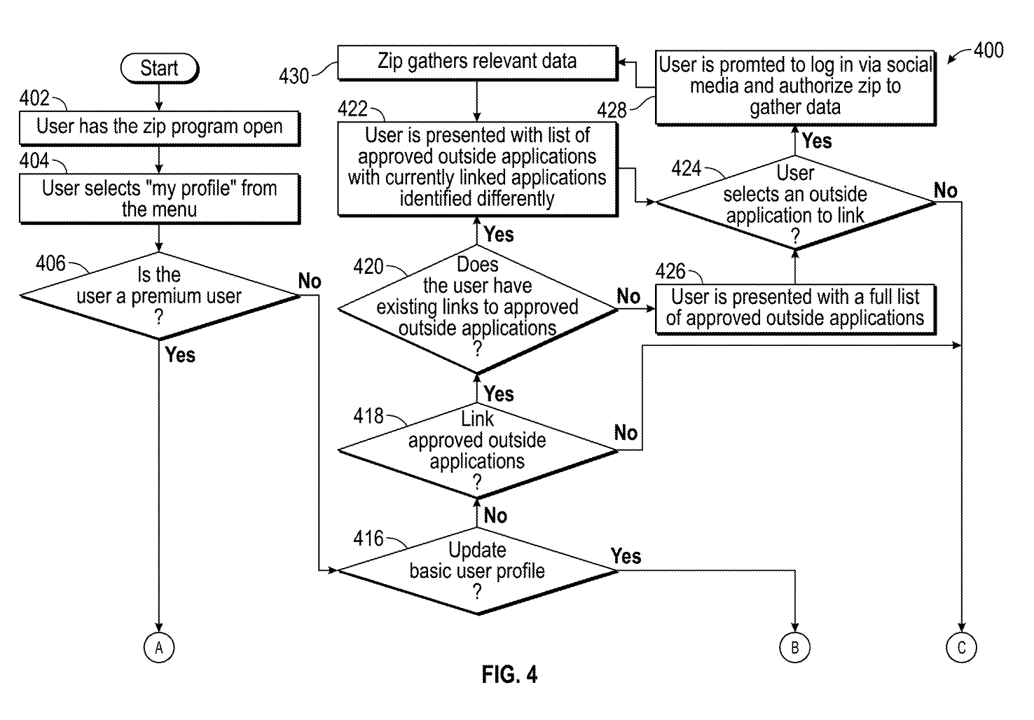

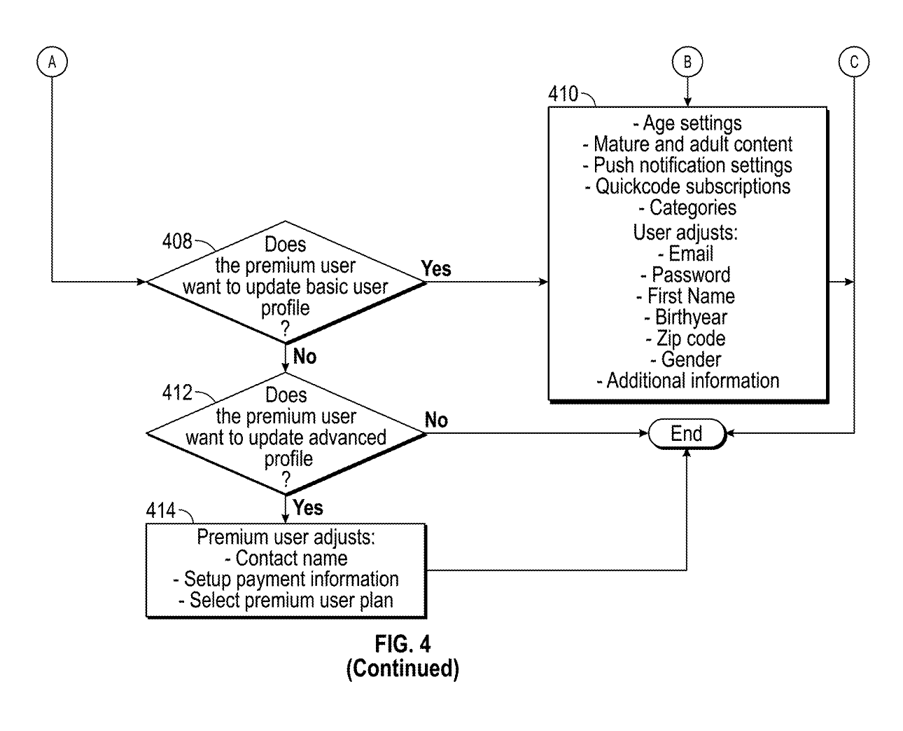

Referring to FIG. 4 is an illustration of a flow chart 400, as a continuation to the steps involved in the profile set up of the user. The commencement of the process is through step 402 where the user has the ZIP program open. This is followed by step 404 where the user selects “my profile” from the menu. Further at step 406 it is enquired whether the user is a premium user. If the enquiry at step 406 is Yes, then further enquiry takes place at step 408 to check if the premium user wants to update basic user profile. If the enquiry at step 408 is Yes, then at step 410 the user adjusts: e.g., Email—Password—First Name—Birth year—Zip code—Gender—Additional information comprising of Age settings/mature & adult content/push notification settings/quickcode subscriptions/categories. If the enquiry at step 408 is Yes, then at step 410 the user adjusts: e.g.—Email—Password—First Name—Last Name—Birthdate—Zip code—Gender—Additional information. If the enquiry at step 408 is No, then a further enquiry at step 412 is done to check whether the premium user wants to update an advanced profile. If the enquiry at step 412 is Yes, the user adjusts: e.g., Contact name—Setup payment information—Select premium user plan at step 414 thus ending the process. If the enquiry at step 412 is No, then the process ends. If the enquiry at step 406 is No, then then it is further enquired at step 416 whether an update of basic user profile is done. If the enquiry at step 416 is Yes, then the process continues to step 410. If the enquiry at step 416 is No, then a further enquiry about link being approved outside applications is done at step 418. If the enquiry at step 418 is Yes, then a further enquiry at step 420 is done to know whether the user has existing links to be approved outside the applications. If the enquiry at step at step 420 is Yes, then the user is presented with list of approved outside applications with currently linked applications identified differently at step 422. The further continuity is established at step 424 where it is enquired whether a user selects an outside application to link. If the enquiry at step 424 is Yes, then the user is promoted to log in via social media and authorize ZIP to gather data at step 428. Further at step 430 ZIP gathers relevant data and gets connected to step 422. If the enquiry at step 418 is No, then the process ends. Further if the enquiry at step 420 is No, then the User is presented with a full list of approved outside applications at step 426. Further if the enquiry at step 424 is No, then the process ends.

After initial registration, a user may be presented with an application home screen. This screen could include, for example, an icon notifying the user of the number of questions waiting in a queue to be answered, based on that user's preferences. At the home screen, the user could be presented with the option to either formulate and ask its own questions, or answer questions that have already been formulated by other users. The user may also be presented with an option to enter a QuickCode or other unique identifier, which will be discussed in further detail below.

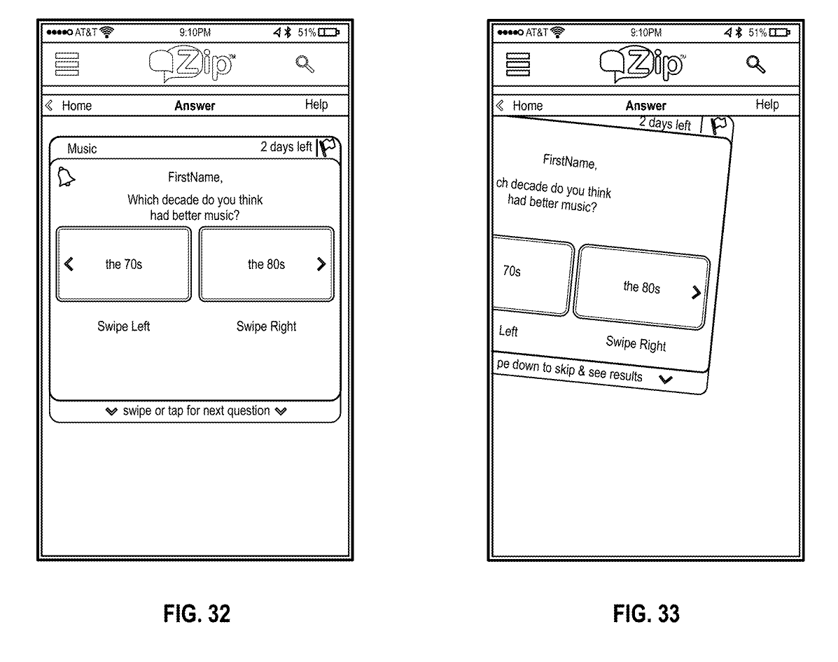

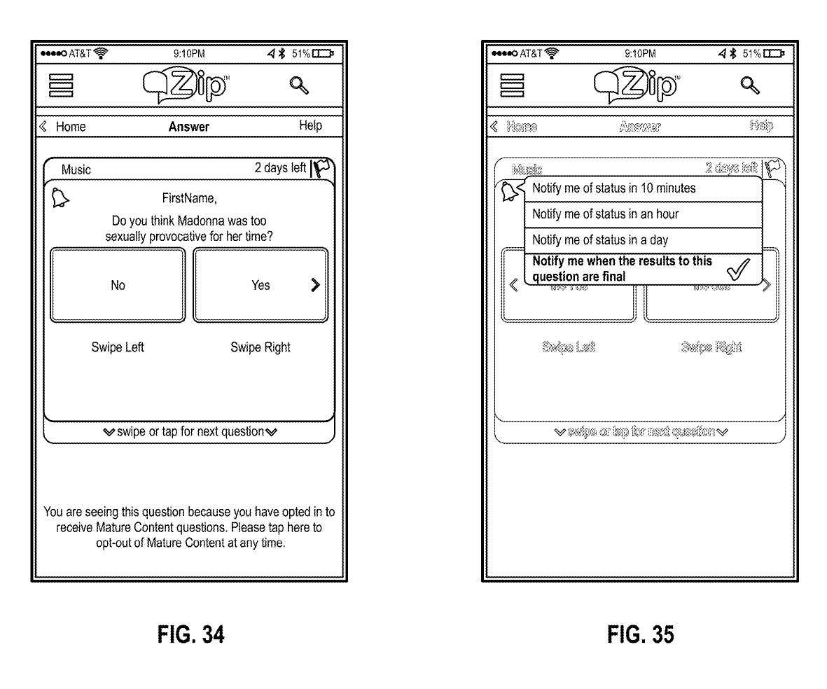

If a user selects to answer a question, the user may be presented with an “answer question” screen, depicted for example in FIG. 29. The “answer question” screen may present to the user a card containing the question, answers, and other icons, depicted for example in FIGS. 31, 32, 35, and 37. The question may be presented in another suitable fashion as well. The card could be movable in the direction of a swipe across the screen of the user's internet connected mobile device. For example, if a user were to swipe the screen in the right direction, the card could move to the right, depicted for example in FIG. 33. The same could be true for a swipe in any direction, including for example, left, up, down, diagonal, etc.

The card presented to the user may indicate the category of the question or other relevant information about the question itself, and also indicate when the question is set to be closed for further responses, and thus “settled.” The card will also include the question itself and the potential responses. Responses may be selected by swiping the card in a particular direction. For example, if there are two potential answers, one may be selected by swiping the card in the right direction, while another response may be selected by swiping the card in the left direction. The question may be skipped by swiping the card in yet a different direction, for example by swiping the card up and off the screen of the electronic device. Users may be able return to the previously asked question if they answered incorrectly or by accident. Such a feature could be limited to only premium users, paid users, or some other unique category of user.

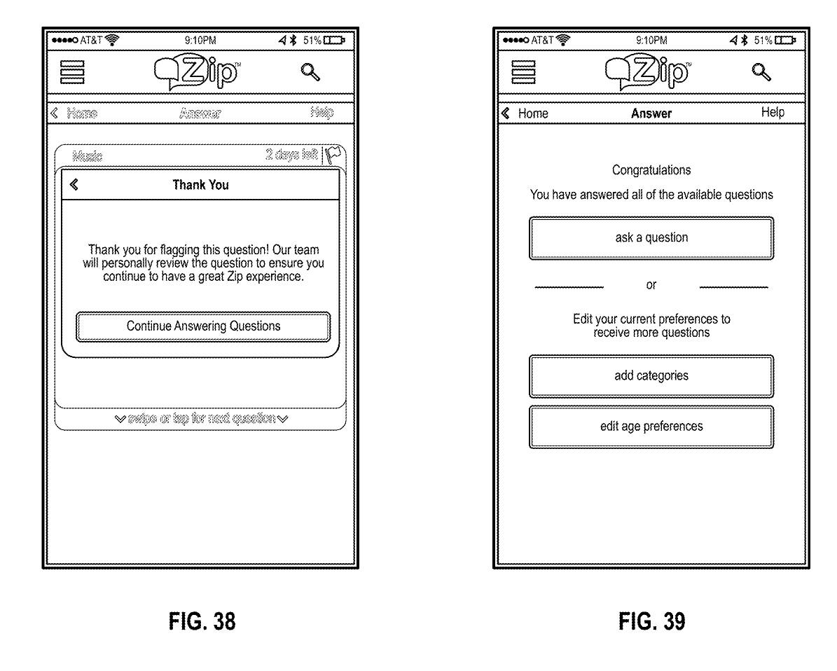

The card may present other icons in addition to the question and answers. For example, the card may include a bell icon, which when activated will serve to notify the user of the results of the question when it is settled, after a certain amount of time has passed, or on some other comparable notification criteria, depicted for example in FIG. 35. The card may also include, for example, a flag icon that will allow a user to identify content that is inappropriate, miscategorized, or otherwise in need of further review, depicted for example in FIGS. 37 and 38.

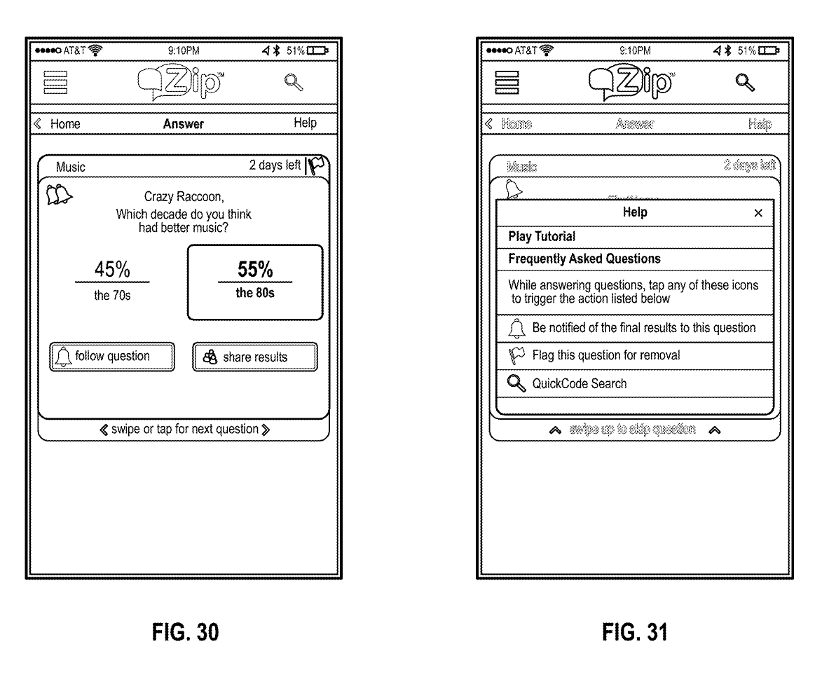

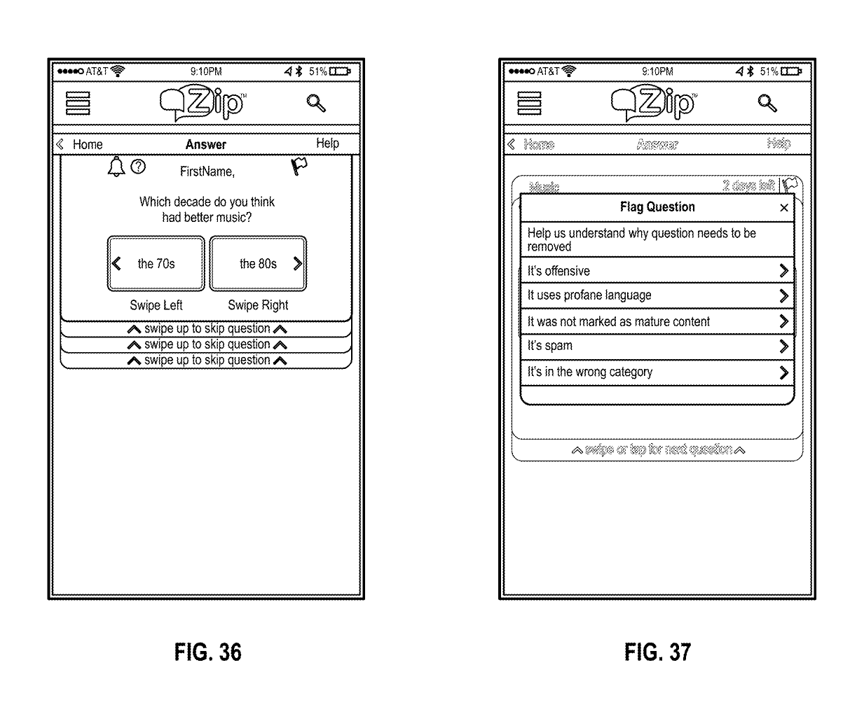

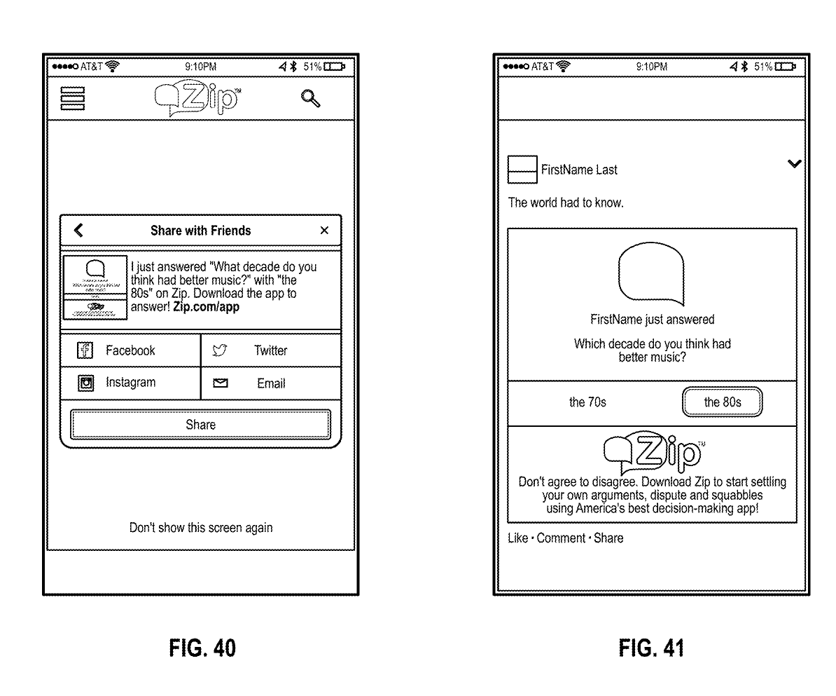

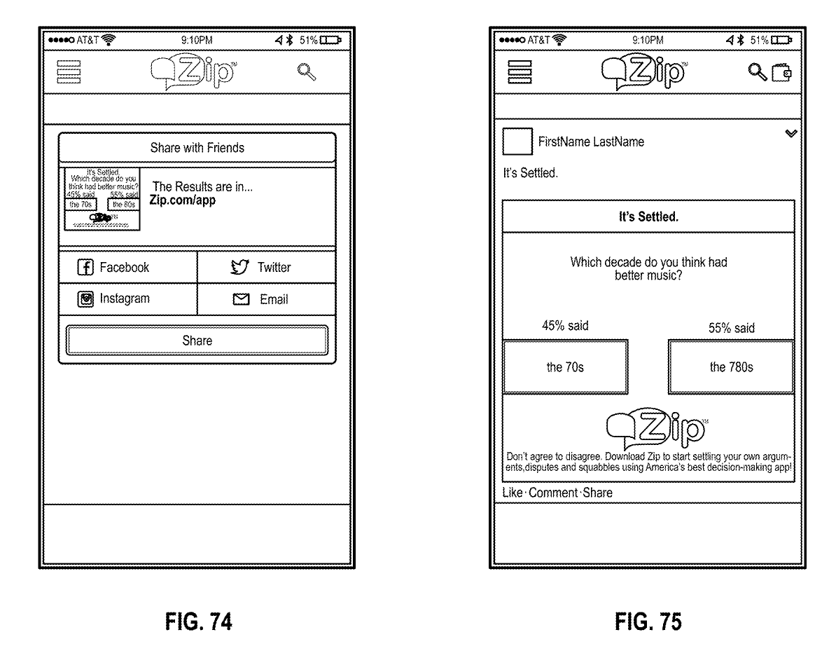

After a user responds to a question card, that user could then be shown a results page that shows a current summary of the result of the question, for example by indicating percentages of responses for each possible answer received thus far, depicted for example in FIG. 30. When a user has answered all possible questions that are available based on their filtering criteria, the user may be informed that no more questions remain, and then be prompted to expand or alter their filtering criteria to receive new questions, depicted for example in FIGS. 36 and 39. Additionally, a user may be able to share, for example via other social networking platforms or email, questions it has been asked, answers it has provided, or results that have been generated thus far, depicted for example in FIGS. 40, 41, 49, 50, 74, and 75.

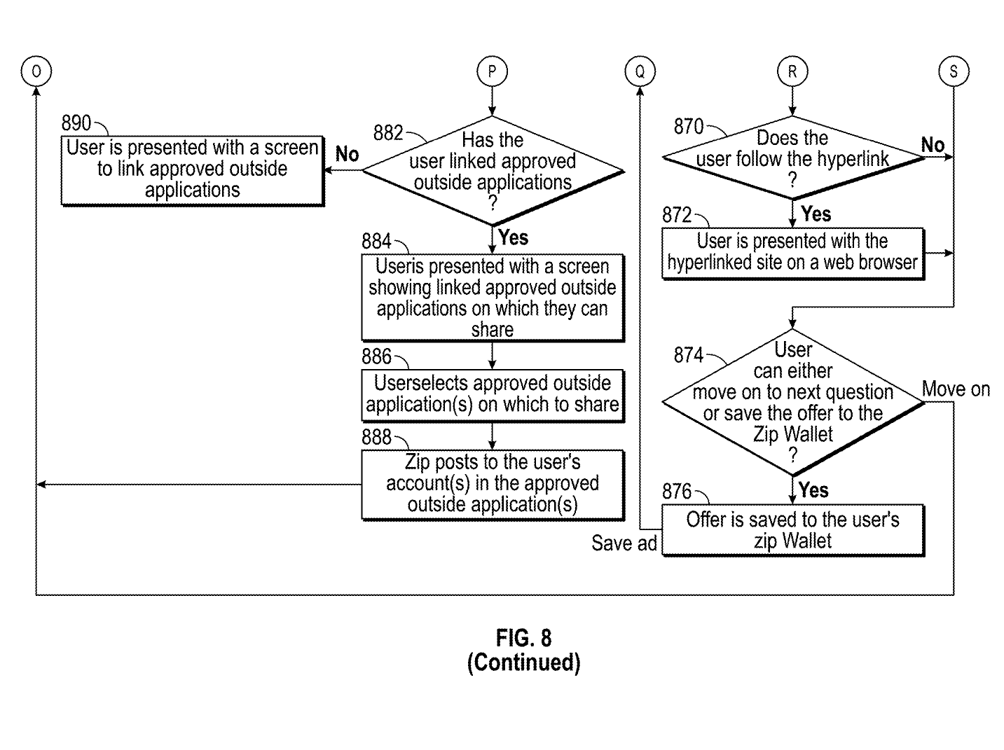

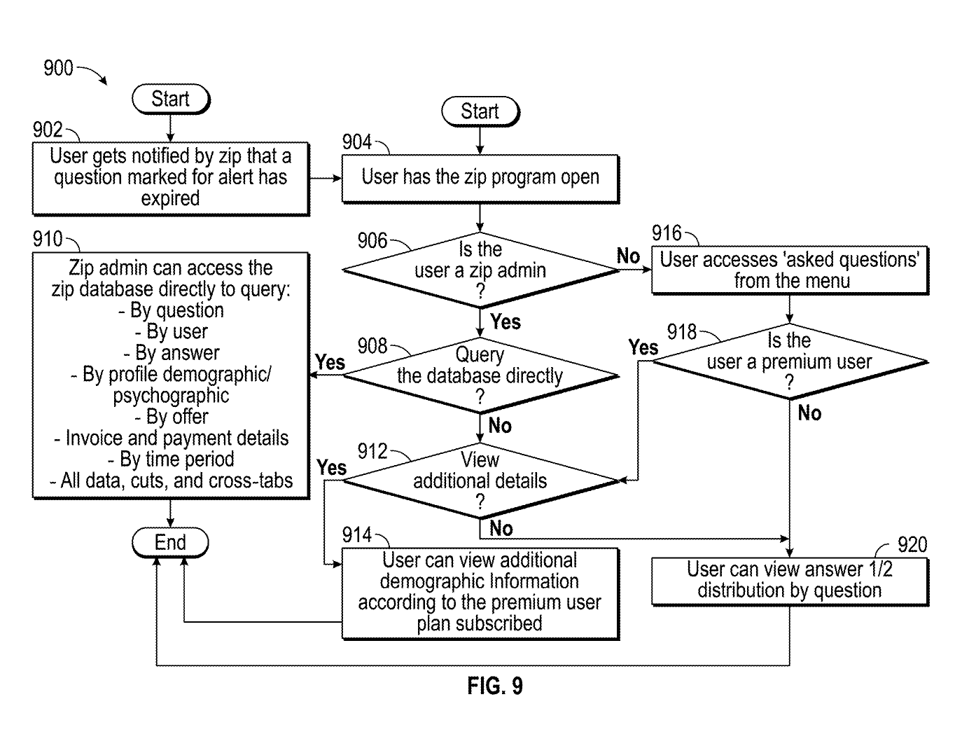

Referring to FIG. 9 is an illustration of a flowchart for “Viewing Poll Results”. The process starts at step 902 where the user gets notified by ZIP that a question marked for alert has expired. Another step to start is step 904 where the user has the ZIP program open. An enquiry is made at step 906 to check whether the user is a ZIP admin. If enquiry at step 906 is Yes, then a further enquiry to query the database directly is raised at step 908. If enquiry at step 908 is Yes, then ZIP admin can access the ZIP database directly to query: e.g.—By question—By user—By answer—By profile demographic/psychographic—By offer—Invoice and payment details—By time period—All data, cuts, and cross-tabs at step 910. If the query of step 906 is No, then at step 916 the user accesses the “asked questions” from the menu. Then the process continues to step 918 where it is enquired whether the user is a premium user. If the enquiry at step 918 is Yes, then it is further enquired at step 912 if additional details can be viewed. If enquiry at step 912 is Yes, then at step 914 the user can view additional demographic information according to the premium user plan subscribed thus further ending the process. In case the enquiry for step 908 is No, then it is connected to step 912 for further query to view additional details. Finally if the query for step 912 is No, and also if the query for step 918 is also No then they get connected to step 920.

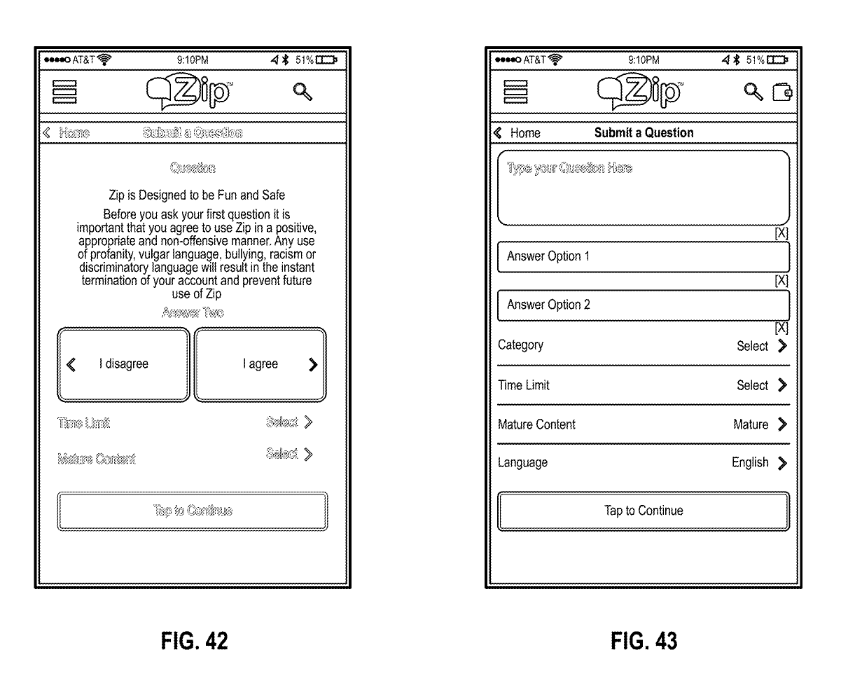

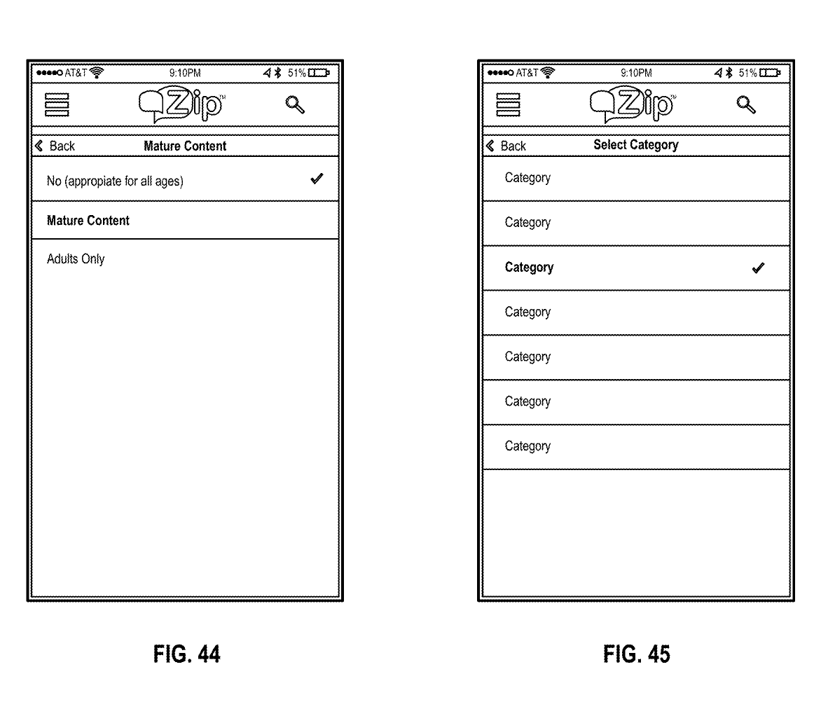

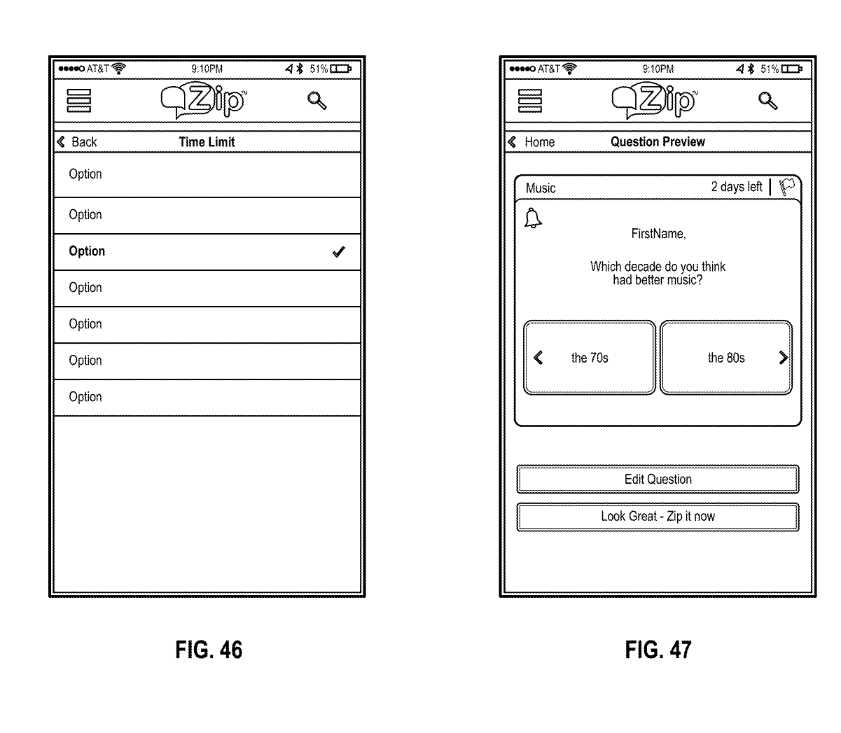

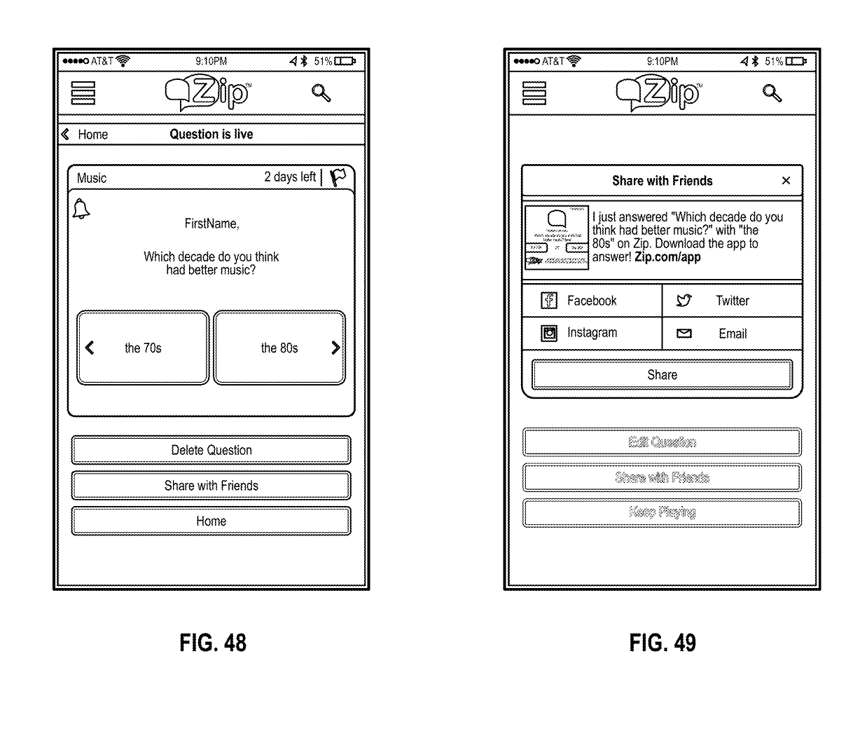

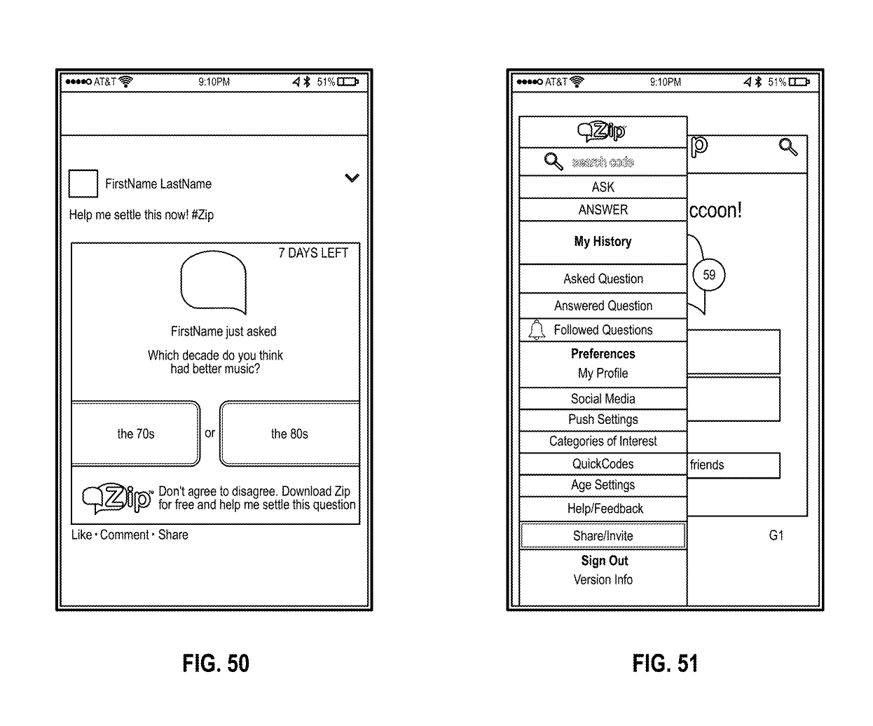

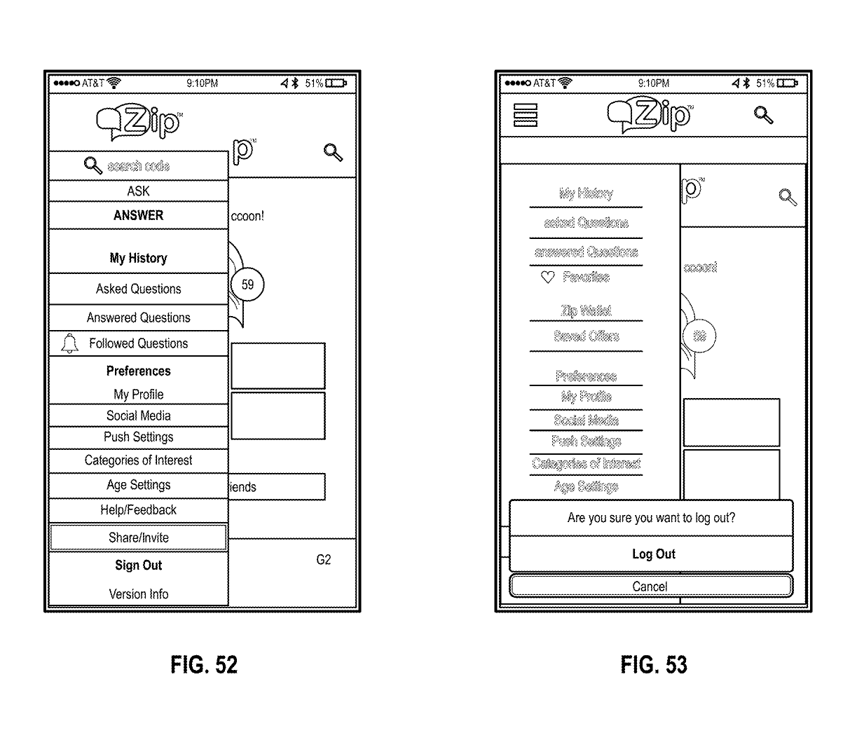

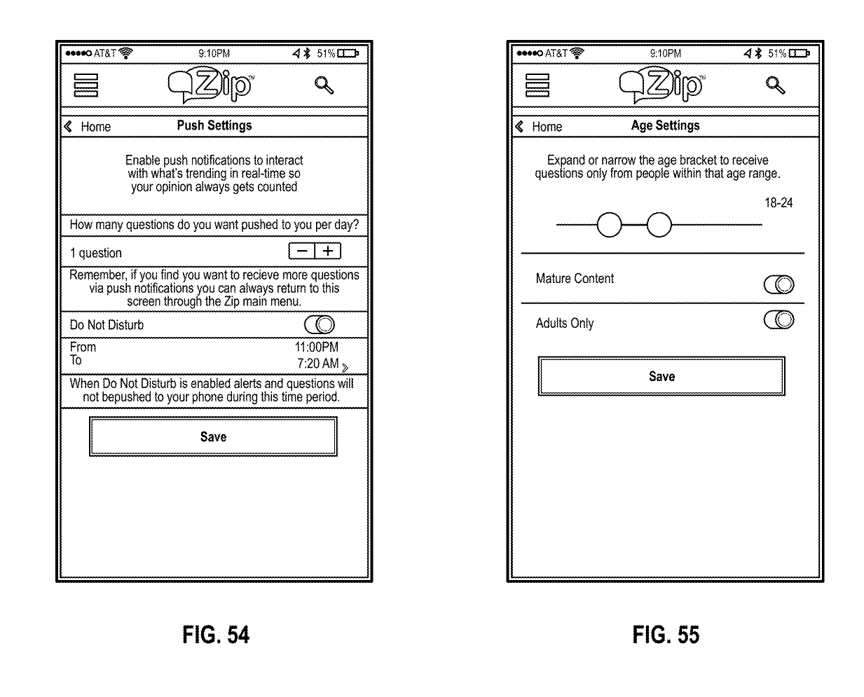

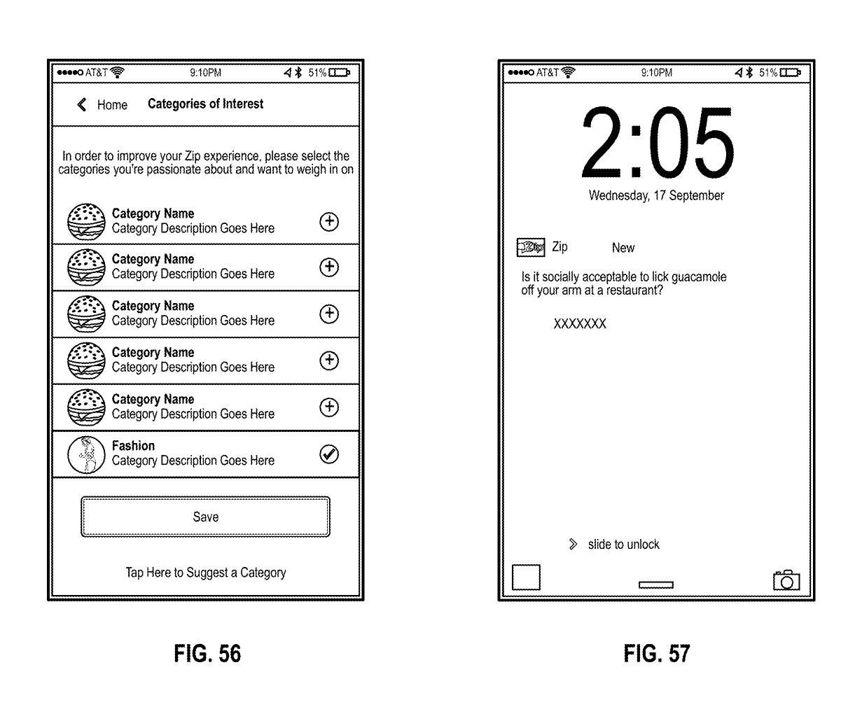

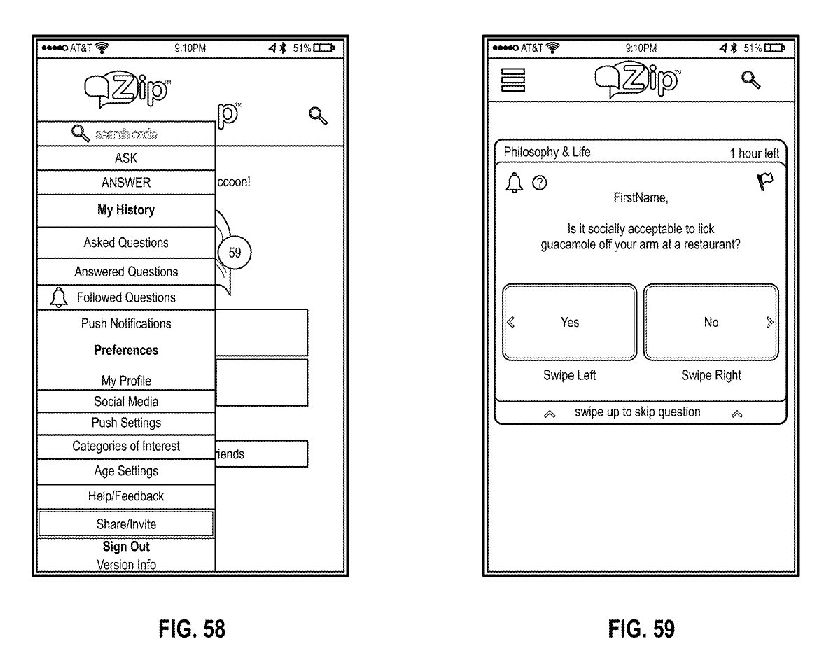

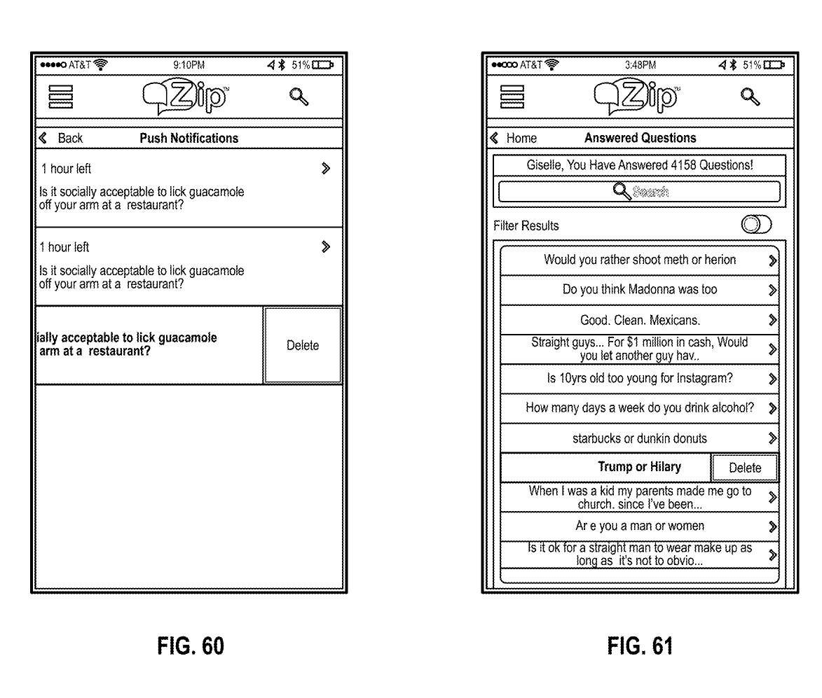

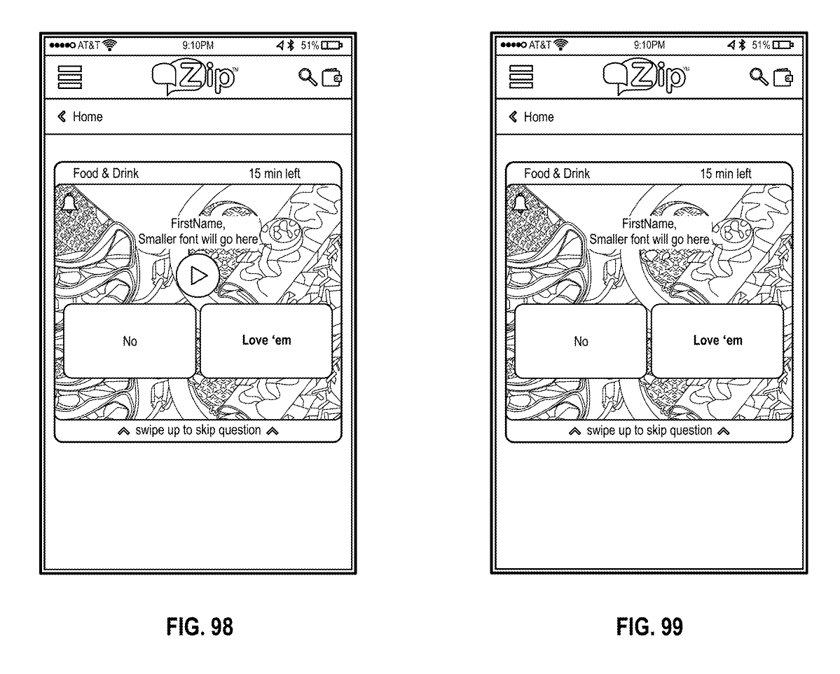

If a user selects to enter a question, the user may be presented with a screen allowing entry of the question and potential answers, depicted for example in FIGS. 42 and 43. In one embodiment, the screen may allow for the entry of questions and answers in text only, depicted for example in FIG. 43. Alternatively, questions and answers may also include all types of media, such as photos, video, links to other URLs, or audio alone or in combination with text, depicted for example in FIGS. 98, 99, and 100. In one embodiment, questions may be limited to only two responses. In another embodiment, it may be permissible to include three or more responses. In another embodiment, it may be permissible to allow for a “write in” response of the respondent's choosing. In another embodiment, creating questions and answers with media other than text only may be limited to premium users. Other features of the questions may also be provided, such as a time limit or other expiration trigger, or an identification of whether the question contains mature content, depicted for example in FIGS. 44, 45, and 46. A user may also classify the question in one or more categories spanning one or more age groups, or other demographic and psychographic variables. A user may then be permitted to preview the resulting question card before it is finalized, depicted for example in FIGS. 47 and 48. A user may also be able to share a question it has generated on other social media outlets or other forums, depicted for example in FIGS. 49 and 50.

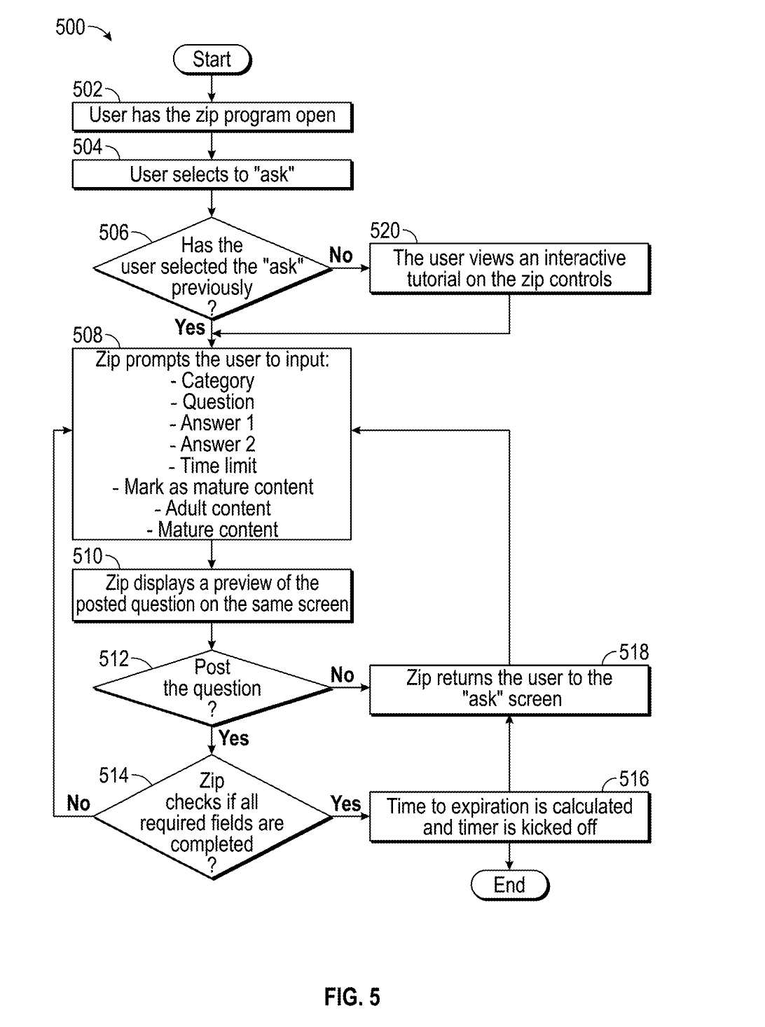

Referring to FIG. 5 is a step by step illustration of a flowchart 500, comprising of steps involved for an “Ask Basic Question” process. The process commences step 502 where the user has the ZIP program open. Further, the user selects “ask” at step 504. The continuity of the process at step 506 is through an enquiry whether the user has selected the “ask” previously. If the enquiry at step 506 is Yes, then ZIP prompts the user to input: e.g. Category—Question—Answer 1—Answer 2—Time limit—Mark “Adult Content & Mature Content” at step 508 and if the enquiry at step 506 is No, then the user views an interactive tutorial on ZIP controls at step 520 and connection then continues to step 508. From step 508 ZIP displays a preview of the posted question on the same screen at step 510. Further at step 512 it is enquired if a question has been posted. If the enquiry at step 512 is Yes, then at step 514 it is enquired if ZIP has checked the required fields to be completed. If the enquiry at step 514 is Yes, then Time to expiration is calculated and timer is kicked off at step 516 and the process is ended as a first case and as a second case step 516 continues to step 518 where ZIP returns the user to the “ask” screen. The step 518 further continues to step 508. If the enquiry at step 512 is No, then the step is connected to step 518 and the process continues.

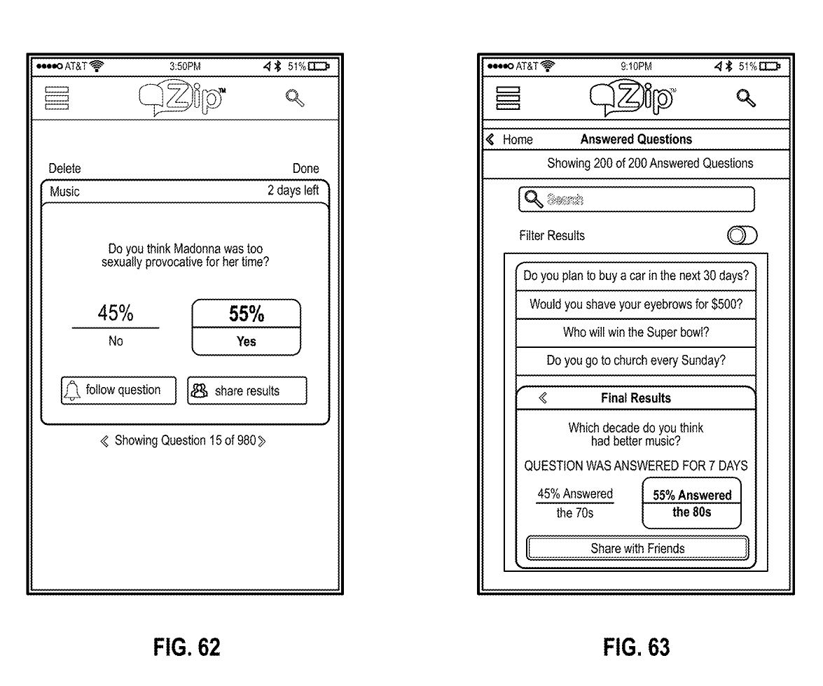

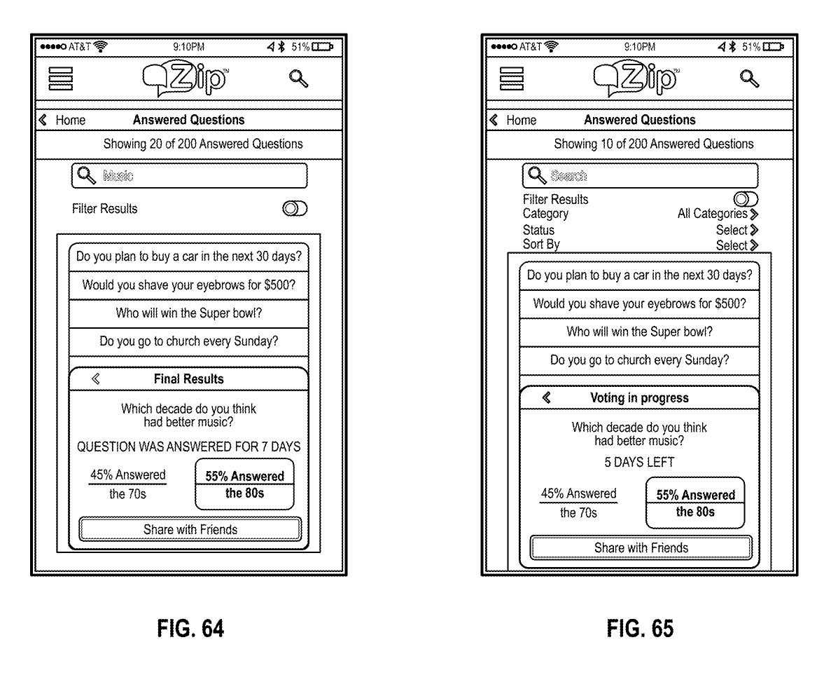

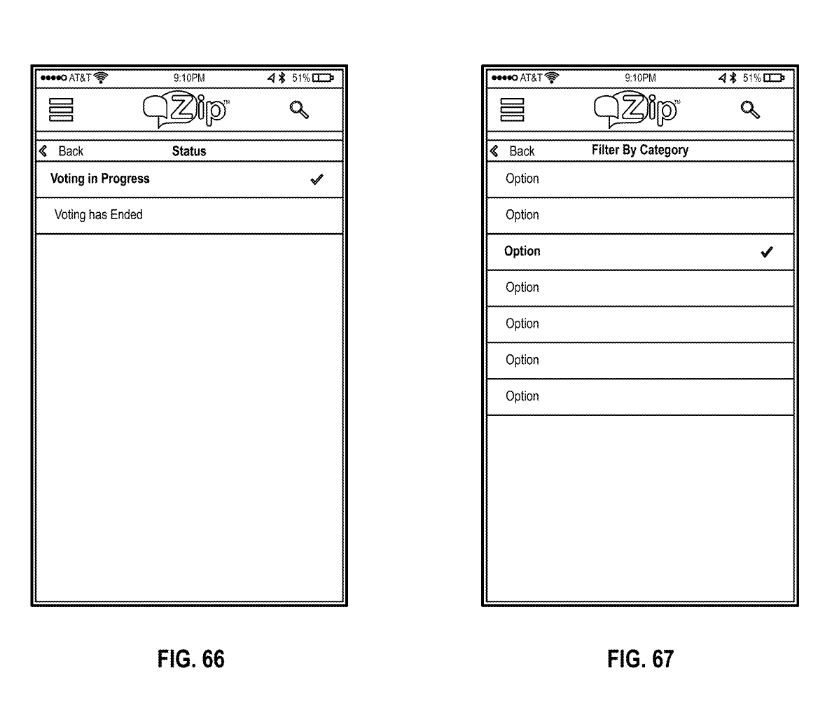

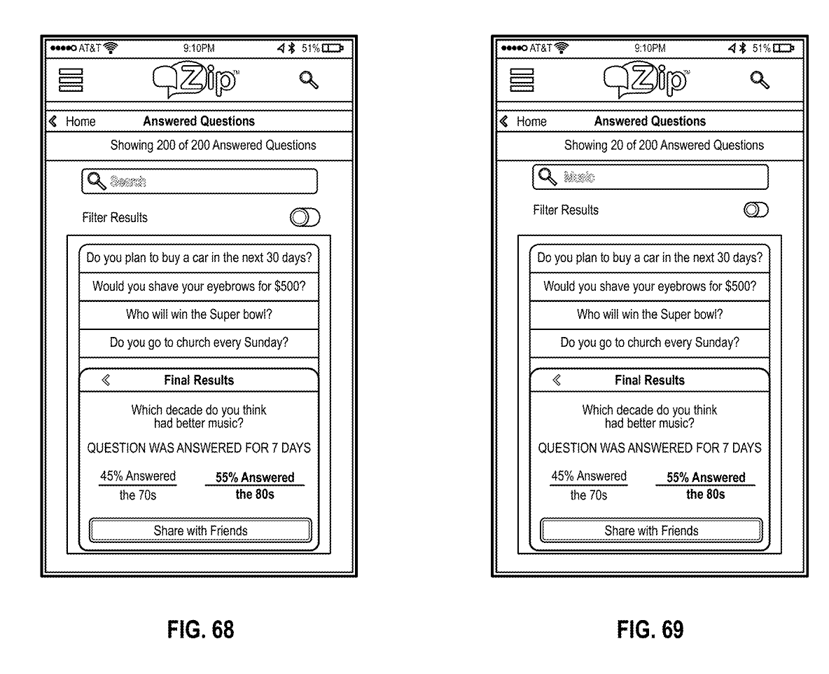

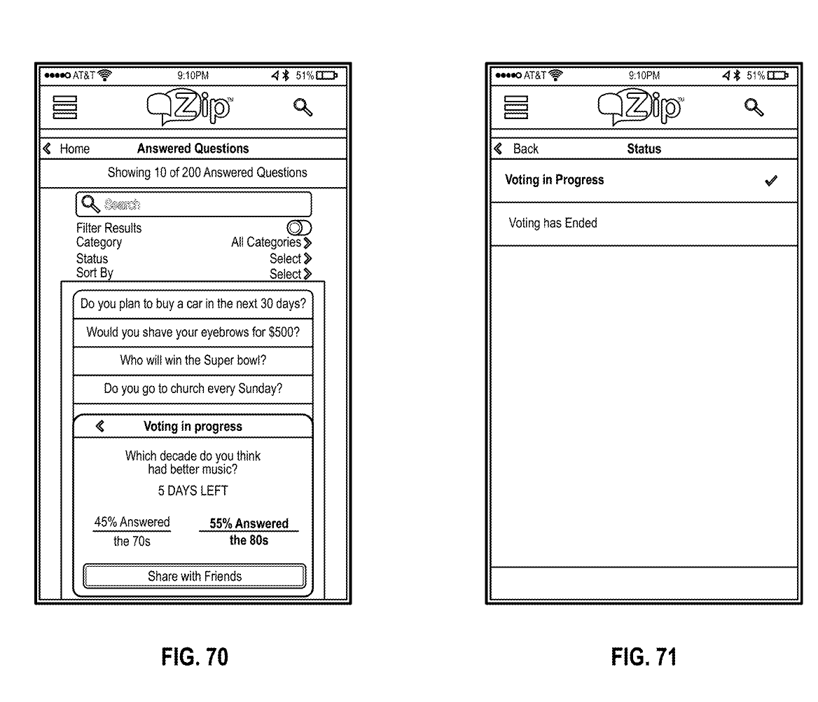

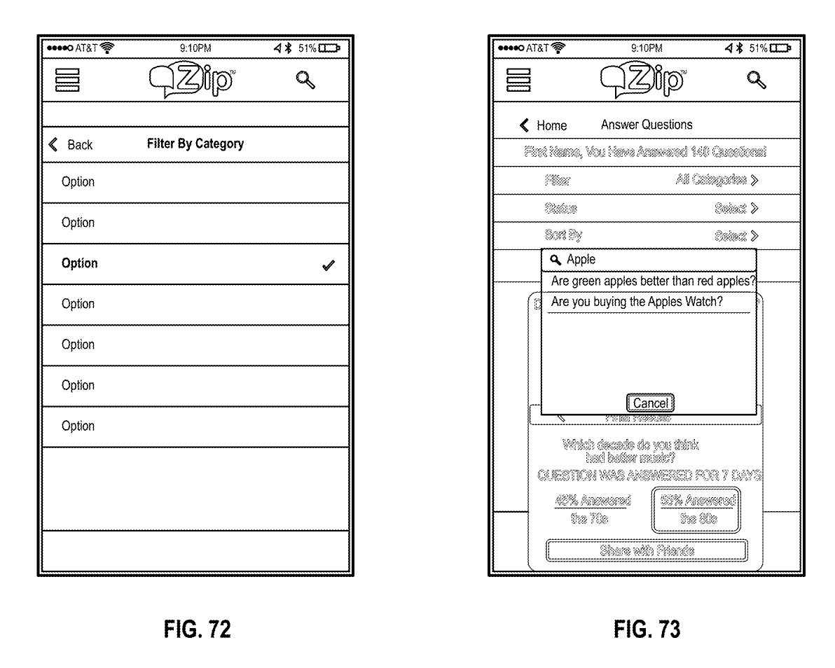

A user may be able to access a historical repository of questions that it has asked or answered. These repositories may allow the user to access these prior question cards and review the results of such questions, depicted for example in FIGS. 61-73.

In another embodiment, the systems and methods can be used by industry partners to reach, query, and collect responses from users. The application has relevance and utility for partners in every industry including media and broadcasters across all mediums, venues, or brands and businesses, advertisers, marketers, venue operators, and others that would benefit from direct contact and interaction with users and potential customers.

In this embodiment, industry partners may be referred to as “premium users” or another designation indicating the advanced status of such partners. Individuals or other entities may also become premium users, for example by paying a fee. Such premium users may have access to information, functionality, or other features that may not be available to, or may be hidden from, other users.

In one embodiment, premium users may be provided with a dedicated feed or channel associated with a specific, unique code. Such a code may be referred to as a QuickCode This code could be letters, numbers, symbols, a PIN, or other comparable mechanism to uniquely identify the feed or channels associated with a premium user. Each code can be unique to, and associated with, only one premium user, but a premium user may be in possession of more than one QuickCode. The QuickCode includes the ability to enter it and jump to one unique question, and thus the channel it resides within. Once entered, the QuickCode may direct a user to a particular segment of the content itself within a larger stream (whether randomized or organized in some manner). As one example, a QuickCode for the New York Yankees may be “Yankees.” As another example, a QuickCode for the radio station 106.7 FM in Los Angeles may be “KROQ.” A premium user may select a simple and readily identifiable QuickCode so that the code will be memorable, or so that the code will be readily identifiable with the controller of that code. As another example, a premium user may select a QuickCode that is a series of digits or numbers or symbols, for yet other reasons.

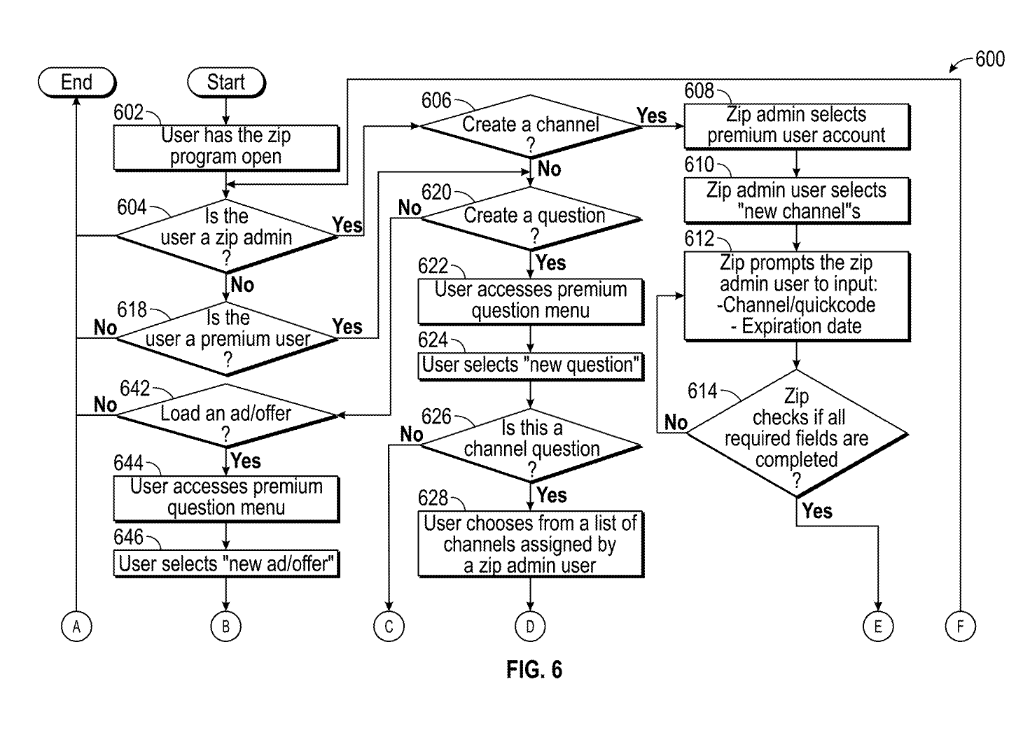

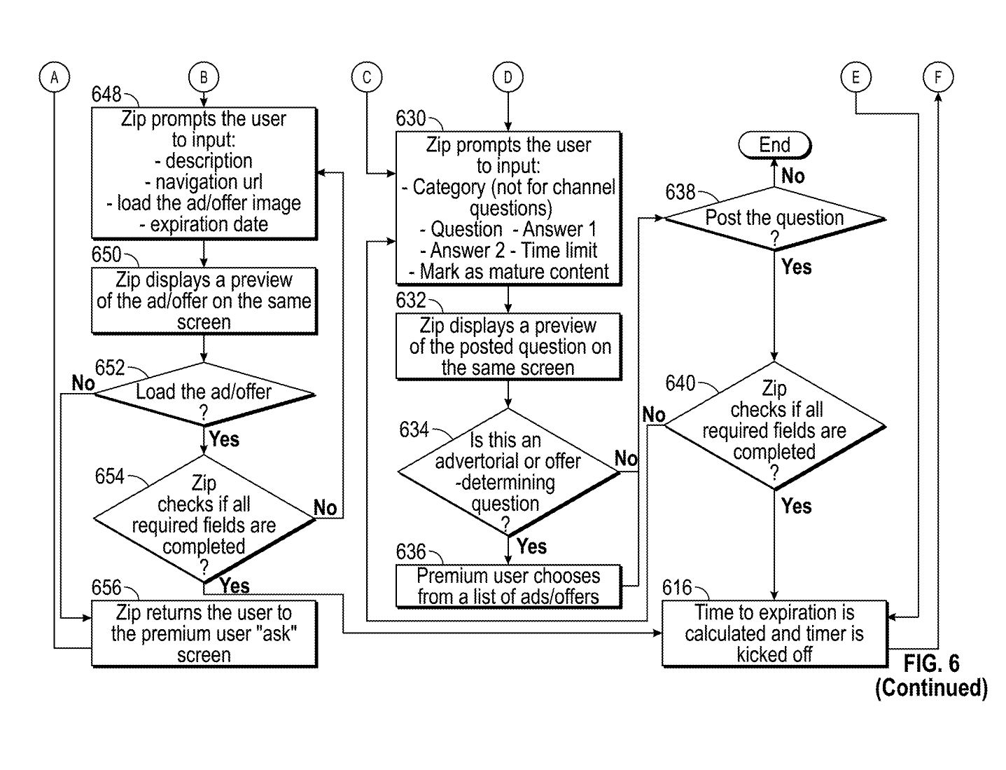

Referring to FIG. 6 is an illustration of flow chart 600, comprising the steps involved for “Ask Channel Question” Process. The process starts at step 602 where the user has the ZIP program open. Further at step 604 it is enquired whether the user is a ZIP admin. If the enquiry at step 604 is Yes, then an enquiry about creation of a channel is made at step 606. If the enquiry at step 606 is Yes, then ZIP admin selects Premium user account at step 608. Further at step 610, the ZIP admin user selects “new channels”. ZIP prompts the ZIP admin user to input: e.g. Channel/Quick Code and Expiration date at step 612. At step 614 ZIP checks if all required fields are completed. If enquiry at step 614 is Yes, then time to expiration is calculated and timer is kicked off at step 616 which in turn gets connected to step 604. In case of the enquiry at step 604 being No then at step 618 it is enquired whether the user is a premium user. If enquiry at step 618 is Yes, then it is connected to step 620 to create a question. If the enquiry to step 620 is Yes, then the user accesses premium question menu at step 622. The process further continues where the user selects a “new question” at 624. Further at step 626 it is enquired whether it is a channel question. If enquiry at step 626 is Yes, then the user chooses from a list of channels assigned by the ZIP admin user at step 628. Further at step 630 ZIP prompts the user to input: e.g., Category (not for channel questions)—Question—Answer 1—Answer 2—Time limit and Mark as a mature content. Further at step 632 ZIP displays a preview of the posted question on the same screen. At step 634 it is enquired whether is this an advertorial or offer-determining question. If enquiry at step 634 is Yes, then at step 636 the premium user chooses from a list of ads/offers. This further continues to another enquiry at step 638 whether to post a question. If enquiry at step 638 is Yes, then another enquiry whether ZIP checks if all fields are completed is done at step 640. If enquiry at step 640 is Yes, then the process continues to step 616. If the enquiry to step 626 is No, then it connects to step 630 and the process continues. If the enquiry for step 634 is No, then it connects to step 638. If the enquiry to step 638 is No, then the process ends. In case the enquiry of step 620 is No, then it is further enquired whether to load an ad/offer at step 642. If enquiry at step 642 is Yes, the user access to premium question menu is done at step 644. If enquiry at step 642 is No, then the process ends. Further at step 646 user selects “new ad/offer”. Followed by step 648 where ZIP prompts the user to input:—e.g. description—navigation url—load the ad/offer image—expiration date. Further at step 650 ZIP displays a preview of the ad/offer on the same screen. This continues with an enquiry at step 652 whether the ad/offer to be loaded. If enquiry at step 652 is Yes, then a further enquiry at step 654 is done where ZIP checks if all fields are completed. If enquiry at step 654 is Yes, then the process to continues to step 616 where the time to expiration is calculated and timer is kicked off. If the enquiry at step 654 is No, then the process gets connected to step 648. If the enquiry at step 652 is No, then it is connected to the process which continues to step 656 where ZIP returns the user to the premium user “ask” screen.

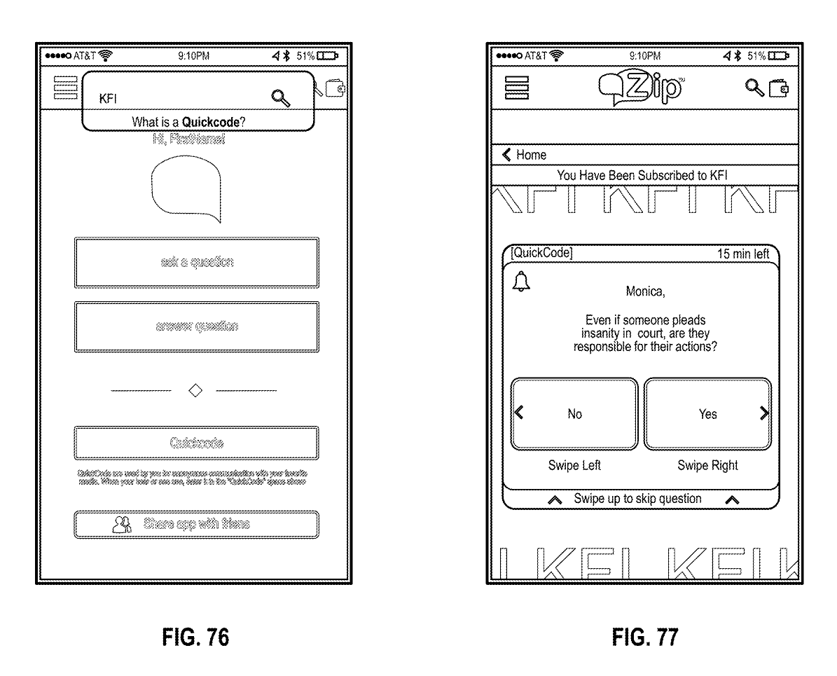

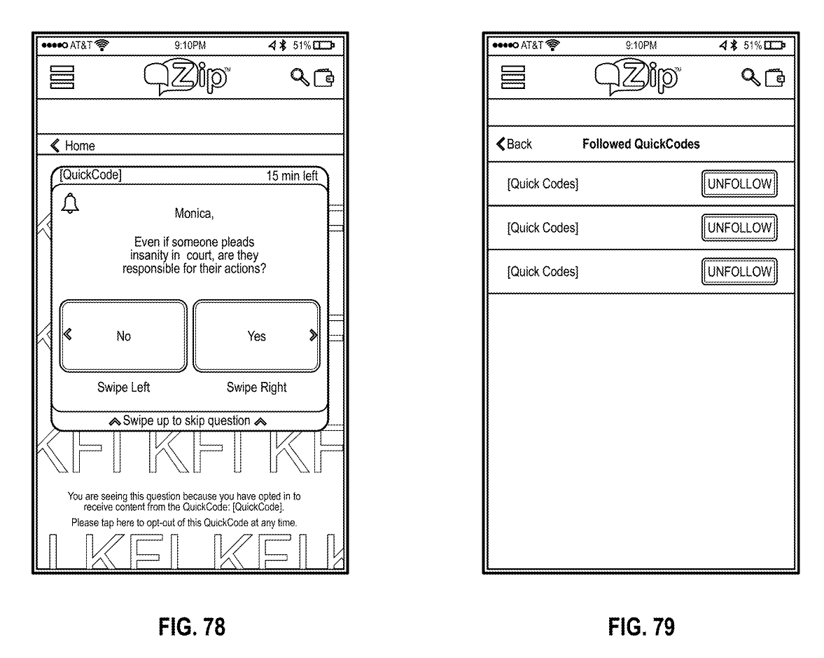

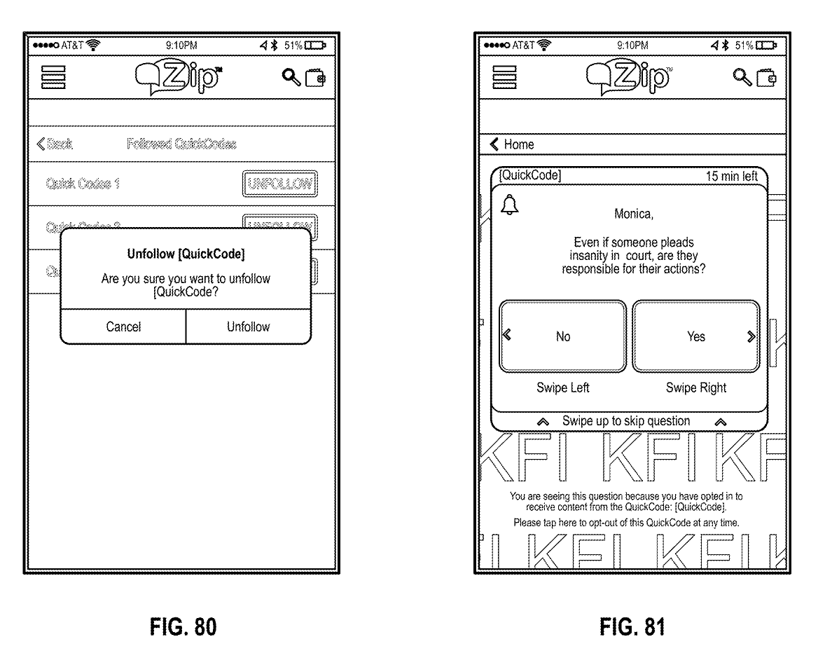

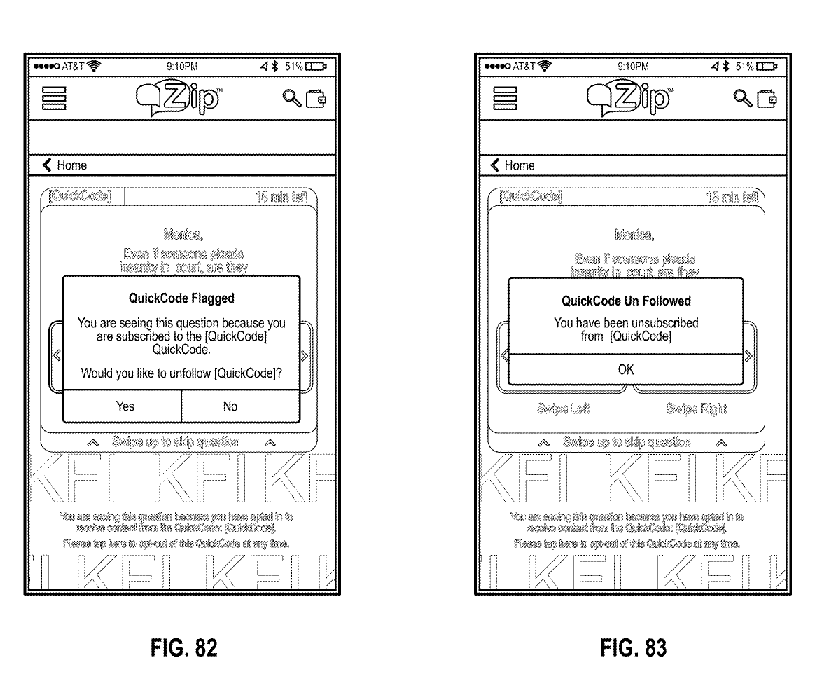

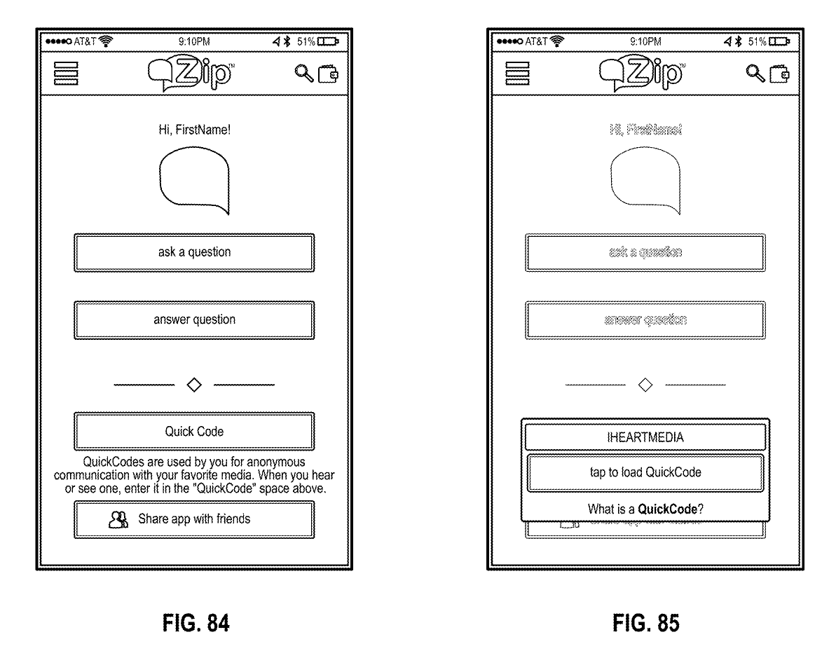

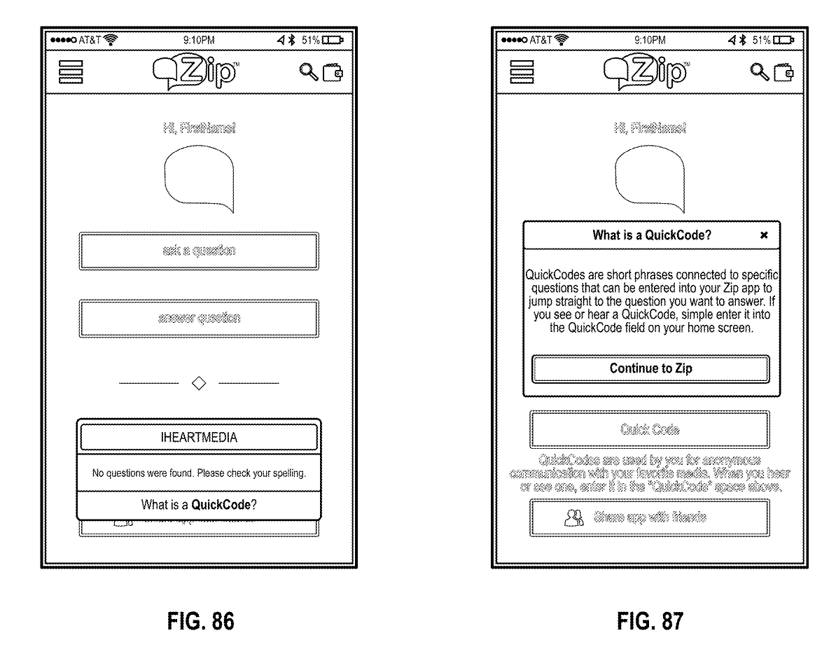

If a user selects to enter a unique identifier, such as a “QuickCode,” the user may be brought to a channel that contains content specific to the owner of that unique identifier, depicted for example in FIG. 76. For example, a user may enter the QuickCode “DODGERS” and be brought to a channel that hosts content provided by the Dodgers baseball team, depicted for example in FIGS. 77 and 78. This content may include questions, advertisements, or other content created and provided by the Dodgers that the team seeks to present to users. For example, the channel accessed by the QuickCode “DODGERS” may present a user with questions specific to a game being played at Dodger Stadium. For example, if there was a contentious call at first base during a game, the channel may ask a question “was he out?” with options for a “yes” or “no” response. Users will then be able to provide instant feedback after entering the associated QuickCode for this question and gauge the reactions of other users who also viewed the contentious play.

As another example, a user may enter the QuickCode “KIISFM” and be brought to a channel that hosts content provided by the radio station KIIS FM. This content may include questions, advertisements, coupons, offers, or other content created and provided by KIIS FM that it seeks to present to users. For example, the channel accessed by the QuickCode “KIISFM” may present a user with questions specific to programming being played on the radio station. A radio DJ may ask his audience, for example, “Which song would you like to hear within the hour? Ed Sheeran's ‘Thinking Out Loud’ or Sam Smith's ‘I'm Not the Only One’”. Alternatively, the radio DJ could also ask, for example, “We've got tickets to see Taylor Swift and tickets for Kelly Clarkson. Which tickets do you want a chance to win at 9:30 am?” These questions, again, are coupled with a particular QuickCode that will allow users to answer particular questions and join the discussion. The DJ could provide users with the QuickCode needed to access the question. Users will thus be able to provide instant feedback after entering the associated QuickCode for this question and can gauge the reactions of other users who are also listening to the station.

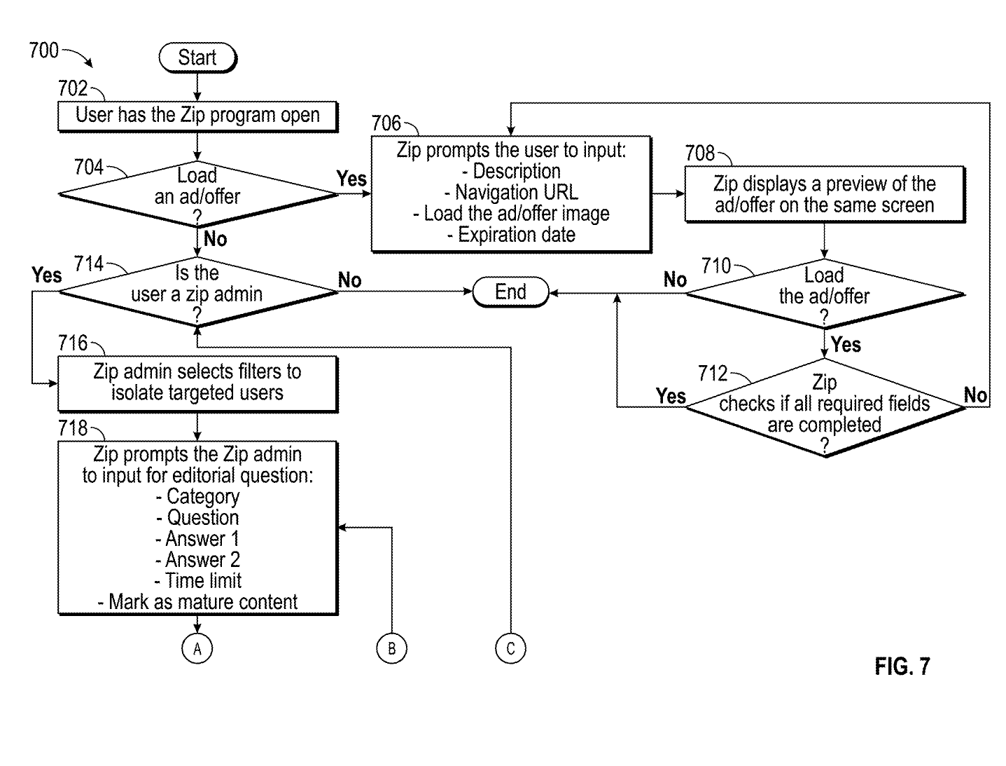

Referring to FIG. 7 is an illustration of flowchart 700, comprising of steps involved for “Target Questions” process. The process commences at step 702 where the user has the ZIP program open. An enquiry at step 714 is done whether to load an ad or an offer. At this step it may also be allowed to tie an add/offer to a particular response to a question. If the enquiry for step 714 is Yes, then ZIP prompts the user to input: e.g., Description—Navigation URL—Load the ad/offer image and expiration date at step 706. This is continued at step 708 where ZIP displays a preview of the ad/offer on the same screen. This further continued at step 710 where enquiry is done whether to load an ad or an offer. At step 712 it is enquired if ZIP checks if all required fields are completed. If the enquiry for step 712 is Yes, the process stands ended else it gets back to step 706 for continuation. If the enquiry at step 704 is No, then it is further enquired at step 714 whether the user is a ZIP admin. If the enquiry for step 714 is Yes, then at step 716 ZIP admin selects filters to isolate targeted users. At step 718 prompts the ZIP admin to input for editorial question: e.g., Category—Question—Answer 1—Answer 2—Time limit—Mark as mature content. If the enquiry at step 710 is No, then the process ends. If the enquiry at step 712 is No, then it connects to step 706. It further continues to step 720 where ZIP displays a preview of the posted question on the same screen. If the enquiry at step 704 is Yes, then it continues with step 716 and so on as per the connectivity established. If the enquiry at step 714 is No, then the process ends. The step 722 is an enquiry where ZIP checks if all required fields are completed. If the enquiry for step 722 is Yes, then it is further enquired whether is this advertorial or offer-determining question at step 724. If the enquiry for step 724 is Yes, then ZIP prompts the admin to input an advertorial or offer determining question: e.g., Question—Answer 1—Answer 2—Time limit—Mark as mature content at step 726. At this step, particular ads may also be associated with particular answers to the question. It continues to step 728 where ZIP displays a preview of the advertorial or offer-determining posted question on the same screen. These further proceed to an enquiry at step 734 where ZIP checks if all the required fields are completed. If the enquiry for step 734 is Yes, then ZIP admin chooses from a list of ads/offers at step 736. If the enquiry for step 734 is no, then it connects to step 726. At step 730 it is enquired whether to post the question. If the enquiry for step 730 is Yes, then Time to expiration is calculated and timer is kicked off at step 732 else it connects to step 714. If the enquiry at step 722 is no, then it is connected to step 718. If the enquiry at step 724 is no, then it is connected to step 730.

In one embodiment, premium users may use another medium to inform users of a particular QuickCode. For example, a premium user may use any other suitable medium to distribute its QuickCode to users, including but not limited to radio, television, billboards, printed mediums, email, internet, venue-specific closed circuit media, or other comparable means to reach a wide, yet targeted audience. For example, using such a medium, premium users can ask questions of their audience, then ask members of this audience to continue their engagement with the premium user by entering its specific QuickCode in an application running, for example, on an internet connected mobile device. Upon entry of the QuickCode provided by the channel scheduler for a medium, users of the application may be directed to the premium user's channel and presented with the question provided by the channel scheduler. The user may be presented the opportunity to answer the question, thus providing a response directly to the channel scheduler. Still further, the channel scheduler may be able to pose additional questions to, and receive additional responses from, the user that has engaged with and entered its channel using the provided QuickCode. As another example, the channel scheduler may be able to provide targeted advertisements, coupons, or other information to that user based on the responses provided to the channel scheduler's questions. The channel scheduler and the user may thus be in direct communication using these systems and methods.

In one embodiment, the systems and methods may be employed by a sports team, such as the Los Angeles Angels, at their sporting venue. For example, during the game, on the jumbotron or other display media, an Angels channel scheduler could pose a question to the crowd in the venue, such as asking if a player was out or safe at first base. Additionally, the code and question could be distributed to other viewers of the game not in the venue, for example by television, radio, or other suitable broadcast means. In addition to, or in alternative to media broadcast in some form, either the question or code could be provided to users in a nearby geographical area, for example by GPS or other comparable geolocation means.

The channel scheduler could ask other types of questions as well, for example the administrator may pose a question such as “We've got a great fireworks show for you tonight. Would you rather see a patriotic theme or a show featuring top too songs tonight?” Regardless of the question, the channel scheduler actively seeks the participation of users of an application running, for example, on an internet connected mobile device. The channel scheduler programs the QuickCode with preloaded questions and answers, sets question expirations, run times, a specific order and other parameters while monitoring live question results and available analytics, thus permitting and ultimately inviting users to join in the discussion.

In addition to questions, the channel scheduler could use the QuickCode to unlock and provide access to other content exclusive to the owner of that “QuickCode.” For example a QuickCode may unlock custom content, such as audio playlists and live streamed content in the form of audio and video. The systems and methods described herein may be used to both provide custom content and to solicit user feedback in the same user session.

As opposed to other methods of seeking user contribution or asking questions of an audience, such as Facebook for example, the particular channels and other features available to premium users allow each channel scheduler, to control the answers permissible for each question and other important characteristics. This may prevent, for example, profanity or other unwanted feedback and may ensure that all answers are family friendly. Such a feature may be beneficial, for example, to protect the brand of the particular channel operator.

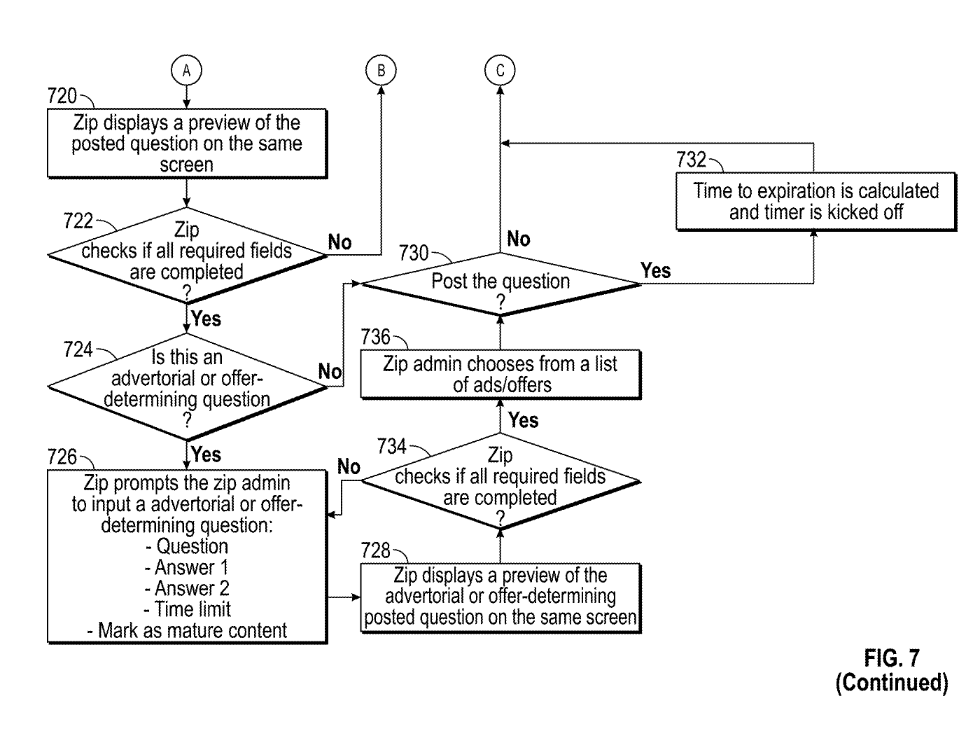

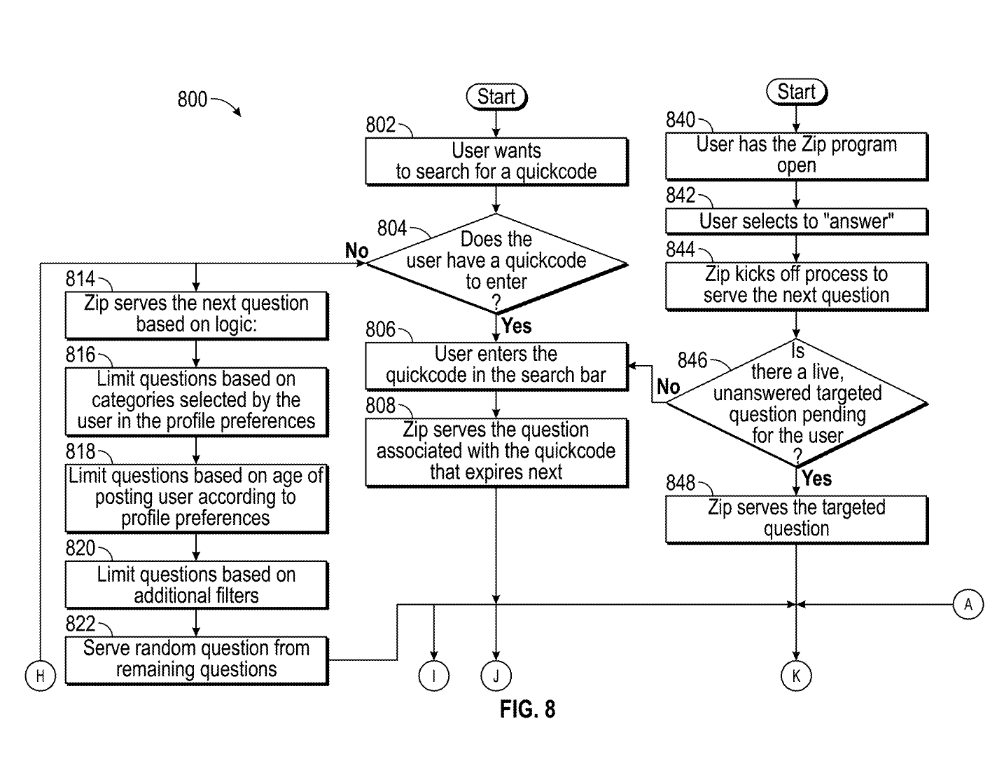

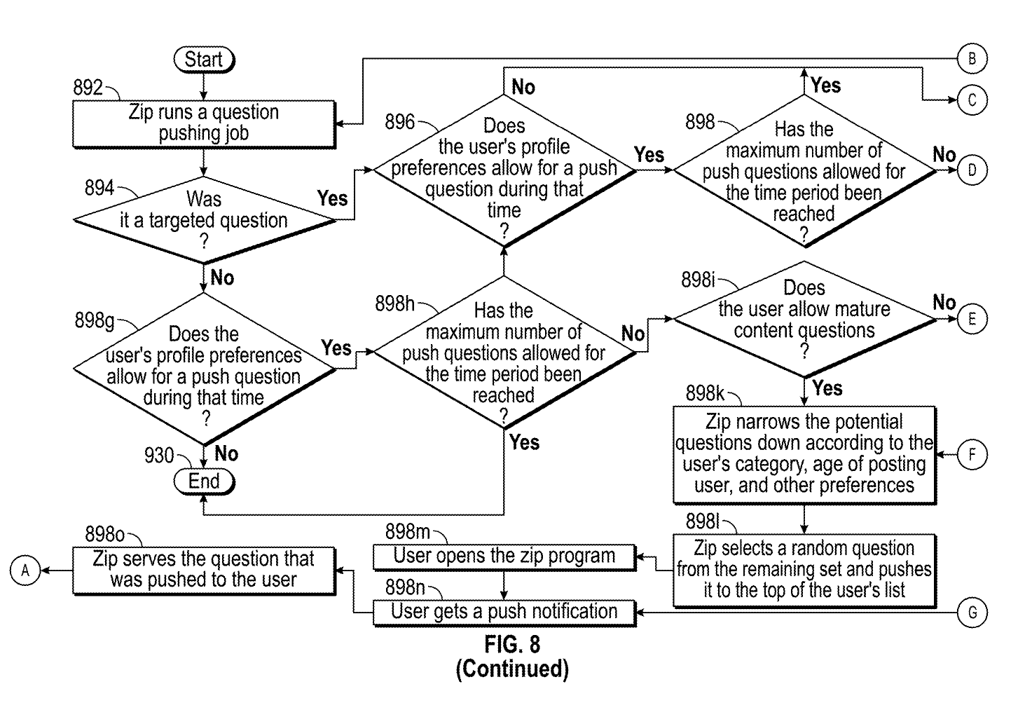

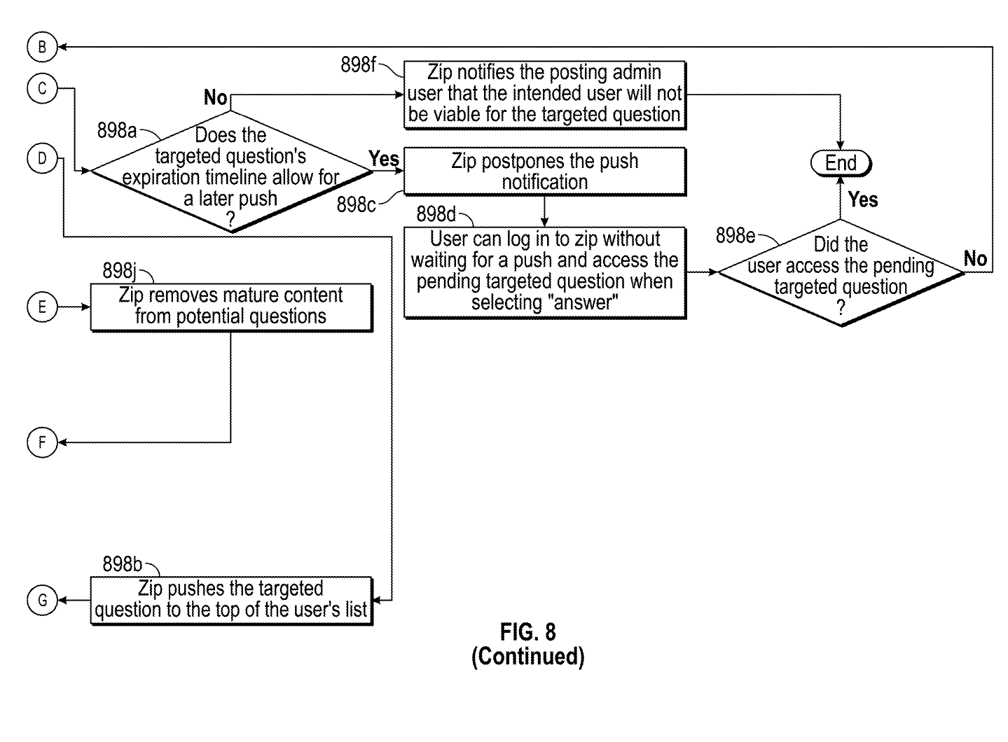

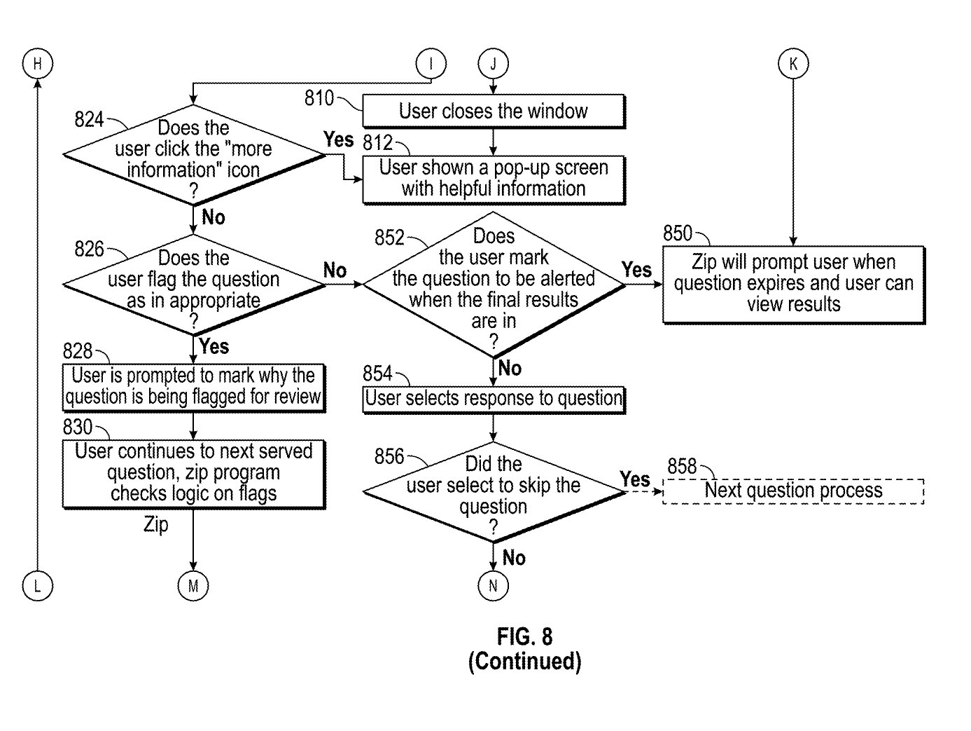

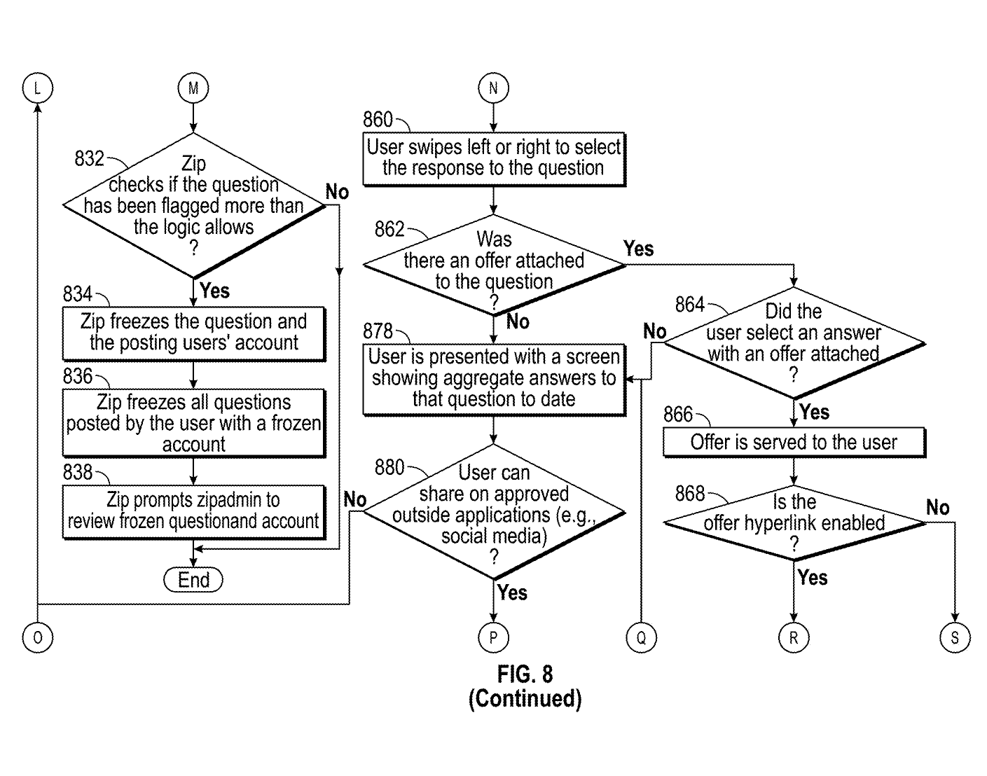

Referring to FIG. 8 is an illustration of flow chart 800, comprising of steps involved in illustration for an example “Answer questions” process. The process comprises of three starting points. The first point starts at step 802 where the user wants to search for a QuickCode. It is enquired at step 804 whether the user has a QuickCode to enter. If the enquiry at step 804 is Yes, then user enters the QuickCode in the search bar at step 806. Further, at step 808 ZIP serves the question or questions associated with the QuickCode that expire next. The process further continues at step 810 where the user closes the window. This is followed by step 812 where the user is shown a pop up screen with helpful information. In case the enquiry to step 804 is no, then ZIP serves the next question based on logic at step 814. This is followed by limited questions based on categories selected by the user in the profile preferences at step 816. This in turn proceeds to step 818 where the questions are limited based on age of the user posting according to profile preferences. Further at step 820 the questions are limited based on additional filters. Step 822 serves random questions from the remaining questions. The process further continues at step 824 where it is enquired whether the user has clicked the “more information” icon. If the enquiry at step 824 is Yes, the process is connected to step 812. If the enquiry to step 824 is No, then it is further enquired at step 826 if the user flags the question as in appropriate. If the enquiry at step 826 is Yes, then the user is prompted to mark why the question is being flagged for review at step 828. The process is further continued to step 830 where the user continues to next served question and ZIP checks logic on the flags. Further it is enquired at step 832 where ZIP checks if the question has been flagged more than what the logic allows. If the enquiry at step 832 is Yes, ZIP freezes the question and the posting user's account at step 834. At step 836 ZIP freezes all questions posted by the user with a frozen account. Finally at step 838 ZIP prompts ZIP admin to review frozen question and account thus brings an end to the process.

The second starting point leads to step 840 where the user has the ZIP program open. Further the user selects to answer at step 842. This moves to step 844 where ZIP kicks off process to serve the next question. At step 846 it is enquired if there is a live, unanswered targeted question pending for the user. If yes, then ZIP serves the targeted question at step 848. Finally at step 850 ZIP prompts the user when question expires and the user can view results. If the enquiry at step 826 is No, then it is further enquired at step 852 whether the user has marked the questions to be alerted when the final results are in. If the enquiry at step 852 is Yes, then the process continues to step 850. Else, the user selects the response to question at step 854. Further it is enquired at step 856 whether the user has selected to skip the question. If the enquiry at step 856 is Yes, then the next question process starts at step 858. If the enquiry at step 856 is No, the process continues to step 860 where the user swipes left or right to select the response to the question. At step 862 it is enquired whether an offer was attached to the question. If the enquiry at step 862 is Yes, then it is further enquired at step 864 if the user has selected an answer with an offer attached. If the enquiry at step 864 is Yes, then an offer is served to the user at step 866. Further it is enquired at step 868 if the offer hyperlink has been enabled. If the enquiry at step 868 is Yes, then it is further enquired at step 870 whether the user follows the hyperlink. If the enquiry at step 870 is Yes, then the user is presented with the hyperlinked site on the web browser at step 872. The enquiry in case being no at step 870 and also the step 872 get further connected to the enquiry 874 where the user can either move on to the next question or save the offer to the ZIP wallet. If the enquiry at step 874 is Yes, then the offer is saved to the user's ZIP wallet. This proceeds to step 878 where the user is presented with a screen showing aggregate answers to that question to date. In case the enquiry at step 864 is No, then it is connected to step 878. In case the enquiry at step 868 and 870 is No, then they are connected to step 874. The step 878 is further connected to step 880 where it is enquired whether the user can share on approved outside applications (e.g. social media). If the enquiry at step 880 is Yes, then at step 884 the user is presented with a screen showing linked approved outside applications on which they can share. Further the user selects approved outside applications on which to share at step 886. Step 888 ensures that ZIP posts to the user's account(s) in the approved outside application(s). In case the enquiry at step 882 is no, then the user is presented with a screen to link the approved outside applications. The step 888 finally connects to step 804.

The third starting point leads to step 892 where ZIP runs a question pushing job. It is further enquired at step 894 whether it was a targeted question. If the enquiry at step 894 is Yes, it is further enquired at step 896 whether the user's profile preferences allow for a push question during that time. If the enquiry at step 896 is Yes, then it is further enquired at step 898 whether the number of push questions allowed for the time period been reached. If the enquiry at step 898 is Yes, then it is connected to step 898a where it is further enquired whether the targeted question's expiration timeline allow for a later push. If the enquiry at step 898 is no, then ZIP pushes the targeted question to the top of the user's list at step 898b. This step further connects to step 898n where the user gets push notifications at step 898n. This further connects to step 898o where ZIP serves the question that was pushed to the user. This gets connected to step 850. If the enquiry to step 898a is Yes, then ZIP postpones the push notification at step 898c. This is further connected to step 898d where the user can log into ZIP without waiting for a push and access the pending targeted question when selecting “answer” at step 898d. This proceeds to step 898e where it is enquired whether the user accessed the pending targeted question. If yes, then the process ends. If no, then the process connects to step 892. If the enquiry at step 898a is no, then ZIP notifies the posting admin user the intended user will not be viable for the targeted question at 898f. In case the enquiry at step 898i is no, then ZIP removes mature content from potential questions at 898j. This further connects to step 898k where ZIP narrows the potential questions down according to the user's category, age of posting user, and other preferences. The connectivity continues at step 898l where ZIP selects a random question from the remaining set and pushes it to the top of the user's list. This further connects to step 898m where the user opens ZIP program. In case the enquiry to step 894 is no, then it is further enquired at step 898g whether the user's profile preferences allow for a push question during that time. If the enquiry at step 898g is Yes, then it is enquired further at step 898h whether the maximum number of push questions allowed for the time period has been reached. If the enquiry at step 898h is yes, the process ends. Else it is connected to step 898i. If the enquiry to step 898g is no, then the process ends. The step 898h is enabled to be further connected to step 896.

In some embodiments, channels may be used to gather real-time audience responses for any of several purposes. Some exemplary purposes include:
Immediate audience polling
Increased audience mobile engagement and time spent interacting with the premium user
Focus group-like audience research
Content available on-demand with questions curated by the premium user
Advertising
Any other purpose that relies on, or would benefit from, the input of a wide group of respondents

One embodiment includes any of several types of advertising directed to users of the application running on, for example, an internet connected mobile device. Advertising may take the form of, for example, pull advertising via, e.g., channels, or push or pinpoint advertising via, e.g., market narrowing.

One example using pull advertising could be implemented on an application running on an internet connected mobile device. For example, a premium user and channel owner, e.g. the Los Angeles Angels baseball team, could ask viewers on the jumbotron, or other media forum, a particular question such as those discussed above, e.g. “What fireworks show do you want to see tonight?” Once the user enters the associated QuickCode thus accessing the premium user's channel and answering such a question, the user could be presented with a follow-up question, such as “Are you in the mood for pizza or a hot dog right now?”, or another comparable question that gauges the user's interest in some subject matter. If a user selects, for example, pizza, the user could then be provided a coupon for an in-stadium pizza vendor. If the user selects the other response, e.g., hot dogs, the user could be provided a coupon for an in-stadium hot dog vendor. When presented with this coupon, the user may be presented with the option to save or discard the offer, for example by swiping in a similar fashion as responding to question cards. If the user were to swipe and indicate that it desired to save the offer, the coupon could be stored in an electronic repository in the application, for example an electronic wallet or other appropriate electronic storage location. Still further, if the user declined to answer the question and skip it, the user may be provided with no advertisement at all. Thus material provided to users on the ANGELS channel may include questions specific to items available for purchase and vendors at Angels Stadium.

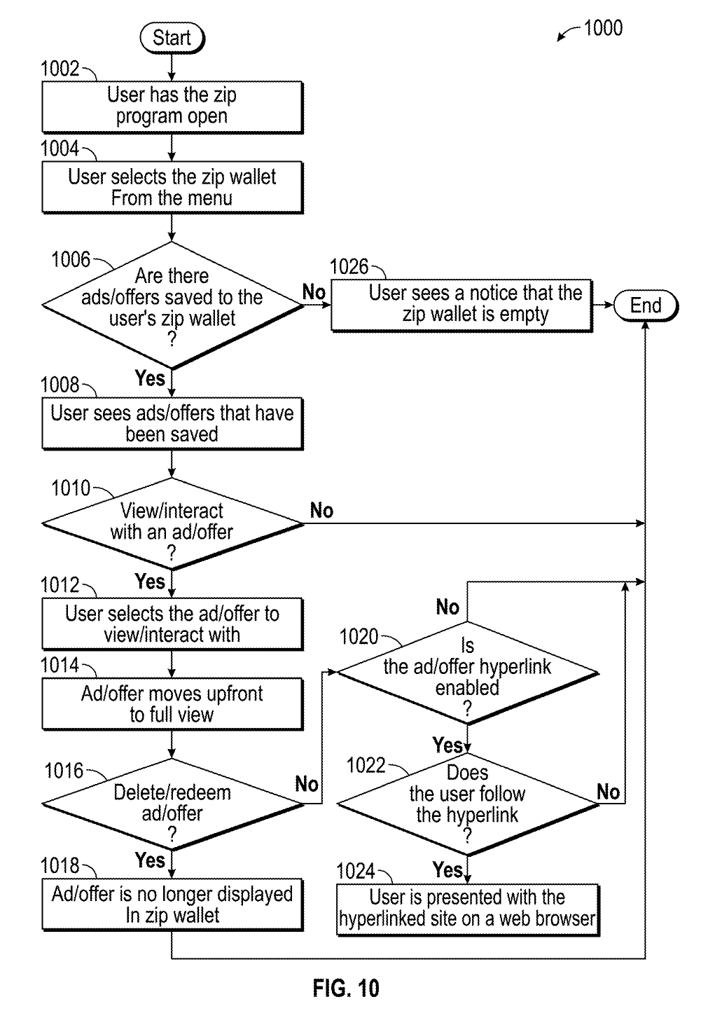

Referring to FIG. 10 is an illustration of flow chart 1000, the steps involved for storing content in ZIP wallet by the user. Storing content in Zip wallet by the user. The process starts at step 1002 where the user has the ZIP program open. The user selects the ZIP wallet from the menu at step 1004. Further an enquiry is done at step 1006 whether are there any ads/offers saved to the user's ZIP wallet. If enquiry at step 1006 is Yes, then the user sees ads/offers that have been saved at step 1008. If enquiry at step 1008 is No, then then the process proceeds to step 1026 where the user sees a notice that the ZIP wallet is empty. At step 1010 it is enquired whether to view/interact with an ad/offer. If enquiry at step 1010 is Yes, then at step 1012 the user selects the ad/offer to view/interact with. Further at step 1014 ad/offer moves upfront to full view. Further at steps 1016 it is enquired whether to delete or redeem the offer. If enquiry at step 1016 is Yes, then ad/offer is no longer displayed in ZIP wallet at step 1018 If the enquiry for step 1006 is No, then it continues at to step 1026 where the user sees a notice that the ZIP wallet is empty and the process ends. If the enquiry for step 1010 is No, then the process ends. If the enquiry at step 1016 is no, then it proceeds to step 1020 where it is enquired whether the ad/offer is hyperlink enabled. If enquiry at step 1020 is Yes, then at step 1022 it is enquired whether the user follows the hyperlink. If enquiry at step 1022 is Yes, then the user is presented with the hyperlinked site on a web browser as in step 1024. If the enquiry at step 1022 is No, then the process ends. If the enquiry to step 1020 is No, then the process ends.

As another example, a premium user and channel owner, for example the radio station KOST, may have its DJ ask listeners on the air a particular question such as those discussed above, e.g. “What song do you want to hear next?” Once the user enters the associated QuickCode thus accessing the premium user's channel and answering such a question, the user could be presented with a follow-up question, such as “Are you in the mood for pizza or Chinese takeout tonight?” or another comparable question to gauge the user's interest in some subject matter. If a user selected, for example, pizza, the user could then be provided a coupon for a local pizza restaurant. If the user selected the other response, e.g., Chinese take-out, the user could be provided a coupon for a local Chinese restaurant. Still further, if the user declined to answer the question and skip it, the user may be provided with no advertisement at all. Material provided to users on the KOST channel may include questions specific to items available from station advertisers and partners. Depending on the response, the offer delivered is customized to the preferences of the user. When presented with the offer, the user may be presented with the option to save or discard the offer, for example by swiping in a similar fashion as responding to question cards. If the user were to swipe and indicate that it desired to save the offer, the coupon could be stored in an electronic repository in the application, for example, an electronic wallet or other appropriate electronic storage location.

Pull advertising may allow, for example, a premium user to leverage its particular channel and corresponding unique identifier, such as a QuickCode, as another component of a larger marketing plan designed for existing or new advertisers with the premium user, or vendors in affiliated programming. Such efforts can be, for example, adjusted to ask questions relevant to any advertiser or vendor and allow a premium user to further integrate an advertiser or other partner or affiliate brand into the framework of the premium user's brand, thus leveraging the premium user's brand equity for the advertiser.

In some embodiments, pull advertising may be considered “opt-in.” For the advertiser, pricing may be impression-based to deliver ads to users and may thus allow, for example, campaigns to be scalable or achieve other efficiencies that further the goals of the advertiser. As an extension of this, smaller advertisers can leverage the impact of aligning with larger entities such as a particular channel owner, but without needing to pay for the entirety of the audience reach. This may make the larger audience more accessible to more advertisers of varying sizes and means.

In one embodiment including for example, pull advertising, psychographic targeting may be possible. For example, by controlling the distribution of QuickCodes and aligning such distribution with particular behavior patterns or psychographics (for example “attends Angels games” or “saw Dodgers advertising sometime today” or “listens to KOST radio station”), and then mapping this to known demographic information of users of an application running for example on an internet connected media device, premium users and channel operators could verify that the psychographics they want actually align with the demographics they are targeting. This functionality is not presently available to advertisers. Advertisers often want to target particular psychographic profiles among users or consumers and may attempt to do so by reaching key demographics. One embodiment reverses the process back to the ideal, original intention of the advertiser and allows for the advertiser to be more targeted in its attempts to reach and identify demographic characteristics of particular psychographic profiles. Across various types of media, this process also allows premium users to take something that is intangible and place it directly into the palm of a user for continued, measurable engagement. For example, in-stadium, radio, TV, print, out-of-home, on-demand content, and so on, all have no way of capturing their audience for continued mobile engagement other than cumbersome methods of Facebook, Twitter, websites, etc. One embodiment allows such engagement to be done with a simple, easy to remember code, which can be backed by analytics and readily accessed by interested users with an elegant and simple application running on, for example, an internet connected media device.

One example using push or pinpoint advertising may use information about the user collected when the user registers with the application. As the userbase for the application develops, in-depth user psychographic profiles, in addition to standard demographic profiles, on each individual user may also be developed. For example, at user sign-up, information about each user may be collected, including for example the user's gender, age, ZIP code, contact information, categories of interest, or other information that may be helpful to develop profiles on users. As another example, as users engage with the application running on, for example, an internet connected mobile device, their responses to individual questions may also be catalogued and analyzed, allowing for a full psychographic profile based on a particular user's use and responses to certain targeted questions.

Push advertising may allow brands, companies, advertisers, or other interested parties to, for example, identify which demographic or psychographic groups they would like to target. This could allow, for example, novel systems and methods for analyzing this newly collected data stored in user databases and serving ads exclusively to the individuals that are most valuable to the particular interested party seeking to deliver such advertisements.

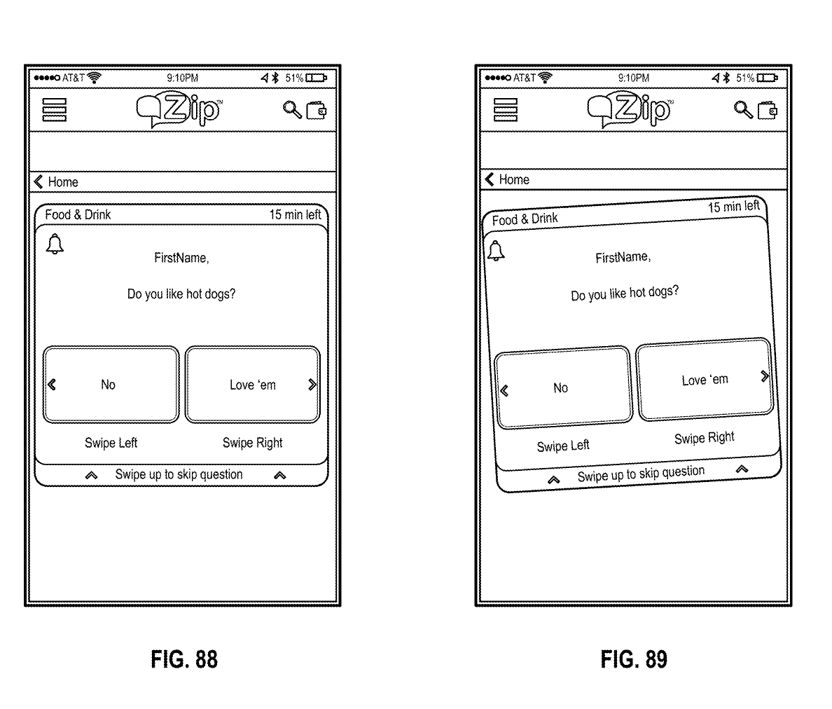

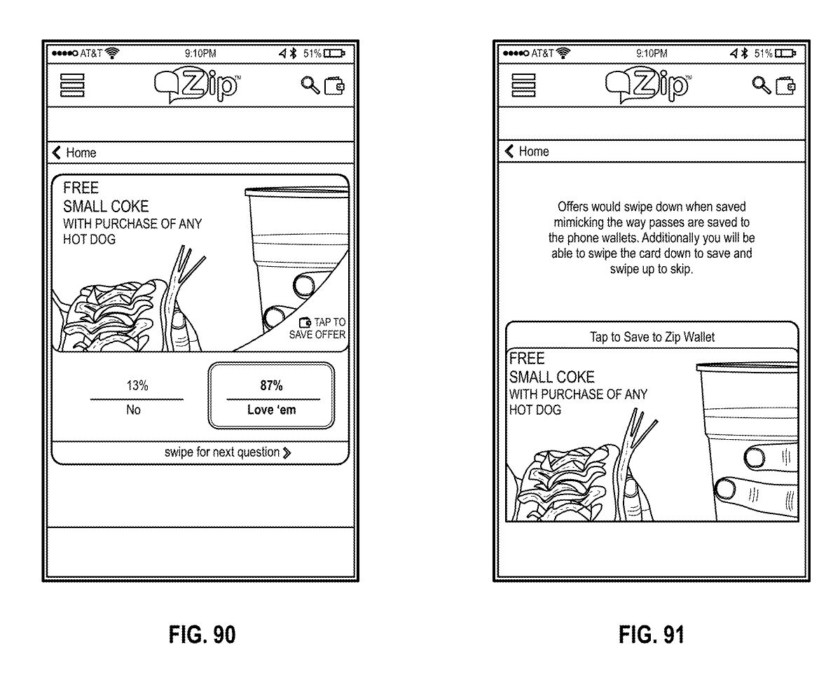

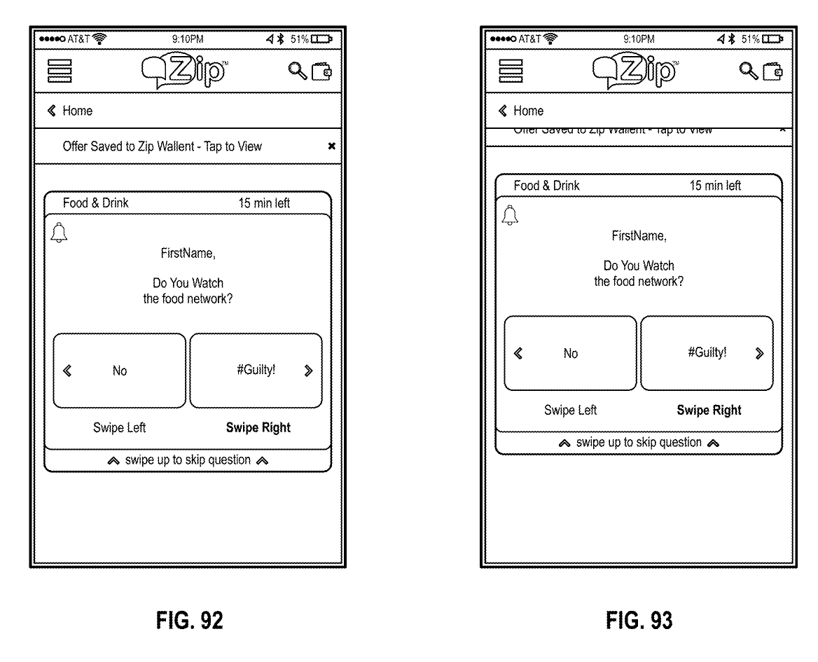

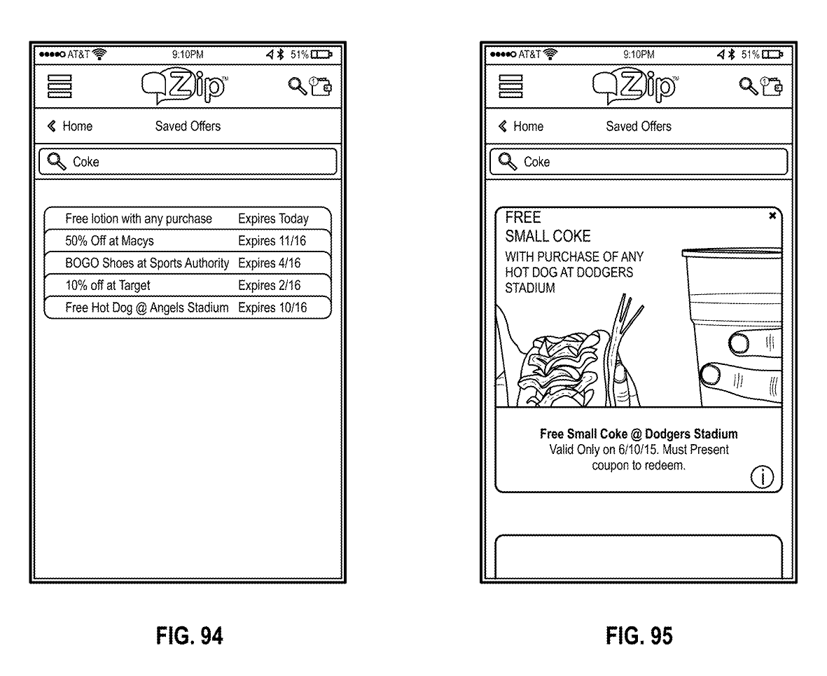

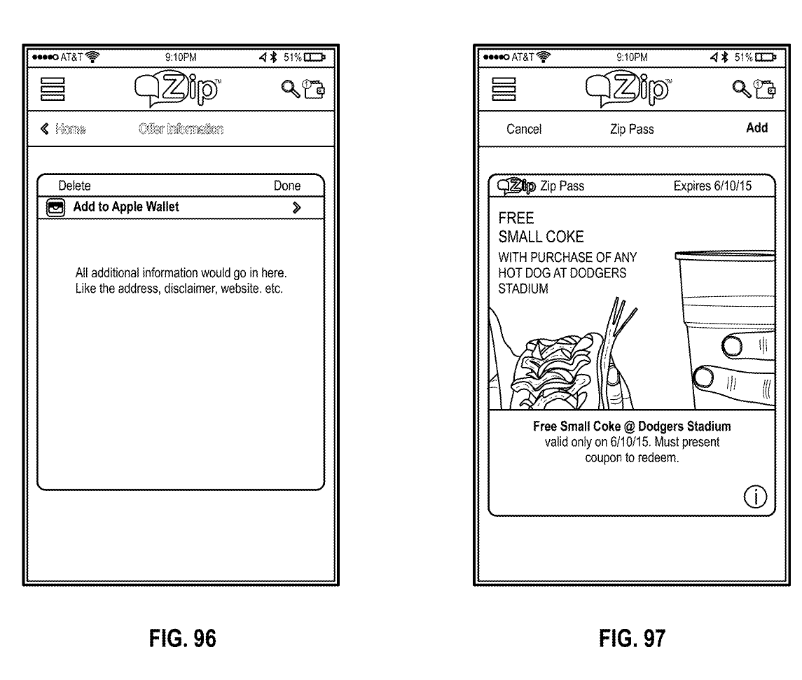

For example, in one embodiment, each pushed ad could be integrated into the “Answer Questions” stream of an application running on, for example, an internet connected mobile device. Such questions could be prefaced by a content or substantive question for full engagement. In this manner, by carefully sequencing ads or other sponsored content with substantive or user generated content, users of the application may remain more engaged and more willing to continue to provide responses, depicted for example in FIG. 88-92.

For example, a Major League Baseball team may be interested in focusing advertising to a particular demographic or psychographic userbase. For example, the New York Yankees, or any sporting team, might identify that it would like to concentrate their advertising efforts to reach, for example, exclusively adults 25+ within 100 miles of New York City and a documented interest in baseball. After establishing these criteria, there could be, for example, two questions developed. First, a substantive question provided to users fulfilling the criteria previously determined by the advertiser, for example, “Would you rather go to the first game in a series or the last?” Suggested answers could include “First game, sets the tone” or “Last game, it's what counts.” Next, an advertorial question could be provided to the same users that answered the first question: “What uniforms should the Yankees wear tomorrow night?” with some suggested answers, for example “Signature” or “Retro.” Depending on the answer to this question, users could then be given a coupon for a discount in the team store on the jersey corresponding to the selection made.

As another example, a radio station may be interested in focusing advertising to a particular demographic or psychographic userbase. For example, iHeartRadio, or any comparable broadcaster, can identify that they would like to concentrate their advertising efforts to reach exclusively adults 25+ within 100 miles of Las Vegas and a documented interest in music currently on the Billboard top too. After establishing these criteria, there could be, for example, two questions developed. First, a substantive question provided to users fulfilling the criteria previously determined by the advertiser, for example, “Would you be more likely to go to Coachella if it were closer to Las Vegas?” Suggested answers could include “No way, Indio all the way!” or “Yes, Coachella in Sin City.” Next, an advertorial question could be provided to the same users that answered the first question: “Who would you rather see play at the iHeartRadio Music Festival?” with some suggested answers, for example, “Ariana Grande” or “Pitbull.” Depending on the answer to this question, users could then be prompted to enter to win a meet and greet at the festival with the artist corresponding to the selection they made.

One benefit of push advertising in such a manner is that this method may allow advertisers to speak directly to their target audience and expand their reach to include new leads based on guaranteed impressions. Users opt in for the advertising or offers that are tailored to them, thus providing beneficial information, and also making it more likely that target users will respond positively. The user opt in may not be explicit, and may comprise simply answering an appropriately tailored and targeted counted-based question that demonstrates a user's interest in the subject matter. By answering such a question, the user has demonstrated at least some responsiveness to the next, targeted question. The process may be largely transparent to the user. This may leverage, for example, the database of demographic and psychographic parameters on users of the application as content interest and preferences selection criteria, allowing for scalable and replicable advertising, marketing, research, or other campaigns.

Another embodiment of push advertising may take the form of pinpoint advertising. This can include advertisements conducted in which the target market for push advertising may be identified through market narrowing. For example, starting with the entire application user database or a selected segment of the user database as the initial population for a campaign, advertisers can set up a series or sequence of questions—the end result of which is a narrowly-defined group of niche individuals known to be valuable consumers for acquisition. Pinpoint advertising through market narrowing may be available to channel users so they can utilize this marketing technique within the audience of engaged users that have used their associated QuickCode. It may also be employed on the entire application user-base without need for a QuickCode. For example, eligible channel users may consist of any user that has entered the channel's QuickCode at any point in time. From within this grouping, the premium user can initiate the market narrowing process at any time to establish the pinpointed and defined user niche that will subsequently be delivered an opt-in offer question.

One example of pinpoint advertising using such systems and methods may include a scenario in which Valley View Casino & Hotel located in North County San Diego wants to send offers to only qualified garners. A sequence of questions to reach this end may include, for example, the following:
First question, “Do you like to play at casinos?”
Anyone that answers no is ruled out of the target group
Second question, “Do you play at Southern California casinos?”
Anyone that answers no is again ruled out of the target
Third question, “How often do you play at casinos?”
Anyone that answers “1-4 times a year” vs. “5 times or more a year” is again ruled out of the target
Fourth question, “When you play, do you play slots?”
Anyone that answers no is again ruled out of the target
Fifth question, “When you play, how much money do you bring to a casino?”
Anyone that answers “Less than $100” vs. “$100 or more” is again ruled out of the target

The questions may be presented in any order and non-sequentially. After many users answer this set of questions, there may only be a smaller and focused subset that answered all of them in the designated desirable manner. Based on this narrowing process, a specific targeted group may be remaining that is most highly valued to the specific advertiser. In one example, a very motivating, specifically tailored ad could then be provided only to the small set of already identified interested individuals, i.e. to those that answered all five questions favorably. Such an offer could include, for example, two free hotel stays at Valley View Casino & Hotel. In one embodiment, the questions could be served one at a time, not in any particular order, and spaced throughout the user's stream of questions to answer in an application running, for example, on an internet connected mobile device, to ensure the content remains valuable, organic, unsuspicious, and unhampered. Alternatively, the questions could be served en mass and in order, if a particular user preferred to receive them that way, or for some other reasons.

Some benefits of pinpoint advertising may include, for example, allowing for very specific identification of a core group of users that represents a company's prime consumers. Once such customers are identified, these individuals can be served large offers, specific or targeted incentives, be asked valuable questions for feedback, be remarketed to, and be communicated with directly by the advertiser.

One embodiment could also be valuable for use as a research tool, including for example, market research. For example, it may assist companies in conducting market research, brand awareness studies, “focus group” testing, or other similar research and data collection that relies on a large pool of respondents with certain unifying characteristics. Even as basic users, companies would be able to ask research-based questions by using the standard application interface. The information available to standard users, however, may be more limited than the information available to premium users, and may, for example, only illustrate percentages of public opinion without the additional demographic or psychographic information about the particular respondents. One example may be to use the systems and methods described herein as a research platform for conducting digital “focus groups”, market research and (in its most basic capacity) surveys of a target audience adjustable in size, scope and demographics. Such information may be available to premium users as opposed to standard users.

For example, one embodiment may be used for research and brand decision-making purposes. In one example, a company may select a core group of users to whom they would like to pose a question for research purposes based on, for example, demographic and psychographic variables. Analytics regarding, for example, the responses gathered for the question posed or information about certain types of users may be provided.

In one example, a baseball team such as the San Diego Padres may be considering changing its team mascot. The team could identify a specific target in the userbase most likely to have an interest in questions related to such a change. For example, the Padres may decide that adults 30+ living in the San Diego DMA with an affinity for following baseball might be the best respondents. The Padres could then ask such users particular questions without disclosing any sensitive or confidential information. For example, the Padres could ask this group “What icon best represents San Diego's baseball team?” and provide suggested answers such as “Friars” or “Bulldogs.” The responses could then be utilized, for example, to determine if there is a disconnect between the team's mascot and the perceived icon, which could provide insight into a discussion of a change of the team mascot.

In another example, radio stations such as those run by iHeartRadio, may be considering changing a station's broadcast format. iHeartRadio could identify a specific target in the user base most likely to have an interest to be asked questions related to such a change. For example, iHeartRadio may decide that adults 30+ living in the Los Angeles DMA with an affinity for radio listening would be the best respondents. iHeartRadio could then ask such users particular questions without disclosing any sensitive or confidential information. For example, iHeartRadio could ask this group “What type of music station would you like to see added in Los Angeles?” and provide suggested answers such as “Contemporary Country” or “Underground Rap.” At the end of the research period, analytics could be provided specifying how many respondents answered either way, the number of male vs. female respondents for each, the ZIP codes from which responses were measured, the ages of the respondents, or other comparable demographic and psychographic information that would be useful when considering the change.

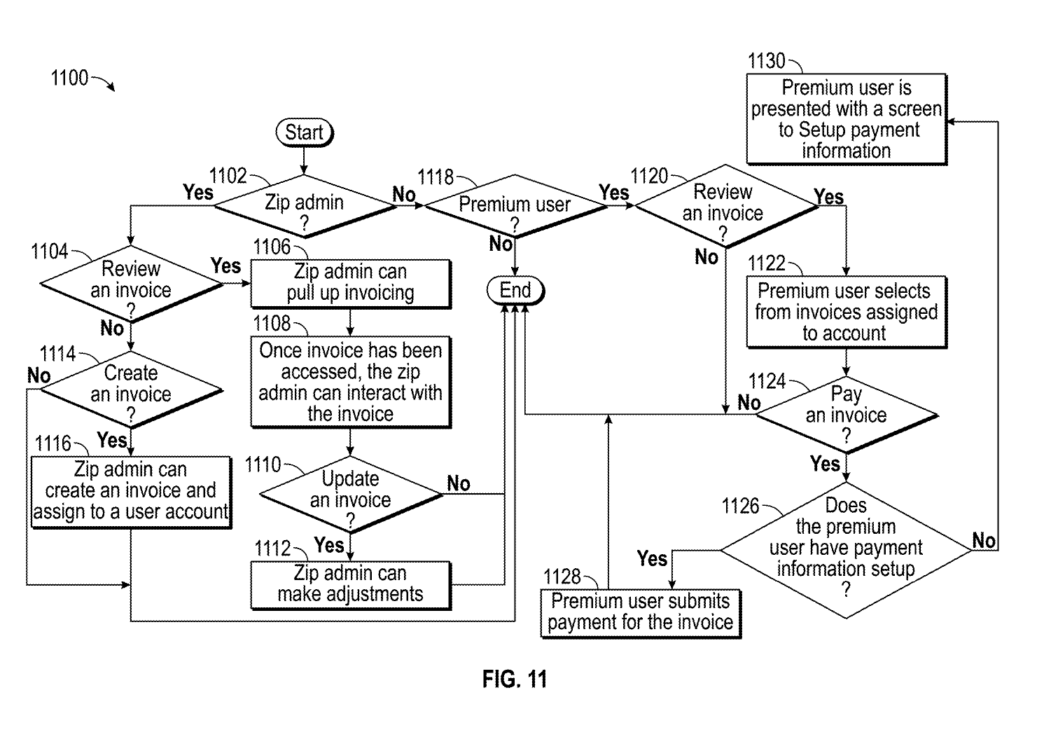

Referring to FIG. 11 is an illustration of a flowchart 1100, comprising of steps involved for Invoicing Process. The process starts at step 1102 where it is enquired if it is a ZIP admin. If enquiry at step 1102 is Yes, then it is further enquired at step 1104 for a review of the invoice. If enquiry at step 1104 is Yes, then ZIP admin can pull up invoicing. Further at step 1108 once invoice has been accessed, the ZIP admin can interact with the invoice. At step 1110 it is enquired whether an update of the invoice is done. If enquiry at step 1110 is Yes, the ZIP admin is enabled to make adjustments at step 1112. On the contrary if the enquiry at step 1110 is no, the process ends. In case the enquiry at step 1104 is No, then it is further enquired whether to create an invoice at step 1114. If enquiry at step 1114 is Yes, then the ZIP admin can create an invoice and assign to the user account If No, then the process ends. In case the enquiry at step 1102 is No, then it is further enquired at step 1118 whether the user is a premium user. If enquiry at step 1118 is Yes, then it is further enquired at step 1120 about renewing an invoice. If enquiry at step 1120 is Yes, then the premium user selects from the invoices assigned to the account at step 1122. Further at step 1124 it is enquired regarding the payment of the invoice. If enquiry at step 1124 is Yes, then further enquired at step 1126 whether the premium user has a payment information set up. If enquiry at step 1126 is Yes, then at step 1128 the premium user submits payment for the invoice thus concluding the process. If enquiry at step 1126 is No, then at step 1130 the premium user is presented with a screen to set up payment information. In case the enquiry at steps 1120 and 1124 is No, then the process ends.

Some benefits of this research capability may include making conducting market research and targeted tests with consumers more affordable or cost effective for companies of various sizes. As another example, such a research capability may allow for many more responses than traditional research at a fraction of the cost and provide results faster than more conventional means, such as traditional focus groups or surveys. As another example, results can be viewed in real time, even as they continue to accrue responses. As another example, as in some advertising methods discussed previously, users may be kept unsuspicious of these questions, as they are integrated within the content stream provided to users of the application running on, for example, an internet connected mobile device, allowing for answers without attached preconceptions.

Some examples of questions that premium users may want to ask could include:
Where should our team host its next promotion?
What bobble head should we give away at Opening Day?
What should be the next giveaway—t-shirts or baseball caps?
Who would you like to see throw the first pitch?
What player would you like us to interview after the game?
Do you like seeing the kiss cam during the 7^{th} inning?
What should be the next song?
Who would you like to see play at the iHeartRadio Country Music Festival?
Do you like hearing playbacks from our “Car Seat Karaoke” promotion on the air?

Such research questions may also be used to serve further advertisements to users, collect information and tendencies of potential customers, identify specific targeted sets of interested and motivated customers, or perform any other analytics in which premium users are keenly interested.

Ultimately, features and capabilities of these novel systems and methods include, for example, allowing a medium or live venue (partner) to connect to and interact with their audience. In summary, benefits to partners include the ability to:
Deliver original and entertaining content
Allow users to direct the content they want
Garner audience opinion instantly
Increase engagement time
Execute pinpoint advertising through marketing
Obtain market research instantly
Deliver user-specific advertising and offers
Engage in a new, unique and simple way
Define audience targets
Customize programs and solutions created for their specific marketing needs
Identify target audience, build relationships, and then deliver a requested offer
Refine, schedule, and determine programming based on audience feedback and response in real time
Target specific user psychographics that can be narrowed or expanded
Create, monitor, traffic, and control the distribution of their own content exclusive to their audience
Support their advertising clients and partners via brand content integration
Bring terrestrial media directly into the palm of the user's hand for immediate continued engagement
Provide verifiable audience analytics and demographic information for content platforms that have no pattern of broadcast or delivery time (e.g. on-demand video and/or audio)
Leverage and market to audiences identified by other partners targeting similar psychographics as prime users for them
Utilize the application to conduct contesting and/or voting

As would be apparent to one of skill in the art based on the description provided herein, the novel systems and methods described herein could be employed in several different manners using several different types of devices, to enable many new and novel applications.

For example, users could create groups of other users, such as “friends,” and direct particular questions to the more limited subset of preselected or identified “friends.” Questions and answers could be exchanged in the manner described herein, but such exchange would occur only amongst the preselected or identified group. Additionally it may be possible for “friends” among this more limited group to answer questions anonymously. Thus, despite that the group is small and perhaps known to the questioner, answers may be provided without revealing which of the “friends” provided them. This may be beneficial, for example, to resolve or “settle” particularly contentions or controversial topics.

As another example, users may be provided graphical information, such as an infographic, with the top questions asked to users or other media with the various segment findings. Such information may include, for example, currently trending topics or subject matter, information about the most active users or groups of users, in terms of both asking and answering questions, graphical representations of such information broken out in demographic or psychographic segments, or other graphical summaries of useful information gleaned from current statics on questions and answers.

As another example, information “ranking” certain specific users may be provided. For example, information about a specific user's actions compared to other users may be developed, including the amount of total questions asked or answered, the popularity of that user's questions, or other statistics regarding one particular user as compared to other users more generally.

As another example, users could also interact with the software applications in an anonymous manner, such their identities could be hidden, both when asking or answering questions. Anonymity my foster, for example, a more open community both in asking and answering questions. Methods for allowing anonymous use of applications are known in the art, but have not here-to-fore been applied to applications that specifically electronically poll users or target content to users at a particular moment of engagement, for example. One of skill in the art will appreciate the novel aspects of applying anonymization techniques to the inventions disclosed herein.

As another example, gamification could be performed in which questions are presented to the user in a game-type environment for user entertainment. For example, questions could be presented to the user of an application running on, for example, an internet connected mobile device, in a format akin to “this-or-that” or “20 questions” or some other question-based game known to those of skill in the art. The systems and methods described herein would add new and novel dimensions to such games, including but not limited to the ability for a premium user to host specific question-based contests using a channel accessed by a “QuickCode,” allowing marketers and advertisers to collect valuable information from users while the users themselves receive entertainment from their mobile devices, using game-based interaction to perform market narrowing, and other applications that retain user engagement by providing an additional level of entertainment via, e.g., gamification. As another example to increase user engagement and participation, Badges or other comparable profile tags may be given to users based on their answering patterns. Additional other types of rewards could be provided as well, for example to top or other notable users. Badges may be assigned based on application usage or other psychographic information gathered by the manner in which a user answers questions. As another example, a score may be provided to all users based on their asking and answering patterns.

As another example, a user may be able to seek responses to non-question based content. For example a user may input graphics, sounds, videos, links, photos, or other non-textual media and present users with several options for a response. In this fashion, a user could seek to measure reactions to various types of information that may be of value to that user, and may not be limited to text-based questions and answers. For example, a question may be pushed in the form of a short, e.g. approximately to second, video clip.

As another example, a user may be able to use the application to exchange questions and responses in several ways. In one embodiment, the application may run on an internet connected mobile device. In another embodiment, the application may run on an electronic device that communicates with other devices via other means, for example, via Bluetooth, Radio Frequency Near Field Communications (RF NFC), WiFi Direct, infrared (IR), or other electronic means of communication not limited to the internet. In one embodiment such electronic communication means may transfer either questions or answers to other users simply by touching the electronic devices together, or by bringing the electronic devices into close proximity. In another embodiment, a user of an application employing the systems and methods described herein could transfer either questions or answers to another user's cell phone by touching the two phones together.

As another example, a user may be able to receive specific advertisements and offers as a result of its questions and answers, as described above. Such a user could then share such offers via social media, email, or other electronic means, and other users of the application could then access and add such offer to their own electronic wallet interfaces. Such transfer of offers from one user to another could additionally be limited by the premium user that originally generated and delivered that offer. For example, the premium user may allow for distribution of an offer to other users, but only to other users that meet certain demographic or psychographic profiles. For example, an offer provided to a thirty-something male that has a demonstrated interest in baseball may be limited such that it can only be provided to other users that meet those same criteria.

As another example, the screen of the electronic devices running an application that employs the systems and methods describe herein may display a content paired question and an advertisement on the same screen.

As another example, the application running on an electronic device may allow for geographic querying and other functionality based on the geographic position of the user. Such information may be gleaned from GPS, triangulation, the internet, or other means sufficient to locate the user. This information may be used, for example, to provide questions to, or receive answers from, only users in a certain geographical area, to provide the ability for premium users to further filter the profiles of users they seeks to reach, to limit access to channels and use of “QuickCodes” to nearby users, or perform other like methods based on a user's geographic location. As another example “QuickCodes” may have the ability to be linked or related in some way to geographic locations. In one example, if a user arrives to an event that is using a particular QuickCode, that user may receive, for example, a push notification informing them of the availability of the QuickCode in that geographic region, or an icon for the application may appear on the screen of the user's electronic device. For example, when a user carries a cell phone, running an application employing the systems and methods described herein, into Dodger stadium, that user may be notified of the availability of the “DODGERS” QuickCode in the location corresponding to that venue.

As another example, an application running the systems and methods described herein may be able to share questions and answers on any social media platform from any screen.

As another example, an embodiment could provide messages to the user relating to an advertisement or offer, for example using the pinpoint (narrow marketing) approach or other push technique. In one example, such a message could be used explain the exclusivity of the population that received such an offer, or provide other comparable information about the offer itself that may make the offer more compelling to users that receive it. For example, such a message may inform users, that based on their answers this company selected them to receive this offer and this offer was only given to, for example, 2% of the user population, making it more exclusive and compelling.

As another example, an algorithm could use the systems and methods described herein to adjust to individual user answers and establish a consumer profile based on answer patterns and choices. The algorithm may assign a value that can be, for example, sorted based on brand criteria. The algorithm could also perform additional analysis on user input and demographic and psychographic profiles and provide such information to premium users for further analysis and action. The algorithm could alternatively perform a function automatically and transparent to users that improves the quality both of questions provided to certain users and answers received by certain users. As another example, the algorithm could prioritize the questions served to the user based on prior question-and-answer content to serve the most relevant and compelling question next. As another example, the algorithm could target users based on the audience's propensity to engage with questions from a complementary industry/company.

As another example, ads and offers may be served based on more information than a target demographic or psychographic profile. For example, ads and offers may be served based on the user's preference toward the ad/offer, for example as determined by the user's prior responses to questions and ads. This may ensure, among other things, that users are not overwhelmed or “spammed” with irrelevant offers and ads.

As another example, an application employing the systems and methods described herein could employ tagging by hashtags or other comparable keyword means. Users may be presented the opportunity to tag questions or answers with hashtags or other keywords. Users may also browse, search, filter, or perform other narrowing tasks on specific hashtags or keywords.

As another example, the systems and methods described herein may be used to enable live audience responses in real-time to pre-loaded questions. Such an embodiment may be useful in classrooms, TV audiences, sporting event attendees, etc.

As another example, some of the processes described in the aforementioned figures could be broken apart into smaller subprocesses. Conversely, some of the processes described in the aforementioned figures could be combined into larger, master processes. Still further, the various users of the applications could be further separated into classes of users. Each of these users could be presented with different functionality. The different functionality of the different classes of users could be included all within a single application, or could be included separately in separate applications available only to users of a specific type. Moreover, certain features could be available outside of any particular application running on a mobile electronic device, for example via a web interface. For example, uses could be classified and provided with functionality as follows:

User: anyone that has signed up that uses the application for answering and asking questions, viewing results, looking up historical answers/asked questions and followed questions, and basic usage of the core application.

Admin: any user that has been designated an admin to administer the application day to day. These users could include system administrators, developers, or other engineers, as well as any other that should have administration privileges over the application. Any one of those designated as admins could have control over the content and the functionality of the application at differing levels, for example. An administrator interface could be provided in the application itself. For example, as a content admin one could flag questions in the application that will bypass the normal question flagging logic and immediately “soft” delete a question from the user stream. A “soft” delete could, for example, not actually delete the question, but instead flag it as deleted so it can skipped by the question retrieval logic. An administrator interface could also be provided in an external web application. For example, the web application could have dashboards and many administrative features such as deleting a user, contacting a user, deleting or changing the properties of a question (mature content/category/etc.), or adding questions (targeted/user #1/Zip Tip), for example.

Premium User: Could be any user that can create content associated with one or more QuickCodes, for example, tied to an account they belong to. These users could be provided access to the premium user panel web application by an administrator that has created an account and QuickCodes for that account. Premium users could, for example, have access to add, modify and remove content tied to their accounts and QuickCodes. Premium users could also, for example, see the results of their questions in near-time on their dashboard within the external web application. The functionality of the premium user panel and actions that could be completed by premium users may be done through the web application, for example.

As another example, partners who work with the application, for example by becoming premium users could be provided a QuickCode for exclusive use by them within the application. Each QuickCode may be a proprietary, or otherwise distinguishing and unique ID code. It could be a short series of letters or numbers, for example broadcast call letters or a brand name. Through specific distribution of each QuickCode in a particular setting or via a particular medium, for example, each can be utilized to gather specific information corresponding to the method of distribution for said QuickCode.

Personalities, media and brands, for example, can request a personalized QuickCode for the application to speak directly to their audience while obtaining real-time results and analytics to questions posed, among other things. A QuickCode may be communicated to consumers by partners to instantly access a specific question that has been associated with the QuickCode. Each QuickCode may become a unique code for the brand within the application, and may function similarly to, for example, a branded channel. For example, a radio stations could a question on the application and promote it to on-air listeners to go onto the application and weigh in. After the question gained results, the radio station could share those results on the air.

Premium Users may, for example, communicate directly and exclusively with their audience via distribution of their QuickCodes to instantly answer subjective questions, settle debates, win arguments and measure market feedback. Since each QuickCode may be unique to an associated Premium User, it can represent a new development in the marketing world, namely the ability to segment, narrow and expand the audience being reached by a particular message or partner immediately without restrictions.

A QuickCode may be exclusive to media partners, for example, as well as other brands. In this way, the experience may feel less like a poll and more like an interesting conversation. The application thus closes the communication loop between users and viewers, with media partners connecting to their audience with the questions and answers. The capabilities of the application go beyond TV and radio, but into print, events and more.

QuickCodes may also, for example, integrate the broadcast or terrestrial media experience into the palm of a user's hand, leading to increased engagement because they generate content and results that can be shared on air. For example, when the application is used to partner with TV stations, the station may discuss, for example, a topic leading to a question to be pushed out onto the application to interact with their viewers. Viewers may then be given the opportunity to enter the QuickCode and weigh in to submit their opinion on whatever the topic may be. There could then be a follow up, for example, of the TV station connecting back with viewers on the certain topic to share the results.

As another example, an application employing the systems and methods described herein may be integrated with other electronic devices and platforms. For example such an application may allow for integration with Xbox Kinect, Wii, or other comparable gaming platform, or similar network connected home electronics device. It may also allow for visualization and interaction across non-traditional interfaces, for example Google Glass, Apple iWatch, or other personal wearable devices, e.g. “wearables”. Additionally the application may include or allow for an API (Application Programmable Interface) to enable outside applications to be integrated into the application at varying levels of programmatic access. For example, certain features of functionality may be locked down to varying levels across one or more APIs available to or from the application.

What is claimed is:

1. A system for asking and answering questions, comprising:
a first application executable on a mobile electronic device;
a second application executable on a server capable of communicating with said mobile electronic device;
wherein said second application, when executed by said server, is configured to:
deliver a content-based question with one or more proposed responses to said first application; and
deliver one or more advertisements that is linked to one of said one or more proposed responses to said first application;
wherein said first application, when executed by said mobile electronic device, is configured to:
receive said content-based question and said one or more proposed responses from said second application;
present said content-based question and said one or more proposed responses to a user of said mobile electronic device;
receive a selection of one of said one or more responses from said user;
deliver said selection to said second application;
receive said one or more advertisements that is linked to said selection from said second application;
present said one or more advertisements to said user after said user makes said selection; and,
whereby said one or more advertisements delivered to said user are presented in response to and after answering said content-based question in a pre-specified way, thereby targeting the user's preferences at the moment of engagement.

2. The system according to claim 1, wherein said one or more advertisements is linked to said one of said one or more proposed responses from within said first or said second applications.

3. The system according to claim 1, wherein said one or more advertisements is linked to said one of said one or more proposed responses using an external web based interface.

4. The system according to claim 1, wherein said one or more advertisements is delivered to said second application before said user answers said content-based question.

5. The system according to claim 1, wherein said content-based question includes any of text, video, audio, or still pictures.

6. The system according to claim 1, wherein said advertisement includes any of text, video, audio, or still pictures.

7. The system according to claim 1, wherein said user is anonymous.

8. A system for asking and answering questions, comprising:
a first application executable on a mobile electronic device;
a second application executable on a server capable of communicating with said mobile electronic device;
wherein said second application, when executed by server, is configured to:
associate one or more questions with a QuickCode;
receive a specified QuickCode from said first application; and,
deliver said one or more questions associated with said specified QuickCode to said first application;
wherein said first application, when executed by said mobile electronic device, is configured to:
accept input of said specified QuickCode from a user;
deliver said specified QuickCode to said second application;
receive said one or more questions associated with said specified QuickCode from said second application;
present said one more questions to said user after said user enters said input; and,
whereby said one or more questions is presented to said user in response to and after entry of an associated QuickCode that has been provided to said user at a particular moment of engagement, thereby targeting the user's preferences at that moment of engagement.

9. The system according to claim 8, wherein said one or more questions is linked to said QuickCode within said first or said second applications.

10. The system according to claim 8, wherein said one or more questions is linked to said QuickCode using an external web based interface.

11. The system according to claim 8, wherein said user is anonymous.

12. The system according to claim 8, wherein said QuickCode is provided to said user via geolocation.

13. The system according to claim 8, wherein said QuickCode is provided to said user by visual display.

14. The system according to claim 8, wherein said one more questions is delivered to said second application before said entry of said associated QuickCode.

15. A system for asking and answering questions, comprising:
a first application executable on a mobile electronic device;
a second application executable on a server capable of communicating with said mobile electronic device;
wherein said second application, when executed by said server, is configured to:
associate a content-based question with a QuickCode;
receive a specified QuickCode from said first application;
deliver said content-based question with one or more proposed responses associated with said specified QuickCode to said first application;
deliver one or more advertisements that is linked to one of said one or more proposed responses to said first application; and,
wherein said first application, when executed by said mobile electronic device, is configured to:
accept input of said specified QuickCode from a user;
deliver said specified QuickCode to said second application;
receive said content-based question and said one or more proposed responses application associated with said specified QuickCode from said second application;
present said content-based question and said one or more proposed responses to a user of said mobile electronic device;
receive a selection of one of said one or more responses from said user;
deliver said selection to said second application;
receive said one or more advertisements that is linked to said selection from said second application;
present said one or more advertisements to said user after said user makes said selection; and,
whereby said one or more advertisements delivered to said user are presented in response to and after answering said content-based question in a pre-specified way, thereby targeting the user's preferences at the moment of engagement.

16. The system according to claim 15, wherein said user is anonymous.

17. The system according to claim 15, wherein said QuickCode is provided to said user via geolocation.

18. The system according to claim 15, wherein said QuickCode is provided to said user by visual display.

19. The system according to claim 15, wherein said one more questions is delivered to said second application before said entry of said associated QuickCode.

20. The system according to claim 15, wherein said pre-specified way is defined when said one or more advertisements is linked to said one of said one or more proposed responses.
